(19) United States
(12) Patent Application Publication
(10) Pub. No.: US 2019/0276376 A1
(43) Pub. Date: Sep. 12, 2019

(54) CAPSULES COMPRISING BENZYLPROPARGYLETHERS FOR USE AS NITRIFICATION INHIBITORS

(71) Applicant: BASF SE, Ludwigshafen am Rhein (DE)

(72) Inventors: Karl-Heinrich Schneider, Kleinkarlbach (DE); Barbara Nave, Ruppertsberg (DE); Roland Hinrich Staff, Guntersblum (DE); Alexander Wissemeier, Speyer (DE)

(21) Appl. No.: 16/302,435

(22) PCT Filed: May 15, 2017
(86) PCT No.: PCT/EP2017/061564

§ 371 Date: Nov. 16, 2018

(30) Foreign Application Priority Data
May 18, 2016 (EP) 16170144.6

(51) Int. Cl. C05G 3/08; C05G 3/00; C05C 1/00; A01C 21/00

(52) U.S. Cl. CPC C05G 3/08; C05G 3/0047; A01C 21/00; C05G 3/007; C05C 1/00; C05G 3/0029

(57) ABSTRACT

Capsules comprising benzylpropargylethers for use as nitrification inhibitors. The capsules include a core and a shell and may further include a matrix. When including a core and a shell, the core includes benzylpropargylether compounds and the shell includes a shell material. When including a core, a shell, and a matrix, the matrix includes benzylpropargylether compounds and a matrix material. The disclosure further relates to methods of reducing nitrification using the capsules.

The present invention relates to capsules comprising (1) a core (a) and a shell (b), or (2) a matrix (c), wherein, in case of option (1), the core (a) a comprises benzylpropargylether compounds of formula I, and the shell (b) comprises a shell material; and wherein, in case of option (2), the matrix (c) comprises benzylpropargylether compounds of formula I, and a matrix material. The present invention further relates to a capsule suspension comprising the capsules of the invention, to a mixture comprising a fertilizer and the capsules or the capsule suspension of the invention. Furthermore, the present invention relates to uses and methods comprising the application of the capsules, capsule suspensions, and mixtures of the invention.

Nitrogen is an essential element for plant growth and reproduction. About 25% of the plant available nitrogen in soils (ammonium and nitrate) originate from decomposition processes (mineralization) of organic nitrogen compounds such as humus, plant and animal residues and organic fertilizers. Approximately 5% derive from rainfall. On a global basis, the biggest part (70%), however, is supplied to the plant by inorganic nitrogen fertilizers. The mainly used nitrogen fertilizers comprise ammonium compounds or derivatives thereof, i.e. nearly 90% of the nitrogen fertilizers applied worldwide is in the NH₄⁺ form (Subbarao et al., 2012, Advances in Agronomy, 114, 249-302). This is, inter alia, due to the fact that NH₄⁺ assimilation is energetically more efficient than assimilation of other nitrogen sources such as NO₃⁻.

Moreover, being a cation, NH₄⁺ is held electrostatically by the negatively charged clay surfaces and functional groups of soil organic matter. This binding is strong enough to limit NH₄⁺-loss by leaching to groundwater. By contrast, NO₃⁻, being negatively charged, does not bind to the soil and is liable to be leached out of the plants' root zone. In addition, nitrate may be lost by denitrification which is the microbiological conversion of nitrate and nitrite (NO₂⁻) to gaseous forms of nitrogen such as nitrous oxide (N₂O) and molecular nitrogen (N₂).

However, ammonium (NH₄⁺) compounds are converted by soil microorganisms to nitrates (NO₃⁻) in a relatively short time in a process known as nitrification. The nitrification is carried out primarily by two groups of chemolithotrophic bacteria, ammonia-oxidizing bacteria (AOB) of the genus Ni-trosomonas and Nitrobacter, which are ubiquitous components of soil bacteria populations. The enzyme, which is essentially responsible for nitrification is ammonia monooxygenase (AMO), which was also found in ammonia-oxidizing archaea (Subbarao et al., 2012, Advances in Agronomy, 114, 249-302).

The nitrification process typically leads to nitrogen leakage and environmental pollution. As a result of the various losses, approximately 50% of the applied nitrogen fertilizers are lost during the year following fertilizer addition (see Nelson and Huber; Nitrification inhibitors for corn production (2001), National Corn Handbook, Iowa State University).

As countermeasures the use of nitrification inhibitors, mostly together with fertilizers, was suggested. Suitable nitrification inhibitors include biological nitrification inhibitors (BNIs) such as linoleic acid, alpha-linolenic acid, methyl p-coumarate, methyl ferulate, MHPP, Karanjin, brachialacton or the p-benzoquinone sorgoleone (Subbarao et al., 2012, Advances in Agronomy, 114, 249-302). Further suitable nitrification inhibitors are synthetic chemical inhibitors such as Nitrapyrin, dicyandiamide (DCD), 3,4-dimethyl pyrazole phosphate (DMPP), 4-amino-1,2,4-triazole hydrochloride (ATC), 1-amido-2-thiourea (ASU), 2-amino-4-chloro-6-methylpyrimidine (AM), 5-ethoxy-3-trichloromethyl-1,2,4-thiodiazole (terrazole), or 2-sulfanilamidothiazole (ST) (Slangen and Kerkhoff, 1984, Fertilizer research, 5(1), 1-76).

Furthermore, pyrazole-based nitrification inhibitors have been described, e.g., in U.S. Pat. No. 3,635,690, WO 2011/009572, WO 2011/015305, DE 10 2011 120 098, and DE 10 2013 022 031 B3.

However, many of these inhibitors only work sub-optimal. The world population is expected to grow significantly in the next 20-30 years, and, therefore, food production in sufficient quantities and quality is necessary. In order to achieve this, the use of nitrogen fertilizers would have to double by 2050. For environmental reasons, this is not possible, since nitrate levels in drinking water, eutrophication of surface water and gas emissions into the air have already reached critical levels in many places, causing water contamination and air pollution. However, fertilizer efficiency increases significantly and less fertilizer may therefore be applied, if nitrification inhibitors are used. Therefore, there is a clear need for novel nitrification inhibitors, as well as for methods using them.

As certain nitrification inhibitors also have disadvantages, e.g., in that they may cause environmental problems, a lot of research has been done discover further compound classes that exhibit activity as nitrification inhibitors.

In this regard, it was already discovered more than 30 years ago that acetylene is a potent nitrification inhibitor. However, as acetylene is a gas, it has never gained any practical value as a nitrification inhibitor. G. W. McCarty et al. describe the inhibition of nitrification in soil by acetylenic compounds, such as phenylacetylene (Soil Sci. Soc. Am. J., vol. 50, 1986, pp. 1198-1201). Phenylacetylene is also described as nitrification inhibitor in U.S. Pat. No. 4,552,581 A. However, phenylacetylene does not satisfy the present needs e.g. in terms of a high activity at a low application rate.

Starting from phenylacetylene, it has been discovered that benzylpropargylethers are suitable for use as nitrification inhibitors and exhibit a higher activity than phenylacetylene.

However, benzylpropargylethers have a high vapor pressure, which may be in the range of, e.g. from 0.2 to 2 Pa at 2° C. The high vapor pressure of benzylpropargylethers poses difficulties in delivering suitable formulations which can provide long-term nitrification inhibiting activity in the soil.

It was therefore the object of the present invention to provide formulations of benzylpropargylethers, which are suitable for use as nitrification inhibitors, and which overcome the volatility losses of the active ingredient in the environment. It was a further object of the invention to provide capsules comprising the active ingredient, i.e. the compounds of formula (I), which on application to the soil, result in enhanced nitrification inhibiting activity. It was a further object of the invention to also provide capsule formulations comprising the compounds of formula (I) having long term nitrification inhibiting activity.

The present invention addresses this need and relates to capsules comprising
(1) a core (a) and a shell (b), wherein the core (a) is encapsulated by the shell (b); or
(2) a matrix (c);
wherein, if the capsules comprise a core (a) and a shell (b) according to option (1), the core (a) comprises compounds of formula I

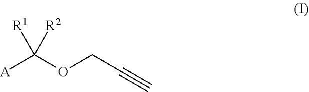

or a stereoisomer, salt, tautomer, or N-oxide thereof
wherein
R¹ and R² are independently of each other selected from the group consisting of H, C₁-C₆-alkyl, C₂-C₆-alkenyl, C₂-C₆-alkynyl, C₁-C₆-haloalkyl, C₁-C₄-alkoxy-C₁-C₄-alkyl C₁-C₆-alkoxy, C₂-C₆-alkenyloxy, C₂-C₆-alkynyloxy, wherein the C-atoms may in each case be unsubstituted or may carry 1, 2 or 3 identical or different substituents R^{e};
   C₃-C₈-cycloalkyl, C₃-C₈-cycloalkenyl, heterocyclyl, aryl, hetaryl, C₃-C₈-cycloalkyl-C₁-C₆-alkyl, C₃-C₈-cycloalkenyl-C₁-C₆-alkyl, heterocyclyl-C₁-C₆-alkyl, aryl-C₁-C₆-alkyl, and hetaryl-C₁-C₆-alkyl, phenoxy and benzyloxy, wherein the cyclic moieties may in each case be unsubstituted or may carry 1, 2, 3, 4, or 5 identical or different substituents R^{a};
A is phenyl, wherein said phenyl ring may be unsubstituted or may carry 1, 2, 3, 4, or 5 identical or different substituents R^{A};
wherein
R^{A} is selected from the group consisting of CN, halogen, NO₂, OR^{b}, NR^{c}R^{d}, C(Y)R^{b}, C(Y)OR^{b}, C(Y)NR^{c}R^{d}, S(Y)ₘR^{b}, S(Y)ₘOR^{b},
   C₁-C₆-alkyl, C₂-C₆-alkenyl, C₂-C₆-alkynyl, C₁-C₆-haloalkyl, C₁-C₆-alkoxy, C₁-C₆-alkylthio, wherein the C-atoms may in each case be unsubstituted or may carry 1, 2 or 3 identical or different substituents R^{e};
   C₃-C₈-cycloalkyl, C₃-C₈-cycloalkenyl, heterocyclyl, aryl, hetaryl, C₃-C₈-cycloalkyl-C₁-C₆-alkyl, C₃-C₈-cycloalkenyl-C₁-C₆-alkyl, heterocyclyl-C₁-C₆-alkyl, aryl-C₁-C₆-alkyl, and hetaryl-C₁-C₆-alkyl, phenoxy and benzyloxy, wherein the cyclic moieties may be unsubstituted or may carry 1, 2, 3, 4, or 5 identical or different substituents R^{a};
and wherein
R^{a} is selected from CN, halogen, NO₂, C₁-C₄-alkyl, C₁-C₄-haloalkyl and C₁-C₄-alkoxy;
or two substituents R^{a} on adjacent C-atoms may be a bridge selected from CH₂CH₂CH₂CH₂, OCH₂CH₂CH₂, CH₂OCH₂CH₂, OCH₂CH₂O, OCH₂OCH₂, CH₂CH₂CH₂, CH₂CH₂O, CH₂OCH₂, O(CH₂)O, SCH₂CH₂CH₂, CH₂SCH₂CH₂, SCH₂CH₂S, SCH₂SCH₂, CH₂CH₂S, CH₂SCH₂, S(CH₂)S, and form together with the C atoms, to which the two R^{a} are bonded to, a 5-membered or 6-membered saturated carbocyclic or heteocyclic ring;
R^{b} is selected from H, C₁-C₆-alkyl, C₂-C₄-alkenyl, C₂-C₄-alkynyl, C₁-C₄-haloalkyl, phenyl and benzyl;
R^{c} and R^{d} are independently of each other selected from the group consisting of H, C₁-C₄-alkyl, and C₁-C₄-haloalkyl; or
R^{c} and R^{d} together with the N atom to which they are bonded form a 5- or 6-membered, saturated or unsaturated heterocycle, which may carry a further heteroatom being selected from O, S and N as a ring member atom and wherein the heterocycle may be unsubstituted or may carry 1, 2, 3, 4, or 5 substituents which are independently of each other selected from halogen;
R^{e} is selected from CN, halogen, C₁-C₄-alkyl, C₁-C₄-haloalkyl, C₁-C₄-alkoxy, and C₁-C₄-haloalkoxy;
Y is O or S; and
m is 0, 1 or 2;
and
the shell (b) comprises a shell material, which is selected from the group consisting of
(b1) polyaddition products of isocyanates;
(b2) poly(meth)acrylates; and
(b3) aminoplasts;
and wherein, if the capsules comprise a matrix (c) according to option (2),
the matrix (c) comprises compounds of formula I

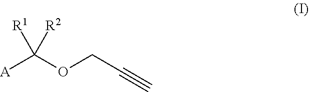

or a stereoisomer, salt, tautomer, or N-oxide thereof
wherein
R¹ and R² are independently of each other selected from the group consisting of H, C₁-C₆-alkyl, C₂-C₆-alkenyl, C₂-C₆-alkynyl, C₁-C₆-haloalkyl, C₁-C₄-alkoxy-C₁-C₄-alkyl C₁-C₆-alkoxy, C₂-C₆-alkenyloxy, C₂-C₆-alkynyloxy, wherein the C-atoms may in each case be unsubstituted or may carry 1, 2 or 3 identical or different substituents R^{e};
   C₃-C₈-cycloalkyl, C₃-C₈-cycloalkenyl, heterocyclyl, aryl, hetaryl, C₃-C₈-cycloalkyl-C₁-C₆-alkyl, C₃-C₈-cycloalkenyl-C₁-C₆-alkyl, heterocyclyl-C₁-C₆-alkyl, aryl-C₁-C₆-alkyl, and hetaryl-C₁-C₆-alkyl, phenoxy and benzyloxy, wherein the cyclic moieties may in each case be unsubstituted or may carry 1, 2, 3, 4, or 5 identical or different substituents R^{a};
A is phenyl, wherein said phenyl ring may be unsubstituted or may carry 1, 2, 3, 4, or 5 identical or different substituents R^{A};
wherein
R^{A} is selected from the group consisting of CN, halogen, NO₂, OR^{b}, NR^{c}R^{d}, C(Y)R^{b}, C(Y)OR^{b}, C(Y)NR^{c}R^{d}, S(Y)ₘR^{b}, S(Y)ₘOR^{b},
   C₁-C₆-alkyl, C₂-C₆-alkenyl, C₂-C₆-alkynyl, C₁-C₆-haloalkyl, C₁-C₆-alkoxy, C₁-C₆-alkylthio, wherein the C-atoms may in each case be unsubstituted or may carry 1, 2 or 3 identical or different substituents R^{e};
   C₃-C₈-cycloalkyl, C₃-C₈-cycloalkenyl, heterocyclyl, aryl, hetaryl, C₃-C₈-cycloalkyl-C₁-C₆-alkyl, C₃-C₈-cycloalkenyl-C₁-C₆-alkyl, heterocyclyl-C₁-C₆-alkyl, aryl-C₁-C₆-alkyl, and hetaryl-C₁-C₆-alkyl, phenoxy and benzyloxy, wherein the cyclic moieties may be unsubstituted or may carry 1, 2, 3, 4, or 5 identical or different substituents R^{a};
and wherein
R^{a} is selected from CN, halogen, NO₂, C₁-C₄-alkyl, C₁-C₄-haloalkyl and C₁-C₄-alkoxy;
or two substituents R^{a} on adjacent C-atoms may be a bridge selected from CH₂CH₂CH₂CH₂, OCH₂CH₂CH₂, CH₂OCH₂CH₂, OCH₂CH₂O, OCH₂OCH₂, CH₂CH₂CH₂, CH₂CH₂O, CH₂OCH₂, O(CH₂)O, SCH₂CH₂CH₂, CH₂SCH₂CH₂, SCH₂CH₂S, SCH₂SCH₂, CH₂CH₂S, CH₂SCH₂, S(CH₂)S, and form together with the C atoms, to which the two R^{a} are bonded to, a 5-membered or 6-membered saturated carbocyclic or heteocyclic ring;
R^{b} is selected from H, C₁-C₆-alkyl, C₂-C₄-alkenyl, C₂-C₄-alkynyl, C₁-C₄-haloalkyl, phenyl and benzyl;
R^{c} and R^{d} are independently of each other selected from the group consisting of H, C₁-C₄-alkyl, and C₁-C₄-haloalkyl; or
R^{c} and R^{d} together with the N atom to which they are bonded form a 5- or 6-membered, saturated or unsaturated heterocycle, which may carry a further heteroatom being selected from O, S and N as a ring member atom and wherein the heterocycle may be unsubstituted or may carry 1, 2, 3, 4, or 5 substituents which are independently of each other selected from halogen;
R^{e} is selected from CN, halogen, C₁-C₄-alkyl, C₁-C₄-haloalkyl, C₁-C₄-alkoxy, and C₁-C₄-haloalkoxy;
Y is O or S; and
m is 0, 1 or 2;
and
a matrix material, which is selected from the group consisting of
(c1) a poly(meth)acrylates; and
(c2) calcium alginate.

It has surprisingly been found that if the above defined capsules comprising the active ingredient, i.e. the compounds of formula I, are applied to the soil, the inhibition of nitrification can significantly be improved compared to the application of non-encapsulated active ingredient.

In particular, the long-term activity in terms of the inhibition of nitrification may be improved if the capsules according to the invention are applied.

Apparently, also controlled release of the active ingredient may be provided in certain embodiments of the invention.

The capsules may be applied to the root zone of a plant, the soil, soil substituents and/or the locus where a plant is growing or is intended to grow the soil; or to a fertilizer, a composition comprising a fertilizer, or a granule comprising a fertilizer.

The capsules may preferably be provided in the form of a capsule suspension.

The present invention therefore also relates to a capsule suspension comprising
a suspended phase comprising the capsules of the invention, wherein the capsules have a volume median particle size of 300 μm or less; and
an aqueous phase;
   wherein the ratio of the suspended phase to the aqueous phase is preferably from 1:0.5 to 1:20.

The capsule suspensions may be applied to the root zone of a plant, the soil, soil substituents and/or the locus where a plant is growing or is intended to grow the soil; or to a fertilizer, a composition comprising a fertilizer, or a granule comprising a fertilizer.

The present invention also relates to a mixture comprising

(i) an inorganic carrier granule, an organic carrier granule, a fertilizer, a composition comprising a fertilizer, or a granule comprising a fertilizer; and
(ii) capsules according to the invention, or the capsule suspension according to the invention.

Furthermore, the present invention relates to the use of the capsules according to the invention, the capsule suspension according to the invention or the mixture according to the invention for agrochemical applications, wherein the use preferably comprises applying the capsules, or the capsule suspension, or the mixture to the root zone of a plant, the soil, soil substituents and/or the locus where a plant is growing or is intended to grow. Preferably the use is for reducing nitrification.

Accordingly, the present invention also relates to a method for reducing nitrification comprising applying the capsules, or the capsule suspension, or the mixture to the root zone of a plant, the soil, soil substituents and/or the locus where a plant is growing or is intended to grow.

The capsules, the capsule suspension, and the mixtures of the invention, and the uses and methods comprising their application are described in further detail hereinafter.

Before describing in detail exemplary embodiments of the present invention, definitions important for understanding the present invention are given.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of ±20%, prefer-ably ±15%, more preferably ±10%, and even more preferably ±5%. It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “ii” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

The term “nitrification inhibitor” is to be understood in this context as a chemical substance which slows down or stops the nitrification process. Nitrification inhibitors accordingly retard the natural transformation of ammonium into nitrate, by inhibiting the activity of bacteria such as Nitrosomonas spp. The term “nitrification” as used herein is to be understood as the biological oxidation of ammonia (NH₃) or ammonium (NH₄⁺) with oxygen into nitrite (NO₂⁻) followed by the oxidation of these nitrites into nitrates (NO₃⁻) by microorganisms. Besides nitrate (NO₃⁻) nitrous oxide is also produced though nitrification. Nitrification is an important step in the nitrogen cycle in soil. The inhibition of nitrification may thus also reduce N₂O losses. The term nitrification inhibitor is considered equivalent to the use of such a compound for inhibiting nitrification.

The term “compound(s) according to the invention”, or “compounds of formula I” comprises the compound(s) as defined herein as well as a stereoisomer, salt, tautomer or N-oxide thereof. The term “compound(s) of the present invention” is to be understood as equivalent to the term “com-pound(s) according to the invention”, therefore also comprising a stereoisomer, salt, tautomer or N-oxide thereof. It is of course to be understood that tautomers can only be present, if a substituent is present at the compounds of formula I, which covers tautomers such as keto-enol tautomers, imine-enamine tautomers, amide-imidic acid tautomers or the like. Otherwise, the term “compounds of formula I” does not encompass tautomers. Furthermore, it is to be understood that stereoisomers are only possible, if there is at least one centre of chirality in the molecule or if geometrical isomers (cis/trans isomers) can be formed.

The compounds of formula I may be amorphous or may exist in one or more different crystalline states (polymorphs) which may have different macroscopic properties such as stability or show different biological properties such as activities. The present invention relates to amorphous and crystalline compounds of formula I, mixtures of different crystalline states of the respective com-pound I, as well as amorphous or crystalline salts thereof.

Salts of the compounds of the formula I are preferably agriculturally acceptable salts. They can be formed in a customary manner, e.g. by reacting the compound with an acid of the anion in question if the compound of formula I has a basic functionality. Agriculturally useful salts of the compounds of formula I encompass especially the acid addition salts of those acids whose cations and anions, respectively, have no adverse effect on the mode of action of the compounds of formula I. Anions of useful acid addition salts are primarily chloride, bromide, fluoride, hydro-gensulfate, sulfate, dihydrogenphosphate, hydrogenphosphate, phosphate, nitrate, bicarbonate, carbonate, hexafluorosilicate, hexafluorophosphate, benzoate, and the anions of C1-C4-alkanoic acids, preferably formate, acetate, propionate and butyrate. They can be formed by reacting com-pounds of formula I with an acid of the corresponding anion, preferably of hydrochloric acid, hydrobromic acid, sulfuric acid, phosphoric acid or nitric acid.

The term “N-oxide” includes any compound of formula I which has at least one tertiary nitrogen atom that is oxidized to an N-oxide moiety. Of course, N-oxides can only be formed, if a nitrogen atom is present within the compounds of formula I.

The organic moieties mentioned in the above definitions of the variables are—like the term halo-gen—collective terms for individual listings of the individual group members. The prefix Cn-Cm indicates in each case the possible number of carbon atoms in the group.

The term “halogen” denotes in each case fluorine, bromine, chlorine or iodine, in particular fluorine, chlorine or bromine.

The term “alkyl” as used herein and in the alkyl moieties of alkylamino, alkylcarbonyl, alkylthio, alkylsulfinyl, alkylsulfonyl and alkoxyalkyl denotes in each case a straight-chain or branched alkyl group having usually from 1 to 10 carbon atoms, frequently from 1 to 6 carbon atoms, preferably 1 to 4 carbon atoms, more preferably from 1 to 3 carbon atoms. Examples of an alkyl group are methyl, ethyl, n-propyl, iso-propyl, n-butyl, 2-butyl, iso-butyl, tert-butyl, n-pentyl, 1-methylbutyl, 2 methylbutyl, 3 methylbutyl, 2,2-di¬methylpropyl, 1 ethylpropyl, n-hexyl, 1,1-di¬methylpropyl, 1,2-dimethylpropyl, 1-methylpentyl, 2-methylpentyl, 3-methylpentyl, 4-methyl¬pentyl, 1,1-dimethyl¬butyl, 1,2-dimethylbutyl, 1,3-dimethyl¬butyl, 2,2-dimethylbutyl, 2,3-dimethyl¬butyl, 3,3-dimethyl¬butyl, 1-ethylbutyl, 2-ethylbutyl, 1,1,2-trimethylpropyl, 1,2,2-trimethylpropyl, 1-ethyl-1-methyl¬propyl, and 1-ethyl-2-methyl propyl.

The term “haloalkyl” as used herein and in the haloalkyl moieties of haloalkylcarbonyl, haloalkoxycarbonyl, haloalkylthio, haloalkylsulfonyl, haloalkylsulfinyl, haloalkoxy and haloalkoxyalkyl, denotes in each case a straight-chain or branched alkyl group having usually from 1 to 10 carbon atoms, frequently from 1 to 6 carbon atoms, preferably from 1 to 4 carbon atoms, wherein the hydrogen atoms of this group are partially or totally replaced with halogen atoms. Preferred haloalkyl moieties are selected from C₁-C₄-halo¬alkyl, more preferably from C₁-C₃-haloalkyl or C₁-C₂-haloalkyl, in particular from C₁-C₂-fluoroalkyl such as fluoromethyl, difluoromethyl, trifluorome-thyl, 1-fluoroethyl, 2-fluoroethyl, 2,2 difluoroethyl, 2,2,2-trifluoroethyl, pentafluoroethyl, and the like.

The term “alkoxy” as used herein denotes in each case a straight-chain or branched alkyl group which is bonded via an oxygen atom and has usually from 1 to 10 carbon atoms, frequently from 1 to 6 carbon atoms, preferably 1 to 4 carbon atoms, e.g. 1 or 2 carbon atoms. Examples of an alkoxy group are methoxy, ethoxy, n-propoxy, iso-prop-oxy, n-butyloxy, 2-butyloxy, iso-butyloxy, tert.-butyloxy, and the like.

The term “alkoxyalkyl” as used herein refers to alkyl usually comprising 1 to 10, frequently 1 to 4, preferably 1 to 2 carbon atoms, wherein 1 carbon atom carries an alkoxy radical usually compris-ing 1 to 4, preferably 1 or 2 carbon atoms as defined above. Examples are CH₂OCH₃, CH₂—OC₂H₅, 2-(methoxy)ethyl, and 2-(ethoxy)ethyl.

The term “alkylthio” (alkylsulfanyl: alkyl-S—)” as used herein refers to a straight-chain or branched saturated alkyl group having 1 to 10 carbon atoms, preferably 1 to 4 carbon atoms (═C₁-C₄-alkylthio), more preferably 1 to 3 carbon atoms, which is attached via a sulfur atom.

The term “haloalkylthio” as used herein refers to an alkylthio group as mentioned above wherein the hydrogen atoms are partially or fully substituted by fluorine, chlorine, bromine and/or iodine.

The term “alkenyl” as used herein denotes in each case a singly unsaturated hydrocarbon radical having usually 2 to 10, frequently 2 to 6, preferably 2 to 4 carbon atoms, e.g. vinyl, allyl (2-propen-1-yl), 1-propen-1-yl, 2 propen-2-yl, methallyl (2-methylprop-2-en-1-yl), 2-buten-1-yl, 3-buten-1-yl, 2-penten-1-yl, 3-penten-1-yl, 4-penten-1-yl, 1-methylbut-2-en-1-yl, 2-ethylprop-2-en-1-yl and the like.

The term “alkenyloxy” as used herein denotes in each case an alkenyl group as defined above, which is bonded via an oxygen atom and has usually from 2 to 10, preferably from 2 to 6 or from 2 to 4 carbon atoms.

The term “alkynyl” as used herein denotes in each case a singly unsaturated hydrocarbon radical having usually 2 to 10, frequently 2 to 6, preferably 2 to 4 carbon atoms, e.g. ethynyl, propargyl (2-propyn-1-yl), 1-propyn-1-yl, 1-methylprop-2-yn-1-yl), 2-butyn-1-yl, 3-butyn-1-yl, 1-pen¬tyn-1-yl, 3-pentyn-1-yl, 4-pentyn-1-yl, 1-methylbut-2-yn-1-yl, 1-ethylprop-2-yn-1-yl and the like.

The term “alkynyloxy” as used herein denotes in each case an alkenyl group as defined above, which is bonded via an oxygen atom and has usually from 2 to 10, preferably from 2 to 6 or from 2 to 4 carbon atoms.

The term “cycloalkylalkyl” refers to a cycloalkyl group as defined above which is bonded via an alkyl group, such as a C₁-C₆-alkyl group or a C₁-C₄-alkyl group, in particular a methyl group (=cycloalkylmethyl), to the remainder of the molecule.

The term “cycloalkyl” as used herein and in the cycloalkyl moieties of cycloalkoxy and cycloalkylthio denotes in each case a monocyclic cycloaliphatic radical having usually from 3 to 10 or from 3 to 6 carbon atoms, such as cyclopropyl, cyclobutyl, cyclopentyl, cyclohexyl, cycloheptyl, cyclooctyl, cyclononyl and cyclodecyl or cyclopropyl, cyclobutyl, cyclopentyl and cyclohexyl.

The term “cycloalkenyl” as used herein and in the cycloalkenyl moieties of cycloalkenyloxy and cycloalkenylthio denotes in each case a monocyclic singly unsaturated non-aromatic radical hav-ing usually from 3 to 10, e.g. 3, or 4 or from 5 to 10 carbon atoms, preferably from 3- to 8 carbon atoms. Exemplary cycloalkenyl groups include cyclopropenyl, cycloheptenyl or cyclooctenyl.

The term “cycloalkenylalkyl” refers to a cycloalkenyl group as defined above which is bonded via an alkyl group, such as a C₁-C₆-alkyl group or a C₁-C₄-alkyl group, in particular a methyl group (=cycloalkenylmethyl), to the remainder of the molecule.

The term “carbocycle” or “carbocyclyl” includes in general a 3- to 12-membered, preferably a 3- to 8-membered or a 5- to 8-membered, more preferably a 5- or 6-membered mono-cyclic, non-aromatic ring comprising 3 to 12, preferably 3 to 8 or 5 to 8, more preferably 5 or 6 carbon atoms. Preferably, the term “carbocycle” covers cycloalkyl and cycloalkenyl groups as defined above.

The term “heterocycle” or “heterocyclyl” includes in general 3- to 12-membered, preferably 3- to 8-membered or 5- to 8-membered, more preferably 5- or 6-membered, in particular 6-membered monocyclic heterocyclic non-aromatic radicals. The heterocyclic non-aromatic radicals usually comprise 1, 2, 3, 4, or 5, preferably 1, 2 or 3 heteroatoms selected from N, O and S as ring members, where S-atoms as ring members may be present as S, SO or SO₂. Examples of 5- or 6-membered heterocyclic radicals comprise saturated or unsaturated, non-aromatic heterocyclic rings, such as oxiranyl, oxetanyl, thietanyl, thietanyl-S-oxid (S-oxothietanyl), thietanyl-S-dioxid (S-dioxothiethanyl), pyrrolidinyl, pyrrolinyl, pyrazolinyl, tetrahydrofuranyl, dihydrofuranyl, 1,3-dioxolanyl, thiolanyl, S-oxothiolanyl, S-dioxothiolanyl, dihydrothienyl, S-oxodihydrothienyl, S-dioxodihydro-thienyl, oxazolidinyl, oxazolinyl, thiazolinyl, oxathiolanyl, piperidinyl, piperazinyl, py-ranyl, dihydropyranyl, tetrahydropyranyl, 1,3- and 1,4-dioxanyl, thiopyranyl, S.oxothiopyranyl, S-dioxothiopyranyl, dihydrothio-pyranyl, S-oxodihydrothiopyranyl, S-dioxodihydrothiopyranyl, tetra-hydrothiopyranyl, S-oxotetra-hydrothiopyranyl, S-dioxotetrahydrothiopyranyl, morpholinyl, thiomor-pholinyl, S-oxothio-morpho-linyl, S-dioxothiomorpholinyl, thiazinyl and the like. Examples for heterocyclic ring also comprising 1 or 2 carbonyl groups as ring members comprise pyrrolidin-2-onyl, pyrrolidin-2,5-dionyl, imidazolidin-2-onyl, oxazolidin-2-onyl, thiazolidin-2-onyl and the like.

The term “aryl” includes mono-, bi- or tricyclic aromatic radicals having usually from 6 to 14, preferably 6, 10, or 14 carbon atoms. Exemplary aryl groups include phenyl, naphthyl and anthracenyl. Phenyl is preferred as aryl group.

The term “hetaryl” includes monocyclic 5- or 6-membered heteroaromatic radicals comprising as ring members 1, 2, 3, or 4 heteroatoms selected from N, O and S. Examples of 5- or 6 mem-bered heteroaromatic radicals include pyridyl, i.e. 2-, 3-, or 4 pyridyl, pyrimidinyl, i.e. 2, 4-, or 5-pyrimidinyl, pyrazinyl, pyridazinyl, i.e. 3- or 4 pyridazinyl, thienyl, i.e. 2- or 3-thienyl, furyl, i.e. 2- or 3-furyl, pyrrolyl, i.e. 2- or 3 pyrrolyl, oxazolyl, i.e. 2, 3-, or 5-oxazolyl, isoxazolyl, i.e. 3-, 4-, or 5-isoxazolyl, thiazolyl, i.e. 2-, 3- or 5-thiazolyl, isothiazolyl, i.e. 3-, 4-, or 5 isothiazolyl, pyrazolyl, i.e. 1-, 3-, 4-, or 5-pyrazolyl, i.e. 1-, 2-, 4-, or 5-imidazolyl, oxadiazolyl, e.g. 2- or 5 [1,3,4]oxadi¬azolyl, 4 or 5-(1,2,3-oxa-diazol)yl, 3- or 5-(1,2,4-oxadiazol)yl, 2- or 5 (1,3,4-thiadiazol)yl, thiadi¬azolyl, e.g. 2- or 5-(1,3,4-thia-diazol)yl, 4- or 5 (1,2,3 thiadiazol)yl, 3- or 5-(1,2,4-thiadiazol)yl, triazolyl, e.g. 1H-, 2H- or 3H 1,2,3 triazol-4-yl, 2H-triazol-3-yl, 1H-, 2H-, or 4H-1,2,4-triazolyl and tetrazolyl, i.e. 1H- or 2H tetrazolyl. The term “hetaryl” also includes bicyclic 8 to 10-membered heteroaromatic radi-cals comprising as ring members 1, 2 or 3 heteroatoms selected from N, O and S, wherein a 5- or 6-membered heteroaromatic ring is fused to a phenyl ring or to a 5- or 6-membered heteroaromatic radical. Examples of a 5- or 6-membered heteroaromatic ring fused to a phenyl ring or to a 5- or 6-membered heteroaromatic radical include benzofuranyl, benzo-thienyl, indolyl, ind¬azolyl, benzimidazolyl, benzoxathiazolyl, benzoxadiazolyl, benzothiadiazolyl, benzoxazinyl, chinolinyl, isochinolinyl, purinyl, 1,8-naphthyridyl, pteridyl, pyrido[3,2 d]pyri¬midyl or pyridoimidazolyl and the like. These fused hetaryl radicals may be bonded to the remainder of the molecule via any ring atom of 5- or 6-membered heteroaromatic ring or via a carbon atom of the fused phenyl moiety.

The terms “benzyloxy” and “phenoxy” refer to a benzyl and a phenyl group, respectively, which are bonded via an oxygen atom to the remainder of the molecule.

The terms “heterocyclylalkyl” and “hetarylalkyl” refer to heterocyclyl or hetaryl, respectively, as defined above which are bonded via a C₁-C₆-alkyl group or a C₁-C₄-alkyl group, in particular a methyl group (=heterocyclylmethyl or hetarylmethyl, respectively), to the remainder of the molecule.

The term “arylalkyl” refers to aryl as defined above, which is bonded via C₁-C₆-alkyl group or a C₁-C₄-alkyl group, in particular a methyl group (=arylmethyl or phenylmethyl), to the remainder of the molecule, examples including benzyl, 1-phenylethyl, 2-phenylethyl, etc.

The term “cyclic moiety” can refer to any cyclic groups, which are present in the compounds of the present invention, and which are defined above, e.g. cycloalkyl, cycloalkenyl, carbocycle, het-erocycloalkyl, heterocycloalkenyl, heterocycle, aryl, hetaryl and the like.

As outlined in detail above, the present invention relates to capsules comprising (1) a core (a) and a shell (b), or (2) a matrix (c), wherein, in case of option (1), the core (a) a comprises benzylpropargylether compounds of formula I, and the shell (b) comprises a shell material; and wherein, in case of option (2), the matrix (c) comprises benzylpropargylether compounds of formula I, and a matrix material.

The compounds of formula I are described in detail hereinafter.

It is noted that compounds of formula I are commercially available or may be prepared by methods known in the art. In particular, a skilled person is aware that the ether moiety may be formed either by reacting a suitable propargylhalogenide, e.g. propargylbromide or propargylchloride, with a suitable benzyl alcohol, or by reacting a suitable propargyl alcohol with a suitable benzylhalogenide, e.g. benzylbromide or benzylchloride. Regarding these synthetic routes, reference is made to SU 1 773 901 A1 and N. B. Barhate (Indian Journal of Biochemistry & Biophysics, vol. 39, 2002, pp. 264-273).

Preferred embodiments regarding the variables of the compounds of formula I are defined hereinafter.

In one embodiment of the invention, the compounds of formula I have the following general formula I

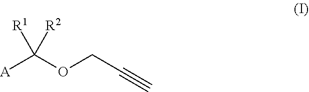

wherein
R¹ and R² are independently of each other selected from the group consisting of H, C₁-C₆-alkyl, C₂-C₆-alkenyl, C₂-C₆-alkynyl, C1-C₆-haloalkyl, C₁-C₄-alkoxy-C₁-C₄-alkyl C₁-C₆-alkoxy, C₂-C₆-alkenyloxy, C₂-C₆-alkynyloxy, wherein the C-atoms may in each case be unsubstituted or may carry 1, 2 or 3 identical or different substituents R^{e};
   C₃-C₈-cycloalkyl, C₃-C₈-cycloalkenyl, heterocyclyl, aryl, hetaryl, C₃-C₈-cycloalkyl-C₁-C₆-alkyl, C₃-C₈-cycloalkenyl-C₁-C₆-alkyl, heterocyclyl-C₁-C₆-alkyl, aryl-C₁-C₆-alkyl, and hetaryl-C₁-C₆-alkyl, phenoxy and benzyloxy, wherein the cyclic moieties may in each case be unsubstituted or may carry 1, 2, 3, 4, or 5 identical or different substituents R^{a};
A is phenyl, wherein said phenyl ring may be unsubstituted or may carry 1, 2, 3, 4, or 5 identical or different substituents R^{A};
wherein
R^{A} is selected from the group consisting of CN, halogen, NO₂, OR^{b}, NR^{c}R^{d}, C(Y)R^{b}, C(Y)OR^{b}, C(Y)NR^{c}R^{d}, S(Y)ₘR^{b}, S(Y)ₘOR^{b},
   C₁-C₆-alkyl, C₂-C₆-alkenyl, C₂-C₆-alkynyl, C₁-C₆-haloalkyl, C₁-C₆-alkoxy, C₁-C₆-alkylthio, wherein the C-atoms may in each case be unsubstituted or may carry 1, 2 or 3 identical or different substituents R^{e};
   C₃-C₈-cycloalkyl, C₃-C₈-cycloalkenyl, heterocyclyl, aryl, hetaryl, C₃-C₈-cycloalkyl-C₁-C₆-alkyl, C₃-C₈-cycloalkenyl-C₁-C₆-alkyl, heterocyclyl-C₁-C₆-alkyl, aryl-C₁-C₆-alkyl, and hetaryl-C₁-C₆-alkyl, phenoxy and benzyloxy, wherein the cyclic moieties may be unsubstituted or may carry 1, 2, 3, 4, or 5 identical or different substituents R^{a};
and wherein
R^{a} is selected from CN, halogen, NO₂, C₁-C₄-alkyl, C₁-C₄-haloalkyl and C₁-C₄-alkoxy;
or two substituents R^{a} on adjacent C-atoms may be a bridge selected from CH₂CH₂CH₂CH₂, OCH₂CH₂CH₂, CH₂OCH₂CH₂, OCH₂CH₂O, OCH₂OCH₂, CH₂CH₂CH₂, CH₂CH₂O, CH₂OCH₂, O(CH₂)O, SCH₂CH₂CH₂, CH₂SCH₂CH₂, SCH₂CH₂S, SCH₂SCH₂, CH₂CH₂S, CH₂SCH₂, S(CH₂)S, and form together with the C atoms, to which the two R^{a} are bonded to, a 5-membered or 6-membered saturated carbocyclic or heteocyclic ring;
R^{b} is selected from H, C₁-C₆-alkyl, C₂-C₄-alkenyl, C₂-C₄-alkynyl, C₁-C₄-haloalkyl, phenyl and benzyl;
R^{c} and R^{d} are independently of each other selected from the group consisting of H, C₁-C₄-alkyl, and C₁-C₄-haloalkyl; or
R^{c} and R^{d} together with the N atom to which they are bonded form a 5- or 6-membered, saturated or unsaturated heterocycle, which may carry a further heteroatom being selected from O, S and N as a ring member atom and wherein the heterocycle may be unsubstituted or may carry 1, 2, 3, 4, or 5 substituents which are independently of each other selected from halogen;
R^{e} is selected from CN, halogen, C₁-C₄-alkyl, C₁-C₄-haloalkyl, C₁-C₄-alkoxy, and C₁-C₄-haloalkoxy;
Y is O or S; and
m is 0, 1 or 2.

In one preferred embodiment of said compound of formula I as defined above, R¹ is H and R² is selected from the group consisting of C₂-C₆-alkynyl, C₂-C₆-alkynyloxy, aryl-C₁-C₆-alkyl, and hetaryl-C₁-C₆-alkyl, and is preferably selected from the group consisting of C₂-C₄-alkynyl, C₂-C₄-alkynyloxy, aryl-C₁-C₄-alkyl, and hetaryl-C₁-C₄-alkyl, and is most preferably hetaryl-C₁-C₄-alkyl, in particular triazolylmethyl. These compounds correspond to compounds of formula I.a, wherein R²-a represents a substituent selected from the group consisting of C₂-C₆-alkynyl, C₂-C₆-alkynyloxy, aryl-C₁-C₆-alkyl, and hetaryl-C₁-C₆-alkyl, and is preferably selected from the group consisting of C₂-C₄-alkynyl, C₂-C₄-alkynyloxy, aryl-C1-C₄-alkyl, and hetaryl-C₁-C₄-alkyl, and is more preferably selected from the group consisting of C₃-alkynyloxy and hetaryl-C₁-C₄-alkyl, and is most preferably hetaryl-C₁-C₄-alkyl, in particular triazolylmethyl. If R²-a is triazolylmethyl, it is preferred that the triazole moiety is bonded to the methyl group via one of the nitrogen atoms. Furthermore, it is preferred that the triazole moiety is a 1,2,4-triazole moiety.

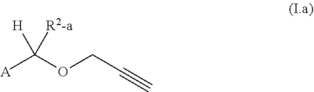

In another preferred embodiment of said compound of formula I as defined above, both, R¹ and R² are H. These compounds correspond to compounds of formula I.b.

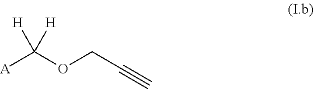

In one embodiment of the compound of formula I, A is phenyl, wherein said phenyl ring is unsubstituted or carries 1, 2, or 3 identical or different substituents R^{A}. Such compounds correspond to compounds of formula I.1, wherein (R^{A})n with n being 0, 1, 2, or 3 indicates the above substitution possibilities for the compound.

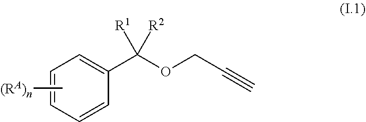

Particular preferred are compounds, wherein n is 1 or 2, i.e. the following compounds I.1¹ and I.1²

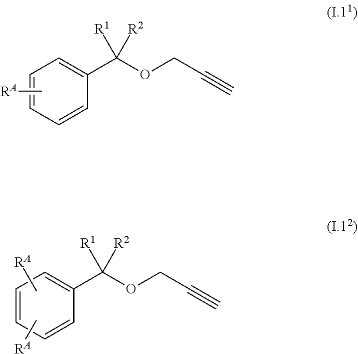

In connection with the compounds defined above, it is to be understood that the substituent(s) R^{A} may be present at any carbon atom of the phenyl ring.

In a preferred embodiment, the present invention relates to compounds of formula I, wherein R¹ is H, R² is R²-a, and A is phenyl, wherein said phenyl ring is unsubstituted or carries 1, 2, or 3 identical or different substituents R^{A}. Such compounds are referred to compounds of formula 1.1.a, with compounds of formula I.1¹.a and compounds of formula I.1².a being particularly preferred.

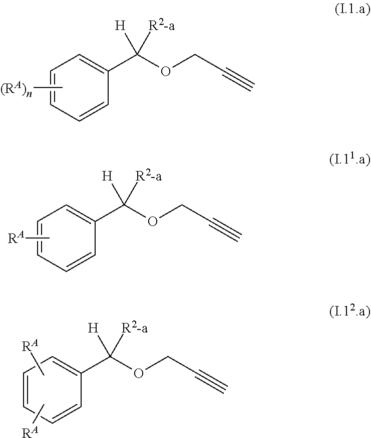

In connection with the compounds defined above, it is to be understood that the substituent(s) R^{A} may be present at any carbon atom of the phenyl ring.

In another preferred embodiment, the present invention relates to compounds of formula I, wherein R¹ is H, R² is H, A is phenyl, wherein said phenyl ring is unsubstituted or carries 1, 2, or 3 identical or different substituents R^{A}. Such compounds are referred to compounds of formula I.1.b, with compounds of formula I.1¹.b and compounds of formula I.1².b being particularly preferred.

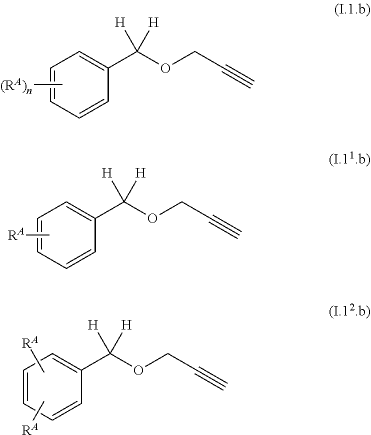

In connection with the compounds defined above, it is to be understood that the substituent(s) R^{A} may be present at any carbon atom of the phenyl ring.

For the compounds as defined above, i.e. I.a, I.b, I.1, I.1¹, I.1², I.1.a, I.1¹.a, I.1².a, I.1.b, I.1¹.b, I.1².b, it is particularly preferred that R^{A}, if present, is selected from the group consisting of halogen, NO₂, NR^{c}R^{d}, C₁-C₆-alkyl, C₁-C₆-haloalkyl, C₁-C₆-alkoxy, C₁-C₆-alkylthio, phenoxy and benzyloxy, wherein the cyclic moieties may be unsubstituted or may carry 1 or 2 identical or different substituents R^{a}, wherein R^{a}, R^{c} and R^{d} are defined as follows:

R^{a} is selected from halogen, C₁-C₂-alkyl, C₁-C₂-alkoxy, or two substituents R^{a} on adjacent C-atoms may be a OCH₂CH₂O bridge or a O(CH₂)O bridge; and

R^{c} and R^{d} are independently of each other selected from the group consisting of H, C₁-C₄-alkyl, and C₁-C₄-haloalkyl.

It is more preferred that R^{A} is selected from the group consisting of halogen, NO₂, C₁-C₆-alkyl, C₁-C₆-haloalkyl, C₁-C₆-alkoxy, and phenoxy, wherein the phenoxy group may be unsubstituted or may carry 1 or 2 identical or different substituents R^{a}, wherein

R^{a} is selected from halogen.

It is more preferred that R^{A} is selected from the group consisting of halogen, NO₂, C₁-C₂-alkyl, C₁-C₂-haloalkyl, C₁-C₂-alkoxy, and phenoxy, wherein the phenoxy group may be unsubstituted or may carry 1 or 2 identical or different substituents R^{a}, wherein R^{a} is selected from halogen.

It is most preferred that R^{A} is selected from the group consisting of fluorine, chlorine, bromine, NO₂, CH₃, CF₃, methoxy, and phenoxy, wherein the phenoxy group may be unsubstituted or may carry 1 or 2 identical or different substituents R^{a}, wherein

R^{a} is selected from fluorine, chlorine, or bromine.

Thus, the present invention refers in one embodiment to compounds of formula I, wherein

R¹ and R² are independently of each other selected from the group consisting of H, C₂-C₆-alkynyl, C₂-C₆-alkynyloxy, aryl-C₁-C₆-alkyl, and hetaryl-C₁-C₆-alkyl, provided at least one of R¹ and R² is H, and wherein

A is phenyl, wherein said phenyl ring is unsubstituted or carries 1, 2, or 3 identical or different substituents R^{A}, wherein

R^{A} is selected from the group consisting of halogen, NO₂, NR^{c}R^{d}, C₁-C₆-alkyl, C₁-C₆-haloalkyl, C₁-C₆-alkoxy, C₁-C₆-alkylthio, phenoxy and benzyloxy, wherein the cyclic moieties may be unsubstituted or may carry 1 or 2 identical or different substituents R^{a}, wherein R^{a}, R^{c} and R^{d} are defined as follows:

R^{a} is selected from halogen, C₁-C₂-alkyl, C1-C₂-alkoxy, or two substituents R^{a} on adjacent C-atoms may be a OCH₂CH₂O bridge or a O(CH₂)O bridge; and

R^{c} and R^{d} are independently of each other selected from the group consisting of H, C1-C₄-alkyl, and C₁-C₄-haloalkyl.

In particular, the present invention relates in one preferred embodiment to a compound of formula I.1.a, especially a compound of formula I.1¹.a or I.1².a as defined above,

wherein R^{A} is selected from the group consisting of halogen, NO₂, C₁-C₆-alkyl, C₁-C₆-haloalkyl, C₁-C₆-alkoxy, and phenoxy, wherein the phenoxy group may be unsubstituted or may carry 1 or 2 identical or different substituents R^{a}, wherein

R^{a} is selected from halogen.

In a more preferred embodiment, the present invention refers to a compound of formula I.1.a, especially a compound of formula I.1′.a or 1.1².a as defined above,

wherein R^{A} is selected from the group consisting of halogen, NO₂, C1-C₂-alkyl, C₁-C₂-haloalkyl, C₁-C₂-alkoxy, and phenoxy, wherein the phenoxy group may be unsubstituted or may carry 1 or 2 identical or different substituents R^{a}, wherein

R^{a} is selected from halogen.

In an even more preferred embodiment, the present invention refers to a compound of formula I.1.a, especially a compound of formula I.1′.a or I.1².a as defined above,

wherein R^{A} is selected from the group consisting of fluorine, chlorine, bromine, NO₂, CH₃, CF₃, methoxy, and phenoxy, wherein the phenoxy group may be unsubstituted or may carry 1 or 2 identical or different substituents R^{a}, wherein

R^{a} is selected from fluorine, chlorine, or bromine.

Furthermore, the present invention refers in another preferred embodiment to a compound of formula I.1.b, especially a compound of formula I.1¹.b or I.1².b as defined above,

wherein R^{A} is selected from the group consisting of halogen, NO₂, C₁-C₆-alkyl, C₁-C₆-haloalkyl, C₁-C₆-alkoxy, and phenoxy, wherein the phenoxy group may be unsubstituted or may carry 1 or 2 identical or different substituents R^{a}, wherein

R^{a} is selected from halogen.

In a more preferred embodiment, the present invention refers to a compound of formula I.1.b, especially a compound of formula I.1¹.b or I.1².b as defined above, wherein R^{A} is selected from the group consisting of halogen, NO₂, C₁-C₂-alkyl, C₁-C₂-haloalkyl, C₁-C₂-alkoxy, and phenoxy, wherein the phenoxy group may be unsubstituted or may carry 1 or 2 identical or different substituents R^{a}, wherein

R^{a} is selected from halogen.

In an even more preferred embodiment, the present invention refers to a compound of formula I.1.b, especially a compound of formula I.1¹.b or 1.1².b as defined above, wherein R^{A} is selected from the group consisting of fluorine, chlorine, bromine, NO₂, CH₃, CF₃, methoxy, and phenoxy, wherein the phenoxy group may be unsubstituted or may carry 1 or 2 identical or different substituents R^{a}, wherein

R^{a} is selected from fluorine, chlorine, or bromine.

Of particular relevance in the context of the present invention are compounds of formula I, wherein, in the compound of formula I,
R¹ and R² are each H;
A is phenyl, wherein said phenyl ring is unsubstituted or carries 1, 2, or 3 identical or different substituents R^{A}, wherein
R^{A} is selected from the group consisting of halogen, NO₂, NR^{c}R^{d}, C₁-C₆-alkyl, C₁-C₆-haloalkyl, C₁-C₆-alkoxy, C₁-C₆-alkylthio, phenoxy and benzyloxy, wherein the cyclic moieties may be unsubstituted or may carry 1 or 2 identical or different substituents R^{a},
wherein
R^{a} is selected from halogen, C₁-C₂-alkyl, and C₁-C₂-alkoxy,
or two substituents R^{a} on adjacent C-atoms may be a OCH₂CH₂O bridge or a O(CH₂)O bridge;
R^{c} and R^{d} are independently of each other selected from the group consisting of H, C₁-C₄-alkyl, and C₁-C₄-haloalkyl;
and wherein preferably
R^{A} is selected from the group consisting of halogen, NO₂, C₁-C₆-alkyl, C₁-C₆-haloalkyl, C₁-C₆-alkoxy, phenoxy and benzyloxy, wherein the cyclic moieties may be unsubstituted or may carry 1 or 2 identical or different substituents R^{a},
wherein
R^{a} is selected from halogen, C1-C₂-alkyl, and C1-C₂-alkoxy.

Particularly preferred are compounds of formula I, wherein, in the compound of formula I,
R¹ and R² are each H;
A is phenyl, wherein said phenyl ring is unsubstituted or carries 1, 2, or 3 identical or different substituents R^{A}, wherein
R^{A}, if present, is selected from the group consisting of halogen, C₁-C₄-alkyl, and C₁-C₄-alkoxy.

In particular, preference is given to the compounds of formula I compiled in Table 1 below.

TABLE 1

| No. | Structure |
|---|---|
| A-1 | 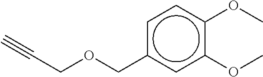 |
| A-2 | 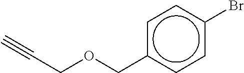 |
| A-3 | 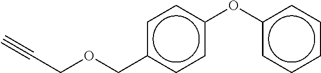 |
| A-4 | 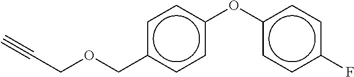 |
| A-5 | 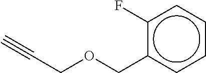 |
| A-6 | 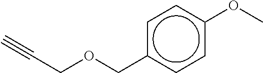 |
| A-7 | 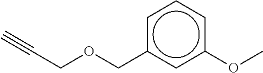 |
| A-8 | 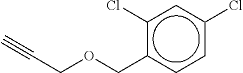 |
| A-9 | 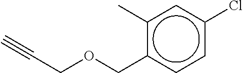 |
| A-10 | 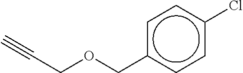 |
| A-11 | 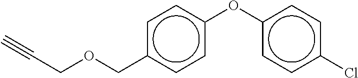 |
| A-12 | 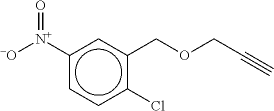 |

Of particular relevance in the context of the present invention are those compounds of formula I, which have a high vapor pressure, but at the same time exhibit a high activity as nitrification inhibitor.

In a preferred embodiment, the vapor pressure of the compound of formula I is more than 0.2 Pa at 20° C. or even more than 1.0 Pa at 20° C.

In some embodiments, the vapor pressure of the compound of formula I is from 0.2 to 4.0 Pa at 20° C., for example from 0.2 to 2.5 Pa at 20° C. or from 0.3 to 2.0 Pa at 20° C. In other embodiments, the vapor pressure of the compound of formula I is from 0.5 to 4.0 Pa at 20° C., for example from 0.5 to 2.5 Pa at 20° C. or from 0.6 to 2.0 Pa at 20° C. In other embodiments, the vapor pressure of the compound of formula I is from 1.0 to 4.0 Pa at 20° C., for example from 1.0 to 2.5 Pa at 20° C. or from 1.2 to 2.0 Pa at 20° C.

Of particular relevance are compounds of formula I, which have a vapor pressure of from 1.5 to 2.0 Pa at 20° C.

The vapor pressure can be determined by thermogravimetry by methods known in the art. In the context of the present invention, a Mettler Toledo STAR thermogravimeter with 5 mg sample on a glass plate may be used. As a reference compound, 3,4-dimethyl pyrazole (DMP) was inter alia measured and a vapor pressure of 3.7 Pa at 20° C. was determined.

The capsules according to the present invention are defined in further detail hereinafter. In particular, core/shell capsules (option (1)) and matrix-based capsules (option (2)) are described in further detail. First, the core/shell capsules are described in detail.

In one embodiment, the present invention relates to capsules comprising a core (a) and a shell (b), wherein the core (a) is encapsulated by the shell (b), and wherein

the core (a) comprises compounds of formula I as defined in the claims and as defined above, and

the shell (b) comprises a shell material, which is selected from the group consisting of

(b1) polyaddition products of isocyanates;

(b2) poly(meth)acrylates; and

(b3) aminoplasts.

The capsules may be prepared by a process comprising the steps of (1) mixing an oil phase and a water phase, wherein the oil phase comprises the compounds of formula I, optionally a solvent, and at least one lipophilic monomer, and wherein the water phase optionally comprises at least one monomer, and (2) polymerizing the monomers at the surface of the oil phase and the water phase to form the capsules of the invention.

Apart from the compounds of formula I, the core of the capsules optionally comprises a water-immiscible solvent (S). Preferably, the solvent (S) has a solubility in water of up to 20 g/l at 20° C., more preferably of up to 5 g/l and in particular of up to 0.5 g/l. Usually, the solvent (S) has a boiling point above 100° C., preferably above 150° C., and in particular above 180° C. (at 1 bar).

“Solvent” in this case means that the solvent (S) is able to form a homogeneous mixture with the compounds of formula I as defined herein or to dissolve the compounds of formula I as defined herein.

Preferred as solvent (S) are:
an aromatic hydrocarbon solvent such as toluene, xylene, tetrahydronaphthalene, or an alkylated naphthalene or derivative thereof;
a fatty acid ester, such as C₁-C₁₀-alkylesters of C₁₀-C₂₂-fatty acids, or methyl- or ethyl esters of vegetable oils such as rapeseed oil methyl ester or corn oil methyl ester, or glycerides like vegetable oils such as corn oil or rapeseed oil; or
a fatty acid dialkyl amide, such as a C₁-C₁₀-dialkyl amide of a C₁₀-C₂₂-fatty acid.

Mixtures of the aforementioned solvents are also possible. The water-immiscible solvent (S) is usually commercially available, such as aromatic hydrocarbons under the tradenames Solvesso® 200, Aromatic® 200, or Caromax® 28. The aromatic hydrocarbons may be used as naphthalene depleted qualities.

An example of commercially available fatty acid esters is methyl oleate (e.g. Synative® ES METI 05, Cognis, Germany).

Examples of commercially available fatty acid dialkyl amides are octanoic acid, decanoic acid dimethylamide (e.g. Genagen® 4296, Clariant, Germany) and dodecanoic acid.

Preferred solvents (S) are aromatic hydrocarbons, fatty acid esters and fatty acid amides, as described above.

In one embodiment of the invention, it is preferred that the compounds of formula I are present in the core (a) in dissolved form, as suspension, emulsion, or suspoemulsion. Preferably, the compounds of formula I are present in dissolved form. Further, in this embodiment the weight ratio of the compounds of formula I in the core to the sum of all solvents (e.g. solvent (S) and any cosolvent) in the core is typically from 5:1 to 1:10, preferably from 3:1 to 1:2, more preferably from 2:1 to 1:1.

The core (a) contains at least 10 wt %, preferably at least 30 wt % and in particular at least 50 wt % of the compounds of formula I, based on the total amount of the core materials. The core (a) may contain up to 100 wt %, preferably up to 70 wt % of the compounds of formula I. The amount of core materials is typically summed up from the amounts of the compounds of formula I and any solvents in the core.

Suitable shell materials are well known to someone skilled in the art and include

(b1) polyaddition products of isocyanates, in particular polyureas;

(b2) poly(meth)acrylates; or

(b3) aminoplasts, preferably melamin formaldehyde condensates.

Preferred are polyaddition products of isocyanates. Particularly preferred are polyureas.

Preferred polyaddition products of isocyanates (b1) can be obtained by polyaddition of

M1.1) 30-100% by weight, based on (b1), of at least one isocyanate derivative (M I),

M1.2) 0-70% by weight, based on (b1), of at least one amino compound (M II), and/or

M1.3) 0-70% by weight, based on (b1), of at least one alcohol (M III).

Suitable isocyanate derivatives (M I) are all isocyanates having two or more isocyanate groups. Preferred are isocyanates listed below for polyurea shells materials.

Suitable amino compounds (M II) are guanidine and its salts, di- and polyamines and aminoalcohols. Preference is given to diethylenetriamine, N,N′-bis-(3-aminopropyl)ethylenediamine, hexamethylenediamine (HMDA) and ethylenediamine (EDA).

Suitable alcohols (M III) are all di- and polyalcohols. Suitable are furthermore ethoxylated and propoxylated di- and polyalcohols. In case the amount of M1.1 is 100% by weight, the reaction partner is water.

Polyaddition processes and the associated monomers (M I-M III) are described, for example, in U.S. Pat. No. 4,021,595, EP 0 392 876 and EP 0 535 384.

Particularly preferred are capsules with encapsulation material comprising polyurea, which are well known and can be prepared by analogy to prior art. They are preferably prepared by an interfacial polymerization process of a suitable polymer shell-forming material, such as a polyisocyanate and a polyamine. Interfacial polymerization is usually performed in an aqueous oil-in-water emulsion or suspension of the core material containing dissolved therein at least one part of the polymer shell-forming material. During the polymerization, the polymer segregates from the core material to the boundary surface between the core material and water thereby forming the shell of the capsule. Thereby an aqueous suspension of the capsule material is obtained. Suitable methods for interfacial polymerization processes for preparing capsules containing agrochemical compounds have been disclosed in prior art.

In general, polyurea is formed by reacting a polyisocyanate having at least two isocyanate groups with a polyamine having at least two primary amino groups to form a polyurea shell material.

In a further embodiment, the polyurea may be formed by contacting polyisocyanate with water. Preferably, the polyurea shell contains a polyisocyanate and a polyamine in polycondensed form. Suitable polyisocyanates are known, e.g. from US 2010/0248963 A 1, paragraphs [0135] to [0158], to which full reference is made. Suitable polyamines are known, e.g. from US 2010/0248963A1, paragraphs [0159] to [0169], to which full reference is made.

Polyisocyanates may be used individually or as mixtures of two or more polyisocyanates. Suitable polyisocyanates are for example aliphatic isocyanates or aromatic isocyanates. These isocyanates may be present as monomeric or oligomeric isocyanates. The NCO content may be determined according to ASTM D 5155-96 A.

Examples of suitable aliphatic diisocyanates include tetramethylene diisocyanate, pentamethylene diisocyanate and hexamethylene diisocyanate as well as cycloaliphatic isocycantates such as isophoronediisocyanate, 1,4-bisisocyanatocyclohexane and bis-(4-isocyanatocyclohexyl) methane.

Suitable aromatic isocyanates include toluene diisocyanates (TDI: a mixture of the 2,4- and 2,6-isomers), diphenylmethene-4,4′-diisocyanate (MDI), polymethylene polyphenyl isocyanate, 2,4,4′-diphenyl ether triisocyanate, 3,3′-dimethyl-4,4′-diphenyl diisocyanate, 3,3′-dimethoxy-4,4′diphenyl diisocyanate, 1,5-naphthylene diisocyanate and 4,4′,4″-triphenylmethane triisocyanate. Also suitable are higher oligomers of the aforementioned diisocyanates such as the isocyanurates and biurethes of the aforementioned diisocyanates and mixtures thereof with the aforementioned diisocyanates.

In another preferred embodiment, the polyisocyanate is an oligomeric isocyanate, preferably an aromatic, oligomeric isocyanate. Such oligomeric isocyanates may comprise above mentioned aliphatic diisocyanates and/or aromatic isocyanates in oligomerized form. The oligomeric isocyanates have an average functionality in the range of 2.0 to 4.0, preferably 2.1 to 3.2, and more preferably 2.3 to 3.0. Typically, these oligomeric isocyanates have a viscosity (determined according to DIN 53018) in the range from 20 to 1000 mPas, more preferably from 80 to 500 mPas and especially from 150 to 320 mPas. Such oligomeric isocyanates are commercially available, for example from BASF SE under the tradenames Lupranat® M10, Lupranat® M20, Lupranat® M50, Lupranat® M70, Lupranat® M200, Lupranat® MM103 or from Bayer AG as Basonat® A270.

Also suitable are adducts of diisocyanates with polyhydric alcohols, such as ethylene glycol, glycerol and trimethylolpropane, obtained by addition, per mole of polyhydric alcohol, of a number of moles of diisocyanate corresponding to the number of hydroxyl groups of the respective alcohol and mixtures thereof with the aforementioned diisocyanates. In this way, several molecules of diisocyanate are linked through urethane groups to the polyhydric alcohol to form high molecular weight polyisocyanates. A particularly suitable product of this kind, DESMODUR® L (Bayer Corp., Pittsburgh), can be prepared by reacting three moles of toluene diisocyanate with one mole of 2-ethylglycerol (1,1-bismethylolpropane). Further suitable products are obtained by addition of hexamethylene diisocyanate or isophorone diisocyanate with ethylene glycol or glycerol.

Preferred polyisocyanates are isophorone diisocyanate, diphenylmethane-4,4′-diisocyanate, toluene diisocyanates, and oligomeric isocyanates, wherein oligomeric isocyanates are in particular preferred.

Suitable polyamines within the scope of this invention will be understood as meaning in general those compounds that contain two and more amino groups in the molecule, which amino groups may be linked to aliphatic or aromatic moieties.

Examples of suitable aliphatic polyamines are α,ω-diamines of the formula H₂N—(CH₂)n-N H₂, wherein n is an integer from 2 to 6. Exemplary of such diamines are ethylenediamine, propylene-1,3-diamine, tetramethylenediamine, pentamethylenediamine and hexamethylenediamine. A preferred diamine is hexamethylenediamine. Further suitable aliphatic polyamines are polyethylenimines of the formula H₂N—(CH₂—CH₂—NH)ₙ—H, wherein n is an integer from 2 to 20, preferably 3 to 5. Representative examples of such polyethylenimines are diethylenetriamine, triethylenetetramine, tetraethylenepentamine and pentaethylenehexamine. Further suitable aliphatic polyamines are dioxaalkane-α,ω-diamines, such as 4,9-dioxadodecane-1,12-diamine of the formula H₂N—(CH₂)₃₀—(CH₂)₄O—(CH₂)₃—NH₂.

Examples of suitable aromatic polyamines are 1,3-phenylenediamine, 2,4- and 2,6-toluenediamine, 4,4′-diaminodiphenylmethane, 1,5-diaminonaphthalene, 1,3,5-triaminobenzene, 2,4,6-triaminotoluene, 1,3,6-triaminonaphthalene, 2,4,4′triaminodiphenyl ether, 3,4,5-triamino-1,2,4-triazole and 1,4,5,8-tetraaminoanthraquinone. Those polyamines which are insoluble or insufficiently soluble in water may be used as their hydrochloride salts.

Polyamines, such as those mentioned above may be used individually or as mixtures of two or more polyamines. Preferred polyamine is a polyethylenimine, such as tetraethylenepentamine.

The relative amounts of each complementary shell-forming component will vary with their equivalent weights. In general, approximately stoichiometric amounts are preferred, while an excess of one component may also be employed, especially an excess of polyisocyanate. The total amount of shell-forming components approximately corresponds to the total amount of polymeric shell-forming materials.

Preferred poly(meth)acrylates (b2) are obtainable by polymerization of

M2.1) 30 to 100% by weight, based on (b2), of at least one monomer (M IV) selected from the group of C₁-C₂₄-alkyl esters of acrylic acid, C₁-C₂₄-alkyl esters of methacrylic acid, acrylic acid, methacrylic acid, methacrylic anhydride, and methacrylonitrile;

M2.2) 0 to 70% by weight, based on (b2), of at least one monomer (M V), selected from the group of polyfunctional monomers, and

M2.3) 0 to 40% by weight, based on (b2), of at least one further monomer (M VI) which is structurally different from monomers (M IV) and (M V).

Preferred as monomers (M IV) are C₁-C₂₄-alkyl esters of acrylic and methacrylic acid, and also methacrylonitrile. Preferred monomers (M IV) are methyl acrylate, ethyl acrylate, n-propyl acrylate, isopropyl acrylate, n-butyl acrylate, isobutyl acrylate, sec-butyl acrylate and tert-butyl acrylate and stearyl acrylate, and also methyl methacrylate, ethyl methacrylate, n-propyl methacrylate, isopropyl methacrylate, n-butyl methacrylate, isobutyl methacrylate, sec-butyl methacrylate, tert-butyl methacrylate and methacrylonitrile and mixtures of the monomers mentioned above.

From among the monomers mentioned above, preference is given to the methacrylates. Particular preference is given to methyl acrylate, ethyl acrylate, isopropyl acrylate, n-butyl acrylate and tert-butyl acrylate and methyl methacrylate, ethyl methacrylate, isopropyl methacrylate, n-butyl methacrylate, tert-butyl methacrylate and stearyl acrylate. Methyl methacrylate, n-butyl acrylate and stearyl acrylate are especially preferred.

Suitable monomers (M V) are polyfunctional monomers which are sparingly soluble, if at all, in water but have good to limited solubility in lipophile substances. The sparing solubility of the monomers (M V) is to be understood as meaning a solubility of <60 g/l at 20° C. and 1013 mbar in water.

In the context of the invention, polyfunctional monomers are understood as meaning monomers having at least two non-conjugated double bonds. Preferred polyfunctional monomers are divinyl or polyvinyl monomers; esters of diols or polyols with acrylic acid; esters of diols or polyols with methacrylic acid; ethers of diols or polyols and allyl alcohol and ethers of diols or polyols and vinyl alcohol.

Particularly preferred monomers (M V) having two non-conjugated double bonds are 1,2-ethanediol diacrylate, 1,3-propanediol diacrylate, 1,4-butanediol diacrylate, 1,5-pentanediol diacrylate and 1,6-hexanediol diacrylate, 1,2-ethanediol dimethacrylate, 1,3-propanediol dimethacrylate, 1,4-butanediol dimethacrylate, 1,5-pentanediol dimethacrylate and 1,6-hexanediol dimethacrylate, divinylbenzene, ethylene glycol dimethacrylate, 1,3-butylene glycol dimethacrylate, methallylmethacrylamid and allyl methacrylate. Very particular preference is given to 1,3-propanediol diacrylate, 1,4-butanediol diacrylate, 1,5-pentanediol diacrylate and 1,6-hexanediol diacrylate, 1,3-propanediol dimethacrylate, 1,4-butanediol dimethacrylate, 1,5-pentanediol di-methacrylate and 1,6-hexanediol dimethacrylate.

Preferred monomers (M V) having more than two non-conjugated double bonds are trimethylolpropane triacrylate, trimethylolpropane trimethacrylate, pentaerythritol triallyl ether, pentaerythritol triacrylate and pentaerythritol tetraacrylate and mixtures thereof.

Suitable monomers (M VI) are monomers IIIa) such as butanediene, isoprene, vinyl acetate, vinyl propionate and vinylpyrridine and IIIb) water-soluble monomers such as acrylonitrile, methacrylamide, acrylic acid, methacrylic acid, itaconic acid, maleinic acid, maleic anhydride, N-vinylpyrrolidone, 2-hydroxyethyl acrylate, 2-hydroxyethyl methacrylate and acrylamido-2-methylpropanesulfonic acid, N-methylolacrylamide, N-methylolmethacrylamide, dimethylaminoethyl methacrylate and diethylaminoethyl methacrylate. Especially suitable are N-methylolacrylamide, N-methylolmethacrylamide, dimethylaminoethyl methacrylate and diethylaminoethyl methacrylate. Particular preference is given to the free acids, i.e. acrylic acid and in particular methacrylic acid, of the acrylates mentioned under M IV.

More preferred poly(meth)acrylates (b2) can be obtained by polymerization of

M2.1) 30 to 100% by weight based on (b2), of at least one monomer (M IV) selected from the group consisting of methyl acrylate, ethyl acrylate, isopropyl acrylate, n-butyl acrylate and tert-butyl acrylate and methyl methacrylate, ethyl methacrylate, isopropyl methacrylate, n-butyl methacrylate, tert-butyl methacrylate and stearyl acrylate;

M2.2) 0 to 70% by weight, based on (b2), of at least one monomer (M V) selected from the group consisting of butanediol diacrylate, trimethylolpropane triacrylate, trimethylolpropane trimethacrylate, pentaerythritol triallyl ether, pentaerythritol triacrylate and pentaerythritol tetraacrylate; and also

M2.3.) 0 to 40% by weight, based on (b2), of acrylic acid and/or methacrylic acid.

Particularly preferred poly(meth)acrylates (b2) can be obtained by polymerization of

M2.1) 30-100% by weight based on (b2), of at least one monomer (M IV) selected from the group consisting of methyl methacrylate, stearyl acrylate and n-butyl acrylate;

M2.2) 0 to 70% by weight, based on (b2), of at least one monomer (M V) selected from the group consisting of butanediol diacrylate, trimethylolpropane triacrylate, trimethylolpropane trimethacrylate, pentaerythritol triallyl ether, pentaerythritol triacrylate and pentaerythritol tetraacrylate; and also

M2.3) 0 to 40% by weight, based on (b2), of acrylic acid or methacrylic acid.

Poly(meth)acrylates (b2) can be obtained by processes known to the person skilled in the art, for example by free-radical, anionic or cationic polymerization in the absence of a solvent, in a solution, in a dispersion or in an emulsion. Preference is given to free-radical polymerization. Particular preference is given to aqueous free-radical emulsion polymerization, suspension polymerization and aqueous free-radical mini-emulsion polymerization.

In a particularly preferred embodiment, the polymer particle comprises, as component M2.3 (M VI), methacrylic acid in amounts of 1-50% by weight, preferably 1-20% by weight, in each case based on (b2).

Preferred melamine formaldehyde condensates (b3) are obtainable by polycondensation

M3.1) melamine formaldehyde prepolymers (M VII); and/or

M3.2) alkyl ethers of melamine formaldehyde prepolymers (M VIII).

Polymers (b3) can be obtained by known polycondensation reactions which are familiar to the person skilled in the art. The preparation of melamine formaldehyde resins and capsules is described, for example, in EP 0 974 394, U.S. Pat. No. 4,172,119, EP-A 0 026 914 and EP-A 0 218 887.

In view of the above, in one embodiment of the invention, capsules are preferred, wherein the shell material is selected from (b1) polyaddition products of isocyanate, which comprise

(b1a) at least one polyfunctional isocyanate and at least one polyfunctional amine in polymerized form; or

(b1b) at least one polyfunctional isocyanate and at least one polyfunctional alcohol in polymerized form; or

(b1c) at least one polyfunctional isocyanate and at least one polyfunctional amine and at least one polyfunctional alcohol in polymerized form.

Particularly preferred is polyurea as a shell material.

In another embodiment of the invention capsules are preferred, wherein the shell material is

(b2a) a poly(meth)acrylate comprising methyl methacrylate and/or methacrylic acid in polymerized form; or

(b3a) an aminoplast comprising melamine and formaldehyde in polymerized form.

In connection with (b2a) “and/or” means that the poly(meth)acrylate may comprise methyl methacrylate or methacrylic acid or the combination of the two in polymerized form.

In the capsules comprising a core (a) and a shell (b), wherein the core (a) is encapsulated by the shell (b), and wherein

the core (a) comprises compounds of formula I as defined in the claims and as defined above, and

the shell (b) comprises a shell material, which is selected from the group consisting of

(b1) polyaddition products of isocyanates;

(b2) poly(meth)acrylates; and

(b3) aminoplasts,

the weight ratio of the core (a) to the shell (b) may be from 50:50 to 99:1.

In a preferred embodiment, the weight ratio of the core (a) to the shell (b) is from 70:30 to 98:2, preferably from 75:25 to 95:5.

A skilled person is aware that the core/shell weight ratio is an important feature in terms of the release properties of the capsules. Depending on the shell material, optionally including the presence of a protective colloid (see explanations provided below), and the particle size of the capsules (see further details in this regard below), it may be required to adapt the core/shell weight ratio to achieve certain desired properties.

It is preferred according to the present invention that the shell material, the particle size of the capsules and the core/shell weight ratio are adapted such that at most 65%, preferably at most 50%, more preferably at most 30% by weight of the total amount of the active ingredient are released after 1 day at 20 to 25° C. It is preferred that at least 10%, more preferably at least 20%, more preferably at least 30% by weight of the total amount of the active ingredient are still present within the capsule after 3 days at 20 to 25° C.

The invention further relates to a method for preparing the capsules of the invention, comprising the steps of

a) mixing the compounds of formula I, optionally a water immiscible solvent, water and encapsulating agents,

b) adding a non-ionic or cationic surfactant or protective colloid as emulsifier,

c) emulsifying the mixture, and

d) optionally adding further encapsulation agents and polymerizing the encapsulation agents to form the capsules.

Surfactants which are suitable as emulsifiers are nonionic and cationic surfactants. Nonionic surfactants are preferred.

Suitable nonionic surfactants are alkoxylates, N-alkylated fatty acid amides, amine oxides, esters or sugar-based surfactants. Examples of alkoxylates are compounds such as alcohols, alkylphenols, amines (e.g. tallow amine), amides, arylphenols, fatty acids or fatty acid esters which have been alkoxylated. Ethylene oxide and/or propylene oxide may be employed for the alkoxylation, preferably ethylene oxide. Examples of N-alkylated fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of suitable cationic surfactants are quaternary surfactants, for example quaternary ammonium compounds with one or two hydrophobic groups, or salts of long-chain primary amines. Particularly preferred are nonionic surfactants where the hydrophobic part consists of alkyl, aralkyl, propylene oxide or butylene oxide, while the hydrophilic part consists of ethylene oxide or ethylene oxide/propylene oxide units.

Details regarding protective colloids are provided below.

The polymerization of the monomers may be initiated by heating. The polymerization can, if appropriate, be controlled through additional increase in temperature, the polymers produced forming the capsule shell which encloses the capsule core. This general principle is described, for example, in WO 03/0166050, on p. 7, I. 17 to p. 8, I. 8, to the content of which reference is expressly made. Generally, during the polymerization, less energy is introduced than during the emulsification. Preferably, for this, the stirring rate is reduced and/or another type of stirrer is used.

In case of capsules based on poly(meth)acrylates, polymerization of the momoners may also be initiated by adding a polymerization initiator. Suitable initiators are known in the art. The initiator can be present in both the aqueous and the continuous phase.

Generally, the polymerization is carried out at temperatures of from 20 to 150° C., preferably from 40 to 120° C., and especially from 60 to 95° C. Preferably, the heating is carried out stepwise.

Advantageously, the polymerization is carried out at standard pressure. However, it can also be operated under reduced or slightly elevated pressure, e.g. at a polymerization temperature of greater than 100° C., thus approximately in the region from 0.5 to 10 bar.

The reaction times for the polymerization are normally from 1 to 10 hours generally from 2 to 5 hours or from 1 to 3 hours.

Generally, the capsules may be prepared in the presence of at least one organic or inorganic protective colloid.

Therefore, in one embodiment of the invention, the shell (b) of the capsules comprises organic or inorganic protective colloids.

Both organic and inorganic protective colloids can be ionic or neutral. Protective colloids can in this connection be used both individually and in mixtures of several protective colloids with identical or different charges.

Preferred organic protective colloids are water-soluble polymers. Particular preference is given to organic protective colloids which reduce the surface tension of the water from 73 mN/m maximum to from 45 to 70 mN/m and accordingly promote the formation of closed capsule shells, and also form capsules with preferred particle sizes.

Neutral organic protective colloids are, for example, cellulose derivatives, such as hydroxyethylcellulose, methylhydroxyethylcellulose, methylcellulose and carboxymethylcellulose, polyvinylpyrrolidone, vinylpyrrolidone copolymers, gelatin, gum arabic, xanthan gum, casein, polyethylene glycol, polyvinyl alcohol and partially hydrolyzed polyvinyl acetates, and methylhydroxypropylcellulose.

Polyvinyl alcohol can be obtained by polymerization of vinyl acetate, if appropriate in the presence of co-monomers, and hydrolysis of the polyvinyl acetate with cleavage of acetyl groups with formation of hydroxyl groups. The degree of hydrolysis of the polymers can, for example, be from 1 to 100% and preferably lies in the range from 50 to 100%, in particular from 65 to 95%. The term “partially hydrolyzed polyvinyl acetates” is understood to mean, in the context of this patent application, a degree of hydrolysis of less than 50% and the tem “polyvinyl alcohol” is understood to mean a degree of hydrolysis of at least from 50 to 100%.

Preference is given to polyvinyl alcohols or partially hydrolyzed polyvinyl acetates, the viscosity of a 4% by weight aqueous solution of which exhibits, at 20° C. according to DIN 53015, a value in the range from 3 to 56 mPa·s, preferably a value from 14 to 45 mPa·s. Preference is given to polyvinyl alcohols with a degree of hydrolysis of at least 65%, preferably at least 70%, in particular at least 75%.

Anionic organic protective colloids are, for example, sodium alginate, polymethacrylic acid and its copolymers, and the copolymers of sulfoethyl acrylate, sulfoethyl methacrylate, sulfopropyl acrylate, sulfopropyl methacrylate, N-(sulfoethyl)maleimide, 2-acrylamido-2-alkylsulfonic acid, styrenesulfonic acid and vinylsulfonic acid. Preferred anionic organic protective colloids are naphthalenesulfonic acid and naphthalenesulfonic acid/fomaldehyde condensates and also, in particular, polyacrylic acids and phenolsulfonic acid/formaldehyde condensates.

Mention may be made, as inorganic protective colloids, of “Pickering systems”, which make possible stabilization by very fine solid particles and are insoluble but dispersible in water or are insoluble and nondispersible in water but wettable by the lipophilic substance.

A Pickering system can in this connection consist of solid particles alone or additionally of auxiliaries which improve the dispersibility of the particles in water or the wettability of the particles by the lipophilic phase.

The solid inorganic particles can be metal salts, such as salts, oxides and hydroxides of calcium, magnesium, iron, zinc, nickel, titanium, aluminum, silicon, barium or manganese. Mention may be made of magnesium hydroxide, magnesium carbonate, magnesium oxide, calcium oxalate, calcium carbonate, barium carbonate, barium sulfate, titanium dioxide, aluminum oxide, aluminum hydroxide and zinc sulfide. Silicates, bentonite, hydroxyapatite and hydrotalcite may likewise be mentioned. Particular preference is given to highly dispersed silicas, magnesium pyrophosphate or tricalcium phosphate.

The highly dispersed silicas can be dispersed as fine solid particles in water. However, it is also possible to use what are known as colloidal dispersions of silica in water, also described as silica sols. Such colloidal dispersions are alkaline aqueous mixtures of silica. In the alkaline pH region, the particles are swollen up and stable in water. For use of these dispersions as pickering system, it is advantageous for the pH of the oil-in-water emulsion to be adjusted with an acid to a pH of from 2 to 7.

According to one embodiment, inorganic protective colloids and their mixtures with organic protective colloids are preferred.

According to an additional embodiment, neutral organic protective colloids are preferred. Preference is given to protective colloids carrying OH groups, such as polyvinyl alcohols, partially hydrolyzed polyvinyl acetates and methylhydroxypropylcellulose. Particular preference is given to mixtures of at least two neutral protective colloids, in particular of at least two protective colloids carrying OH groups. Very particularly preferred are mixtures of polyvinyl alcohol and methylhydroxypropylcellulose.

Generally, the protective colloids are used in amounts of from 0.1 to 15% by weight, preferably from 0.5 to 10% by weight, based on the aqueous phase. For inorganic protective colloids, mixtures of from 0.1 to 15% by weight, preferably from 0.5 to 10% by weight, based on the aqueous phase, are preferably chosen in this connection.

Preference is given to organic protective colloids in amounts of from 0.1 to 15% by weight, preferably from 0.5 to 10% by weight, based on the aqueous phase of the emulsion. According to a specific embodiment, preference is given to from 0.1 to 15% by weight, preferably from 0.5 to 10% by weight, of neutral organic protective colloids. Particular preference is given in this connection to from 0.1 to 15% by weight, preferably from 0.5 to 10% by weight, of protective colloids carrying OH groups, such as polyvinyl alcohols, partially hydrolyzed polyvinyl acetates and methylhydroxypropylcellulose.

Depending on the preparation process and the protective colloid or protective colloids chosen in this connection, this can likewise be a constituent of the capsules. Thus, up to 20% by weight, based on the total weight of the capsules, can be protective colloid. According to this embodiment the capsules exhibit, on the surface of the polymer, the protective colloid or protective colloids.

Certain combinations of shell materials and protective colloids may be preferred according to the invention. For example, a polyurea shell may be stabilized by polyvinylalcohol as protective colloid, or by pickering stabilization. Similarly, a polyacrylate shell may be stabilized by polyvinylalcohol as protective colloid, or by pickering stabilization.

As explained above, the present invention not only relates to core/shell capsules (option (1)), but also to matrix-based capsules (option (2)). The matrix-based capsules are described in further detail hereinafter.

In another embodiment, the present invention therefore relates to capsules comprising a matrix (c), wherein the matrix (c) comprises compounds of formula I as defined in the claims and as defined above, and a matrix material, which is selected from

(c1) a poly(meth)acrylates; and
(c2) calcium alginate.

Thus, the matrix material may either be poly(meth)acrylate or calcium alginate.

The poly(meth)acrylates (c2) for the matrix can be obtained from the same monomers as defined above in connection with the poly(meth)acrylates (b2) as shell materials.

Calcium alginate (c1) may be obtained by solidifying a Na-alginate solution with CaCl₂. For example, calcium alginate capsules of the compounds of formula I may be obtained by emulsifying 20 wt % of the compounds of formula I in a 2% Na-alginate solution, and solidifying the mixture in a CaCl₂ solution. The obtained beads typically have a volume median particle size of 3 to 5 mm and may be used for direct fertilizer mixing. Alternatively, small beads of 300 μm or less may be prepared and applied as suspension. Other particle sizes as defined below may also be realized.

The active ingredient concentration in the matrix capsules may vary over a broad range. Preferably, the matrix (c) contains at least 10 wt % of the compounds of formula I, based on the total amount of the matrix. The matrix (c) may contain up to 95 wt %, preferably up to 70 wt % of the compounds of formula I.

In general, both the core/shell capsules and the matrix-based capsules may be provided as capsules, which are suitable for direct fertilizer mixing, or as microcapsules being provided, e.g., in the form of a capsule suspension.

In one embodiment, the capsules according to the invention therefore have a volume median particle size of
more than 300 μm, preferably 1 mm or more, more preferably from 1 to 6 mm, even more preferably from 3 to 5 mm; or
300 μm or less, preferably from 50 nm to 200 μm, more preferably from 0.5 μm to 50 μm.

If the capsules have a volume median particle size of more than 300 μm, preferably 1 mm or more, they are particularly suitable for direct application.

If the capsules have a volume median particle size of 300 μm or less, they are particularly suitable for application in the form of a capsule suspension (CS).

The volume median particle size may be determined by laser diffraction, which is a well established technique covered by ISO13320 (2009). Details regarding laser diffraction are also provided in CIPAC MT187 (CIPAC Handbook K).

In case of microcapsules, the D50 is preferably 0.5 to 80 μm, more preferably 1.0 to 50 μm, even more preferably 2.0 to 10.0 μm, most preferably 2.0 to 8.0 μm; and the D90 is preferably 1.0 to 145 μm, more preferably 2.0 to 60 μm, even more preferably 4.0 to 20 μm, most preferably 6.0 to 15.0 μm.

The following combinations of D50 and D90 values are preferred: D50: 0.5 to 80 μm and D90: 1.0 to 145 μm, preferably D50: 1.0 to 50 μm and D90: 2.0 to 60 μm, more preferably D50: 2.0 to 10.0 μm and D90: 4.0 to 20 μm, most preferably D50: 2.0 to 8.0 μm, D90: 6.0 to 15.0 μm.

The invention further provides an aqueous composition comprising the capsules according to the invention. The aqueous composition contains usually from 5 to 80 wt % of the capsules, preferably from 10 to 60 wt %. The aqueous composition contains usually at least 2 wt % encapsulated compounds of formula I, preferably at least 5 wt % and in particular at least 8 wt %. The aqueous composition contains usually less than 79.2 wt % of the compounds of formula I, preferably less than 59.4 wt %. Preferably, the aqueous composition comprises from 2 wt % to 79.2 wt. %, preferably from 5 wt % to 75 wt %, more preferably from 8 wt % to 59.4 wt % of the compounds of formula I.

Typically, the composition comprises from 0.5 to 25 wt %, preferably from 1.0 to 20 wt % and in particular from 2.0 to 15 wt % surface-active substances. Preferred surface-active substances are those listed above.

The aqueous compositions according to the invention may also comprise auxiliaries which are customary in agrochemical formulations. The auxiliaries used depend on the particular application form and active substance, respectively. Examples for suitable auxiliaries are dispersants or emulsifiers (such as further solubilizers, protective colloids, surfactants and adhesion agents), organic and inorganic thickeners, bactericides, anti-freezing agents, anti-foaming agents, if appropriate colorants and tackifiers or binders (e.g. for seed treatment formulations).

Suitable surface-active substances (adjuvants, wetters, stickers, dispersants or emulsifiers) are preferably the ones listed above.

Examples for thickeners (i. e. compounds that impart a modified flowability to compositions, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA). Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie). Examples for suitable anti-freezing agents are ethylene glycol, propylene glycol, urea and glycerin. Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof. Examples for tackifiers or binders are polyvinylpyrrolidons, polyvinylacetates, polyvinyl alcohols and cellulose ethers (Tylose®, Shin-Etsu, Japan).

The present invention also covers non-aqueos compositions comprising the capsules of the invention, for which the above preferences regarding the active ingredient concentration, surface-active substances and auxiliaries may also apply. Instead of an aqueous phase, an oil phase may be used, so that an oil dispersion is obtained.

Suitable ratios of the suspended phase, i.e. the phase comprising the capsules of the invention, and the liquid phase, e.g. the aqueous phase or the oil phase, are in the range of from 1:0.5 to 1:100, more preferably from 1:1 to 1:10.

The capsules as used in capsule suspensions as defined above preferably have a volume median particle size of 300 μm or less, and are often referred to as microcapsules.

In view of the above, the present invention relates in one embodiment to a capsule suspension comprising
a suspended phase comprising the capsules as defined herein, wherein the capsules have a volume median particle size of 1 mm or less, preferably 300 μm or less; and
a liquid phase;

wherein the ratio of the suspended phase to the liquid phase is preferably from 1:0.5 to 1:100, more preferably from 1:1 to 1:10.

Preferably, the ratio can be in the range of form 1:1 to 1:7, e.g. from 1:1 to 1:4.

In a preferred embodiment, surface-active substances and/or auxiliaries as defined above may additionally be present.

The liquid phase may be an oil phase or an aqueous phase. Preferably, the liquid phase is an aqueous phase.

As the capsules of the invention comprise compounds of formula I, which exhibit activity as nitrification inhibitors, the capsules or capsule suspensions of the invention may advantageously be used in mixtures comprising a fertilizer and the capsules or capsule suspensions of the invention. Alternatively, the capsules or capsule suspensions may be used in mixtures with carriers, which may then, e.g., be applied to or in combination with fertilizers.

Furthermore, the capsules, capsule suspensions, and mixtures of the invention may advantageously be used for agricultural applications in particular with the purpose of inhibiting nitrification. In particular, they are beneficial in terms of the long-term activity.

In one embodiment, the present invention relates to a mixture comprising

(i) an inorganic carrier granule, an organic carrier granule, a fertilizer, a composition comprising a fertilizer, or a granule comprising a fertilizer; and
(ii) capsules, or the capsule suspension according to the invention.

Preferences regarding mixtures comprising a fertilizer are defined in further detail below.

If the mixture comprises an inorganic or organic carrier granule as component (i), it can be preferred that this mixture is applied to or in combination with a fertilizer. Inorganic carriers preferably include clay, attapulgite, bentonite based carriers. Organic carriers preferably include cellulose pulp based carriers.

In general, inorganic and organic carriers (hereinafter referred to as carriers) include solid carriers such as phytogels, or hydrogels, or mineral earths e.g. silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g. an solid or liquid ammonium-containing inorganic fertilizer such as an NPK fertilizer, ammonium nitrate, calcium ammonium nitrate, ammonium sulfate nitrate, ammonium sulfate or ammonium phosphate; an solid or liquid organic fertilizer such as liquid manure, semi-liquid manure, stable manure, biogas manure and straw manure, worm castings, compost, seaweed or guano, or an urea-containing fertilizer such as urea, formaldehyde urea, anhydrous ammonium, urea ammonium nitrate (UAN) solution, urea sulphur, stabilized urea, urea based NPK-fertilizers, or urea ammonium sulfate, and products of vegetable origin, such as cereal meal, tree bark meal, wood meal and nutshell meal, cellulose powders and other solid carriers. Further suitable examples of carriers include fumed silica or precipitated silica, which may, for instance, be used in solid formulations as flow aid, anti-caking aid, milling aid and as carrier for liquid active ingredients. Additional examples of suitable carriers are microparticles, for instance microparticles which stick to plant leaves and release their content over a certain period of time. In specific embodiments, agrochemical carriers such as composite gel microparticles that can be used to deliver plant-protection active principles, e.g. as described in U.S. Pat. No. 6,180,141; or compositions comprising at least one phytoactive compound and an encapsulating adjuvant, wherein the adjuvant comprises a fungal cell or a fragment thereof, e.g. as described in WO 2005/102045; or carrier granules, coated with a lipophilic tackifier on the surface, wherein the carrier granule adheres to the surface of plants, grasses and weeds, e.g. as disclosed in US 2007/0280981 may be used. In further specific embodiments, such carriers may include specific, strongly binding molecule which assure that the carrier sticks to the plant, the seed, and/or loci where the plant is growing or is intended to grow, till its content is completely delivered. For instance, the carrier may be or comprise cellulose binding domains (CBDs) have been described as useful agents for attachment of molecular species to cellulose (see U.S. Pat. No. 6,124,117); or direct fusions between a CBD and an enzyme; or a multifunctional fusion protein which may be used for delivery of encapsulated agents, wherein the multifunctional fusion proteins may consist of a first binding domain which is a carbohydrate binding domain and a second binding domain, wherein either the first binding domain or the second binding domain can bind to a microparticle (see also WO 03/031477). Further suitable examples of carriers include bifunctional fusion proteins consisting of a CBD and an anti-RR6 antibody fragment binding to a microparticle, which complex may be deposited onto treads or cut grass (see also WO 03/031477). In another specific embodiment the carrier may be active ingredient carrier granules that adhere to e.g. the surface of plants, grasses, weeds, seeds, and/or loci where the plant is growing or is intended to grow etc. using a moisture-active coating, for instance including gum arabic, guar gum, gum karaya, gum tragacanth and locust bean gum. Upon application of the inventive granule onto a plant surface, water from precipitation, irrigation, dew, co-application with the granules from special application equipment, or guttation water from the plant itself may provide sufficient moisture for adherence of the granule to the plant surface (see also US 2007/0280981).

In another specific embodiment the carrier may be or comprise polyaminoacids. Polyaminoacids may be obtained according to any suitable process, e.g. by polymerization of single or multiple amino acids such as glycine, alanine, valine, leucine, isoleu-cine, phenylalanine, proline, tryptophan, serine, tyrosine, cysteine, methionine, asparagine, glutamine, threonine, aspartic acid, glutamic acid, lysine, arginine, histidine and/or ornithine. Polyaminoacids may be combined with a nitrification inhibitor according to the present invention and, in certain embodiments, also with further carriers as mentioned herein above, or other nitrification inhibitors as mentioned herein in any suitable ratio. For example, polyaminoacids may be combined with a nitrification inhibitor according to the present invention in a ratio of 1 to 10 (polyaminoacids) vs. 0.5 to 2 (nitrification inhibitor according to the present invention).

In one embodiment, the present invention relates to the use of the capsules, or the capsule suspension, or the mixture according to the invention for agrochemical applications, wherein the use preferably comprises applying the capsules, or the capsule suspension, or the mixture according to the invention to the root zone of a plant, the soil, soil substituents and/or the locus where a plant is growing or is intended to grow.

Preferably, the use is for reducing nitrification.

In one embodiment, the present invention relates to a method for reducing nitrification comprising applying the capsules, or the capsule suspension, or the mixture according to the invention to the root zone of a plant, the soil, soil substituents and/or the locus where a plant is growing or is intended to grow.

It is preferred in connection with the above use or method that the root zone of a plant, the soil, soil substituents and/or the locus where a plant is growing or is intended to grow is additionally provided with a fertilizer, wherein the application of the capsules, or the capsule suspension, or the mixture according to the invention, and the fertilizer may be carried out simultaneously or with a time lag, preferably an interval of up to 1 day, 2 days, 3 days, 1 week, 2 weeks, or 3 weeks.

In connection with the mixture of the invention, and the above use or method that the fertilizer comprises
a solid or liquid ammonium-containing inorganic fertilizer, preferably a NPK fertilizer, ammonium nitrate, calcium ammonium nitrate, ammonium sulfate nitrate, ammonium sulfate, or ammonium phosphate;
a solid or liquid organic fertilizer, preferably liquid manure, semi-liquid manure, biogas manure, stable manure and straw manure, worm castings, compost, seaweed or guano; or
an urea-containing fertilizer such as urea, formaldehyde urea, urea ammonium nitrate (UAN) solution, urea sulphur, stabilized urea, urea based NPK-fertilizers, or urea ammonium sulfate.

Further preferences regarding the uses, methods and mixtures of the invention are defined hereinafter.

The use according to the invention may be based on the application of the capsules, or the capsule suspension, or the mixture according to the invention to a plant growing on soil and/or the locus where the plant is growing or is intended to grow, or the use may be based on the application of the capsules, or the capsule suspension, or the mixture according to the invention to soil where a plant is growing or is intended to grow or to soil substituents. In specific embodiments, the capsules, or the capsule suspension, or the mixture according to the invention may be used for reducing nitrification in the absence of plants, e.g. as preparatory activity for subsequent agricultural activity, or for reducing nitrification in other technical areas, which are not related to agriculture, e.g. for environmental, water protection, energy production or similar purposes. In specific embodiments, the capsules, or the capsule suspension, or the mixture according to the invention may be used for the reduction of nitrification in sewage, slurry, manure or dung of animals, e.g. swine or bovine feces. For example, the capsules, or the capsule suspension, or the mixture according to the invention may be used for the reduction of nitrification in sewage plants, biogas plants, cowsheds, liquid manure tanks or containers etc. In further embodiments, the capsules, or the capsule suspension, or the mixture according to the invention may be used for the reduction of nitrification in situ in animals, e.g. in productive livestock. Accordingly, the capsules, or the capsule suspension, or the mixture according to the invention may be fed to an animal, e.g. a mammal, for instance together with suitable feed and thereby lead to a reduction of nitrification in the gastrointestinal tract of the animals, which in turn is resulting in reduction of emissions from the gastrointestinal tract. This activity, i.e. the feeding of the capsules, or the capsule suspension, or the mixture according to the invention may be repeated one to several times, e.g. each 2nd, 3rd, 4th, 5th, 6th, 7th day, or each week, 2 weeks, 3 weeks, or month, 2 months etc.

The use may further include the application of the capsules, or the capsule suspension, or the mixture according to the invention to environments, areas or zones, where nitrification takes place or is assumed or expected to take place. Such environments, areas or zones may not comprise plants or soil. For example, the capsules, or the capsule suspension, or the mixture according to the invention may be used for nitrification inhibition in laboratory environments, e.g. based on enzymatic reactions or the like. Also envisaged is the use in green houses or similar indoor facilities.

The term “reducing nitrification” or “reduction of nitrification” as used herein refers to a slowing down or stopping of nitrification processes, e.g. by retarding or eliminating the natural transformation of ammonium into nitrate. Such reduction may be a complete or partial elimination of nitrification at the plant or locus where the capsules, or the capsule suspension, or the mixture according to the invention are applied. For example, a partial elimination may result in a residual nitrification on or in the plant, or in or on the soil or soil substituents where a plant grows or is intended to grow of about 90% to 1%, e.g. 90%, 85%, 80%, 70%, 60%, 50%, 40%, 30%, 20%, 10% or less than 10%, e.g. 5% or less than 5% in comparison to a control situation where the capsules, or the capsule suspension, or the mixture according to the invention are not used. In certain embodiments, a partial elimination may result in a residual nitrification on or in the plant or in or on the soil or soil substituents where a plant grows or is intended to grow of below 1%, e.g. at 0.5%, 0.1% or less in comparison to a control situation where the capsules, or the capsule suspension, or the mixture according to the invention are not used.

The use of the capsules, or the capsule suspension, or the mixture according to the invention for reducing nitrification may be a single use, or it may be a repeated use. As single use, the nitrification inhibitor or corresponding compositions may be provided to their target sites, e.g. soil or loci, or objects, e.g. plants, only once in a physiologically relevant time interval, e.g. once a year, or once every 2 to 5 years, or once during the lifetime of a plant.

In other embodiments, the use may be repeated at least once per time period, e.g. the capsules, or the capsule suspension, or the mixture according to the invention may be used for reducing nitrification at their target sites or objects two times within a time interval of days, weeks or months. The term “at least once” as used in the context of a use of the capsules, or the capsule suspension, or the mixture according to the invention means that the capsules, or the capsule suspension, or the mixture according to the invention may be used two times, or several times, i.e. that a repetition or multiple repetitions of an application or treatment may be envisaged. Such a repetition may be a 2 times, 3 times, 4 times, 5 times, 6 times, 7 times, 8 times, 9 times, 10 times or more frequent repetition of the use.

The term “irrigation” as used herein refers to the watering of plants or loci or soils or soil substituents where a plant grows or is intended to grow, wherein said watering includes the provision of the capsules, or the capsule suspension, or the mixture according to the invention together with water.

The capsules, or the capsule suspension, or the mixture according to the invention may further comprise additional ingredients, for example at least one pesticidal compound. For example, the capsules, or the capsule suspension, or the mixture according to the invention may additionally comprise at least one herbicidal compound and/or at least one fungicidal compound and/or at least one insecticidal compound and/or at least one nematicide and/or at least one biopesticide and/or at least one biostimulant.

In further embodiments, the capsules, or the capsule suspension, or the mixture according to the invention may further comprise one or more alternative or additional nitrification inhibitors. Examples of envisaged alternative or additional nitrification inhibitors are linoleic acid, alpha-linolenic acid, methyl p-coumarate, methyl ferulate, methyl 3-(4-hydroxyphenyl) propionate (MHPP), Karanjin, brachialacton, p-benzoquinone sorgoleone, 2-chloro-6-(trichloromethyl)-pyridine (nitrapyrin or N-serve), dicyandiamide (DCD, DIDIN), 3,4-dimethyl pyrazole phosphate (DMPP, ENTEC), 2-(3,4-dimethyl-1H-pyrazol-1-yl) succinic acid or 2-(4,5-dimethyl-1H-pyrazol-1-yl) succinic acid (DMPSA), 3,4-dimethyl pyrazolium glycolate (DMGA), 3,4-dimethyl pyrazolium citrate (DMPC), 3,4-dimethyl pyrazolium lactate (DMPL), 3,4-dimethyl pyrazolium mandelate (DMPM), 1,2,4-triazole, 4-Chloro-3-methylpyrazole (CIMP), 4-amino-1,2,4-triazole hydrochloride (ATC), 1-amido-2-thiourea (ASU), 2-amino-4-chloro-6-methylpyrimidine (AM), 2-mercapto-benzothiazole (MBT), 5-ethoxy-3-trichloromethyl-1,2,4-thiodiazole (terrazole, etridiazole), 2-sulfanilamidothiazole (ST), ammoniumthiosulfate (ATU), 3-methylpyrazol (3-MP), 3,5-dimethylpyrazole (DMP), 1,2,4-triazol thiourea (TU), N-(1H-pyrazolyl-methyl)acetamides such as N-((3(5)-methyl-1H-pyrazole-1-yl)methyl)acetamide, and N-(1H-pyrazolyl-methyl)formamides such as N-((3(5)-methyl-1H-pyrazole-1-yl)methyl formamide, N-(4-chloro-3(5)-methyl-pyrazole-1-ylmethyl)-formamide, a reaction adduct of dicyandiamide, urea and formaldehyde as described in WO 2011/137393 A1 or US2016/0060184 A1, N-(3(5),4-dimethylpyrazole-1-ylmethyl)-formamide, neem, products based on ingredients of neem, cyan amide, melamine, zeolite powder, catechol, benzoquinone, sodium terta board, zinc sulfate.

In further embodiments, the capsules, or the capsule suspension, or the mixture according to the invention may further comprise one or more urease inhibitors. Examples of envisaged urease inhibitors include N-(n-butyl) thiophosphoric acid triamide (NBPT, Agrotain), N-(n-propyl) thiophosphoric acid triamide (NPPT), 2-nitrophenyl phosphoric triamide (2-NPT), further NXPTs known to the skilled person, phenylphosphorodiamidate (PPD/PPDA), hydroquinone, ammonium thiosulfate, and mixtures of NBPT and NPPT (see e.g. U.S. Pat. No. 8,075,659). Such mixtures of NBPT and NPPT may comprise NBPT in amounts of from 40 to 95% wt.-% and preferably of 60 to 80% wt.-% based on the total amount of active substances. Such mixtures are marketed as LIMUS, which is a composition comprising about 16.9 wt.-% NBPT and about 5.6 wt.-% NPPT and about 77.5 wt.-% of other ingredients including solvents and adjuvants.

In further embodiments, the capsules, or the capsule suspension, or the mixture according to the invention may further comprise one or more plant growth regulators. Examples of envisaged plant growth regulators are antiauxins, auxins, cytokinins, defoliants, ethylene modulators, ethylene releasers, gibberellins, growth inhibitors, morphactins, growth retardants, growth stimulators, and further un-classified plant growth regulators.

Suitable examples of antiauxins to be used according to the present invention are clofibric acid or 2,3,5-tri-iodobenzoic acid.

Suitable examples of auxins to be used according to the present invention are 4-CPA, 2,4-D, 2,4-DB, 2,4-DEP, dichlorprop, fenoprop, IAA (indole-3-acetic acid), IBA, naphthaleneacetamide, alpha-naphthaleneacetic acid, 1-naphthol, naphthoxyacetic acid, potassium naph-thenate, sodium naphthenate or 2,4,5-T.

Suitable examples of cytokinins to be used according to the present invention are 2iP, 6-Benzylaminopurine (6-BA) (═N-6 Benzyladenine), 2,6-Dimethylpuridine (N-Oxide-2,6-Lultidine), 2,6-Dimethylpyridine, kinetin, or zeatin.

Suitable examples of defoliants to be used according to the present invention are calcium cyanamide, dimethipin, endothal, merphos, metoxuron, pentachlorophenol, thidiazuron, tribufos, or tributyl phosphorotrithioate.

Suitable examples of ethylene modulators to be used according to the present invention are aviglycine, 1-methylcyclopropene (1-MCP), prohexadione (prohexadione calcium), or trinexapac (Trinexapac-ethyl).

Suitable examples of ethylene releasers to be used according to the present invention are ACC, etacelasil, ethephon, or glyoxime.

Suitable examples of gibberellins to be used according to the present invention are gibberelline or gibberellic acid.

Suitable examples of growth inhibitors to be used according to the present invention are abscisic acid, S-abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat (mepiquat chloride, mepiquat pentaborate), piproctanyl, prohydrojasmon, propham, or 2,3,5-triiodobenzoic acid.

Suitable examples of morphactins to be used according to the present invention are chlorfluren, chlorflurenol, dichlorflurenol, or flurenol Suitable examples of growth retardants to be used according to the present invention are chlormequat (chlormequat chloride), daminozide, flurprimidol, mefluidide, paclobutra-zol, tetcyclacis, uniconazole, metconazol.

Suitable examples of growth stimulators to be used according to the present invention are brassinolide, forchlorfenuron, or hymexazol.

Suitable examples of further unclassified plant growth regulators to be used according to the present invention are amidochlor, benzofluor, buminafos, carvone, choline chloride, ciobutide, clofencet, cloxyfonac, cyanamide, cyclanilide, cycloheximide, cyprosulfamide, epocholeone, ethychlozate, ethylene, fenridazon, fluprimidol, fluthiacet, heptopargil, holosulf, ina-benfide, karetazan, lead arsenate, methasulfocarb, pydanon, sintofen, diflufenzopyr or triapenthenol.

In a preferred embodiment, the capsules, or the capsule suspension, or the mixture according to the invention may comprise a combination of the nitrification inhibitor of the compound of formula I and at least one compound selected from the group comprising: abscisic acid, amidochlor, ancymidol, 6-benzylaminopurine (═N-6 benzyladenine), brassinolide, butralin, chlormequat (chlormequat chloride), choline chlo-ride, cyclanilide, daminozide, diflufenzopyr, dikegulac, dimethipin, 2,6-dimethylpyridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), 1-methylcyclopropene (1-MCP), naphthaleneacetic acid, N-6 benzyladenine, paclobutrazol, prohexadione (prohexadione calcium), prohydrojasmon, thidiazuron, triapenthenol, tributyl phosphorotrithioate, 2,3,5-tri-iodobenzoic acid, trinexapacethyl, and uniconazole.

In further embodiments, the capsules, or the capsule suspension, or the mixture according to the invention may further comprise one or more pesticides.

A pesticide is generally a chemical or biological agent (such as pesticidal active ingredient, compound, composition, virus, bacterium, antimicrobial or disinfectant) that through its effect deters, incapacitates, kills or otherwise discourages pests. Target pests can include insects, plant pathogens, weeds, mollusks, birds, mammals, fish, nematodes (roundworms), and microbes that destroy property, cause nuisance, spread disease or are vectors for disease. The term “pesticide” includes also plant growth regulators that alter the expected growth, flowering, or reproduction rate of plants; defoliants that cause leaves or other foliage to drop from a plant, usually to facilitate harvest; desiccants that promote drying of living tissues, such as unwanted plant tops; plant activators that activate plant physiology for defense of against certain pests; safeners that reduce unwanted herbicidal action of pesticides on crop plants; and plant growth promoters that affect plant physiology e.g. to increase plant growth, biomass, yield or any other quality parameter of the harvestable goods of a crop plant.

The following list of pesticides I (e. g. pesticidally active substances), in con-junction with which the compounds I can be used, is intended to illustrate the possible combinations but does not limit them:

A) Respiration Inhibitors
Inhibitors of complex III at Qo site (e. g. strobilurins): azoxystrobin (A.1.1), coumeth¬oxystrobin (A.1.2), coumoxystrobin (A.1.3), dimoxystrobin (A.1.4), enestroburin (A.1.5), fenaminstrobin (A.1.6), fenoxy¬strobin/flufenoxystrobin (A.1.7), fluoxastro¬bin (A.1.8), kresoxim-methyl (A.1.9), mandestrobin (A.1.10), meto¬minostrobin (A.1.11), orysastrobin (A.1.12), picoxy¬strobin (A.1.13), pyraclostrobin (A.1.14), pyrametostrobin (A.1.15), pyraoxystrobin (A.1.16), tri-floxystrobin (A.10.17), 2 (2-(3-(2,6-di¬chlorophenyl)-1-methyl-allylidene¬aminooxy¬methyl)-phenyl)-2-methoxyimino-N methyl-acetamide (A.1.18), pyribencarb (A.1.19), triclopy-ricarb/chlorodin¬carb (A.1.20), famoxadone (A.1.21), fenamidone (A.1.21), methyl-N-[2-[(1,4-dimethyl-5-phenyl-pyrazol-3-yl]oxylmethyl]phenyl]-N-methoxy-carbamate (A.1.22), 1-[3-chloro-2-[[1-(4-chlorophenyl)-1H-pyrazol-3-yl]oxymethyl]¬phenyl]-4-methyl-tetrazol-5-one (A.1.23), 1-[3-bromo-2-[[1-(4-chlorophenyl)pyrazol-3-yl]¬oxy¬methyl]phenyl]-4-methyl-tetrazol-5-one (A.1.24), 1-[2-[[1-(4-chlorophenyl)pyrazol-3-yl]oxy¬methyl]-3-methyl-phenyl]-4-methyl-tetrazol-5-one (A.1.25), 1-[2-[[1-(4-chlorophenyl)py¬razol-3-yl]oxymethyl]-3-fluoro-phenyl]-4-methyl-tetrazol-5-one (A. 1.26), 1-[2-[[1-(2,4-dichloro¬phenyl)pyrazol-3-yl]oxymethyl]-3-fluoro-phenyl]-4-methy-tetrazol-5-one (A.1.27),

1-[2-[[4-(4-chlorophenyl)thiazol-2-yl]oxymethyl]-3-methyl-phenyl]-4-methyl-tetrazol-5-one (A.1.28), 1-[3-chloro-2-[[4-(p-tolyl)thiazol-2-yl]oxymethyl]phenyl]-4-methyl-tetrazol-5-one (A.1.29), 1-[3-cyclopropyl-2-[[2-methyl-4-(1-methylpyrazol-3-yl)phenoxy]¬methyl]phenyl]-4 methyl-tetrazol-5-one (A.1.30), 1-[3-(difluoromethoxy)-2-[[2-methyl-4-(1 methylpyrazol-3 yl)phenoxy]methyl]phenyl]-4-methyl-tetrazol-5-one (A.1.31), 1-methyl-4-[3-methyl-2 [[2 methyl-4-(1-methylpyrazol-3-yl)phenoxy]methyl]phenyl]tetrazol-5-one (A.1.32), 1-me¬thyl-4-[3-methyl-2-[[1-[3-(trifluoromethyl)phenyl]-ethylideneamino]oxymethyl]phenyl]¬tetrazol-5 one (A.1.33), (Z,2E)-5-[1-(2,4-dichlorophenyl)pyrazol-3-yl]-oxy-2-methoxyimino-N,3-dimethyl-pent-3-enamide (A.1.34), (Z,2E)-5-[1-(4-chlorophenyl)pyrazol-3-yl]oxy-2-methoxyimino-N,3-dimethyl-pent-3-enamide (A.1.35), (Z,2E)-5-[1-(4-chloro-2-fluoro-phenyl)pyrazol-3-yl]oxy-2-methoxyimino-N,3-dimethyl-pent-3-enamide (A.1.36),
inhibitors of complex III at Qi site: cyazofamid (A.2.1), amisulbrom (A.2.2), [(3S,6S,7R,8R)-8-benz¬yl-3-[(3-acetoxy-4 methoxy-pyridine-2-carbonyl)amino]-6 methyl-4,9-dioxo-1,5-di¬oxonan-7-yl] 2 methylpropanoate (A.2.3), [(3S,6S,7R,8R)-8-benzyl-3-[[3-(acet¬oxymeth¬oxy)-4-methoxy-pyridine-2 carbonyl]amino]-6-methyl-4,9-dioxo-1,5-dioxonan-7-yl] 2 methylpropanoate (A.2.4), [(3S,6S,7R,8R)-8-benzyl-3-[(3-isobut¬oxycarbonyloxy-4-meth¬oxy-pyri¬dine-2 carbonyl)amino]-6-methyl-4,9-dioxo-1,5-dioxonan-7-yl] 2-methylpro¬panoate (A.2.5), [(3S,6S,7R,8R)-8-benzyl-3-[[3-(1,3-ben¬zodioxol-5-ylmethoxy)-4-methoxy-pyri¬dine-2 car-bonyl]amino]-6-methyl-4,9-di¬oxo-1,5-dioxonan-7-yl] 2-methyl¬propanoate (A.2.6); (3S,6S,7R,8R)-3-[[(3-hydroxy-4-methoxy-2-pyridinyl)carbonyl]amino]-6 methyl-4,9-dioxo-8 (phenyl-methyl)-1,5-dioxonan-7-yl 2-methylpropanoate (A.2.7), (3S,6S,7R,8R)-8-benzyl-3 [3 [(isobutyryloxy)methoxy]-4-methoxypicolinamido]-6-methyl-4,9-dioxo-1,5-dioxonan-7-yl isobutyrate (A.2.8);
inhibitors of complex II (e. g. carboxamides): benodanil (A.3.1), benzovindiflupyr (A.3.2), bixafen (A.3.3), boscalid (A.3.4), carboxin (A.3.5), fen¬furam (A.3.6), fluopyram (A.3.7), flutolanil (A.3.8), fluxapyroxad (A.3.9), furametpyr (A.3.10), isofetamid (A.3.11), iso¬pyrazam (A.3.12), mepronil (A.3.13), oxycarboxin (A.3.14), penflufen (A.3.14), penthiopyrad (A.3.15), sedaxane (A.3.16), tecloftalam (A.3.17), thifluz¬amide (A.3.18), N-(4′-trifluoromethylthiobiphenyl-2-yl)-3 difluoromethyl-1-methyl-1H pyrazole-4-carboxamide (A.3.19), N-(2-(1,3,3-trimethyl-butyl)-phenyl)-1,3-dimethyl-5 fluoro-1H-pyr¬azole-4 carboxamide (A.3.20), 3 (difluoromethyl)-1-methyl-N-(1,1,3-trimethyl¬indan-4-yl)pyrazole-4-carboxamide (A.3.21), 3 (trifluoromethyl)-1-methyl-N-(1,1,3-trimethyl¬indan-4-yl)pyrazole-4-carboxamide (A.3.22), 1,3-dimethyl-N-(1,1,3-trimethylindan-4-yl)pyr¬azole-4-carboxamide (A.3.23), 3-(trifluorometh¬yl)-1,5-dimethyl-N-(1,1,3-trimethylindan-4-yl)¬pyrazole-4-carboxamide (A.3.24), 1,3,5-tri¬methyl-N-(1,1,3-trimethylindan-4-yl)pyrazole-4-car¬boxamide (A.3.25), N-(7-fluoro-1,1,3-trimethyl-indan-4-yl)-1,3-dimethyl-pyrazole-4-carbox¬amide (A.3.26), N-[2-(2,4-dichlorophenyl)-2-methoxy-1-methyl-ethyl]-3-(difluoromethyl)-1-methyl-pyrazole-4-carboxamide (A.3.27);
other respiration inhibitors (e. g. complex I, uncouplers): diflumetorim (A.4.1), (5,8-difluoro-quinazolin-4-yl)-{2-[2-fluoro-4-(4-trifluoromethylpyridin-2-yloxy)-phenyl]-ethyl}-amine (A.4.2); nitrophenyl derivates: binapacryl (A.4.3), dinobuton (A.4.4), dinocap (A.4.5), fluazinam (A.4.6); ferimzone (A.4.7); organometal compounds: fentin salts, such as fentin-acetate (A.4.8), fentin chloride (A.4.9) or fentin hydroxide (A.4.10); ametoctradin (A.4.11); and silthiofam (A.4.12);

B) Sterol Biosynthesis Inhibitors (SBI Fungicides)
C14 demethylase inhibitors (DMI fungicides): triazoles: azaconazole (B.1.1), bitertanol (B.1.2), bromuconazole (B.1.3), cyproconazole (B.1.4), difenoconazole (B.1.5), diniconazole (B.1.6), diniconazole-M (B.1.7), epoxiconazole (B.1.8), fenbuconazole (B.1.9), fluquinconazole (B.1.10), flusilazole (B.1.11), flutriafol (B.1.12), hexaconazole (B.1.13), imibenconazole (B.1.14), ipconazole (B.1.15), metconazole (B.1.17), myclobutanil (B.1.18), oxpoconazole (B.1.19), paclobutrazole (B.1.20), penconazole (B.1.21), propiconazole (B.1.22), prothio-conazole (B.1.23), simeconazole (B.1.24), tebuconazole (B.1.25), tetraconazole (B.1.26), tri-adimefon (B.1.27), triadimenol (B.1.28), triticonazole (B.1.29), uniconazole (B.1.30), 1-[rel-(2S;3R)-3-(2-chloro¬phenyl)-2-(2,4-difluorophenyl)-oxiranylmethyl]-5 thio¬cyanato-1H-[1,2,4]triazolo (B.1.31), 2-[rel-(2S;3R)-3-(2-chlorophenyl)-2-(2,4-difluorophenyl)-oxi¬ranyl-methyl]-2H [1,2,4]triazole-3-thiol (B.1.32), 2-[2-chloro-4-(4-chlorophenoxy)¬phenyl]-1 (1,2,4-triazol-1-yl)pentan-2-ol (B.1.33), 1-[4-(4-chlorophenoxy)-2-(trifluoro¬methyl)phenyl]-1 cyclopropyl-2-(1,2,4-triazol-1-yl)ethanol (B.1.34), 2-[4-(4-chloro¬phenoxy)-2-(trifluorometh-yl)phenyl]-1-(1,2,4-triazol-1-yl)butan-2-ol (B.1.35), 2 [2 chloro-4-(4-chlorophenoxy)phenyl]-1-(1,2,4-triazol-1-yl)butan-2-ol (B.1.36), 2 [4 (4 chloro¬phenoxy)-2-(trifluoromethyl)phenyl]-3-methyl-1-(1,2,4-triazol-1 yl)butan-2-ol (B.1.37), 2-[4-(4-chlorophenoxy)-2-(trifluoromethyl)-phenyl]-1-(1,2,4-triazol-1-yl)propan-2-ol (B.1.38), 2-[2-chloro-4-(4-chlorophenoxy)phenyl]-3-methyl-1-(1,2,4-triazol-1-yl)butan-2-ol (B.1.39), 2-[4-(4-chlorophenoxy)-2-(trifluoromethyl)-phenyl]-1-(1,2,4-triazol-1-yl)pentan-2-ol (B.1.40), 2-[4-(4-fluorophenoxy)-2-(trifluoromethyl)-phenyl]-1-(1,2,4-triazol-1-yl)propan-2-ol (B.1.41), 2-[2-chloro-4-(4-chlorophenoxy)phenyl]-1-(1,2,4-triazol-1-yl)pent-3-yn-2-ol (B.1.5l); imidazoles: imazalil (B.1.42), pefurazoate (B.1.43), prochloraz (B.1.44), triflumizol (B.1.45); pyrimidines, pyridines and piperazines: fenarimol (B.1.46), nuarimol (B.1.47), pyrifenox (B.1.48), triforine (B.1.49), [3-(4-chloro-2-fluoro-phenyl)-5-(2,4-difluoro-phenyl)isoxazol-4-yl]-(3-pyridyl)methanol (B.1.50);
Delta14-reductase inhibitors: aldimorph (B.2.1), dodemorph (B.2.2), dodemorph-acetate (B.2.3), fenpropimorph (B.2.4), tridemorph (B.2.5), fenpropidin (B.2.6), piperalin (B.2.7), spiroxamine (B.2.8);
Inhibitors of 3-keto reductase: fenhexamid (B.3.1);

C) Nucleic Acid Synthesis Inhibitors
phenylamides or acyl amino acid fungicides: benalaxyl (C.1.1), benalaxyl-M (C.1.2), kiralaxyl (C.1.3), metalaxyl (C.1.4), metalaxyl-M (mefenoxam, C.1.5), ofurace (C.1.6), oxadixyl (C.1.7);
others: hymexazole (C.2.1), octhilinone (C.2.2), oxolinic acid (C.2.3), bupirimate (C.2.4), 5-fluorocytosine (C.2.5), 5-fluoro-2-(p-tolylmethoxy)pyrimidin-4-amine (C.2.6), 5-fluoro-2-(4-fluorophenylmethoxy)pyrimidin-4 amine (C.2.7);

D) Inhibitors of Cell Division and Cytoskeleton
tubulin inhibitors, such as benzimidazoles, thiophanates: benomyl (D1.1), carbendazim (D1.2), fuberidazole (D1.3), thiabendazole (D1.4), thiophanate-methyl (D1.5); triazolopyrimidines: 5-chloro-7 (4 methylhpiperidin-1-yl)-6-(2,4,6-trifluoro¬phenyl)-[1,2,4]tri¬azolo[1,5 a]pyrimidine (D1.6);
other cell division inhibitors: diethofencarb (D2.1), ethaboxam (D2.2), pencycuron (D2.3), fluopicolide (D2.4), zoxamide (D2.5), metrafenone (D2.6), pyriofenone (D2.7);

E) Inhibitors of Amino Acid and Protein Synthesis
methionine synthesis inhibitors (anilino-pyrimidines): cyprodinil (E.1.1), mepani¬pyrim (E.1.2), pyrimethanil (E.1.3);
protein synthesis inhibitors: blasticidin-S(E.2.1), kasugamycin (E.2.2), kasugamycin hydro-chloride-hydrate (E.2.3), mildiomycin (E.2.4), streptomycin (E.2.5), oxytetra¬cyclin (E.2.6), pol-yoxine (E.2.7), validamycin A (E.2.8);

F) Signal Transduction Inhibitors
MAP/histidine kinase inhibitors: fluoroimid (F.1.1), iprodione (F.1.2), procymidone (F.1.3), vinclozolin (F.1.4), fenpiclonil (F.1.5), fludioxonil (F.1.6);
G protein inhibitors: quinoxyfen (F.2.1);

G) Lipid and Membrane Synthesis Inhibitors
Phospholipid biosynthesis inhibitors: edifenphos (G.1.1), iprobenfos (G.1.2), pyrazo¬phos (G.1.3), isoprothiolane (G.1.4);
lipid peroxidation: dicloran (G.2.1), quintozene (G.2.2), tecnazene (G.2.3), tolclofos-methyl (G.2.4), biphenyl (G.2.5), chloroneb (G.2.6), etridiazole (G.2.7);
phospholipid biosynthesis and cell wall deposition: dimethomorph (G.3.1), flumorph (G.3.2), mandipropamid (G.3.3), pyrimorph (G.3.4), benthiavalicarb (G.3.5), iprovali¬carb (G.3.6), valifenalate (G.3.7) and N-(1-(1-(4-cyano-phenyl)¬ethanesulfonyl)-but-2-yl) carbamic acid-(4-fluorophenyl) ester (G.3.8);
compounds affecting cell membrane permeability and fatty acides: propamocarb (G.4.1);
fatty acid amide hydrolase inhibitors: oxathiapiprolin (G.5.1), 2-{3-[2-(1-{[3,5-bis(difluoromethyl-1H-pyrazol-1-yl]acetyl}piperid in-4-yl)-1,3-thiazol-4-yl]-4,5-d ihyd ro-1,2 oxazol-5-yl}phenyl methanesulfonate (G.5.2), 2-{3-[2-(1-{[3,5-bis(difluoro-me-thyl)-1H-pyrazol-1-yl]acetyl}piperidin-4-yl) 1,3-thiazol-4-yl]-4,5-dihydro-1,2-oxazol-5 yl}-3-chlorophenyl methanesulfonate (G.5.3);

H) Inhibitors with Multi Site Action
inorganic active substances: Bordeaux mixture (H.1.1), copper acetate (H.1.2), copper hydrox-ide (H.1.3), copper oxychloride (H.1.4), basic copper sulfate (H.1.5), sulfur (H.1.6);
thio- and dithiocarbamates: ferbam (H.2.1), mancozeb (H.2.2), maneb (H.2.3), metam (H.2.4), metiram (H.2.5), propineb (H.2.6), thiram (H.2.7), zineb (H.2.8), ziram (H.2.9);
organochlorine compounds (e. g. phthalimides, sulfamides, chloronitriles): anilazine (H.3.1), chlorothalonil (H.3.2), captafol (H.3.3), captan (H.3.4), folpet (H.3.5), dichlofluanid (H.3.6), dichlorophen (H.3.7), hexachloro-benzene (H.3.8), pentachlorphenole (H.3.9) and its salts, phthalide (H.3.10), tolylfluanid (H.3.11), N (4-chloro-2-nitro-phenyl)-N-ethyl-4-methylbenzenesulfonamide (H.3.12);
guanidines and others: guanidine (H.4.1), dodine (H.4.2), dodine free base (H.4.3), guazatine (H.4.4), guazatine-acetate (H.4.5), iminoctadine (H.4.6), iminoctadine-triacetate (H.4.7), imino-ctadine-tris(albesilate) (H.4.8), dithianon (H.4.9), 2,6-di¬methyl-1H,5H-[1,4]dithiino[2,3-c:5,6-c′]dipyrrole-1,3,5,7(2H,6H)-tetraone (H.4.10);

I) Cell Wall Synthesis Inhibitors
inhibitors of glucan synthesis: validamycin (I.1.1), polyoxin B (I.1.2);
melanin synthesis inhibitors: pyroquilon (I.2.1), tricyclazole (I.2.2), carpropamid (I.2.3), dicy-clomet (I.2.4), fenoxanil (I.2.5);

J) Plant Defence Inducers
acibenzolar-S-methyl (J.1.1), probenazole (J.1.2), isotianil (J.1.3), tiadinil (J.1.4), prohexadi-one-calcium (J.1.5); phosphonates: fosetyl (J.1.6), fosetyl-aluminum (J.1.7), phosphorous acid and its salts (J.1.8), potassium or sodium bicarbonate (J.1.9);

K) Unknown Mode of Action
bronopol (K.1.1), chinomethionat (K.1.2), cyflufenamid (K.1.3), cymoxanil (K.1.4), dazomet (K.1.5), debacarb (K.1.6), diclo¬mezine (K.1.7), difenzoquat (K.1.8), difenzoquat-methylsulfate (K.1.9), diphenylamin (K.1.10), fenpyrazamine (K.1.11), flumetover (K.1.12), flusulfamide (K.1.13), flutianil (K.1.14), methasulfocarb (K.1.15), nitrapyrin (K.1.16), nitrothal-isopropyl (K.1.18), oxathiapiprolin (K.1.19), tolprocarb (K.1.20), oxin-copper (K.1.21), proquinazid (K.1.22), tebufloquin (K.1.23), tecloftalam (K.1.24), triazoxide (K.1.25), 2 butoxy-6-iodo-3 propylchromen-4-one (K.1.26), 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]etha¬none (K.1.27), 2-[3,5-bis(difluoromethyl)-1H-pyrazol-1-yl]-1-[4-(4-{5-[2-fluoro-6-(prop-2-yn-1-yl-oxy)phenyl]-4,5-dihydro-1,2-oxazol-3-yl}-1,3-thi¬azol-2-yl)piperidin-1-yl]ethanone (K.1.28), 2 [3,5-bis(d ifluoromethyl)-1H-pyrazol-1-yl]-1-[4-(4-{5-[2-chloro-6-(prop-2-yn-1-yl¬oxy)phenyl]-4,5-dihydro-1,2-oxazol-3-yl}-1,3-thiazol-2 yl)piperidin-1-yl]ethanone (K.1.29), N-(cyclo-propylmethoxyimino-(6-difluoro-methoxy-2,3 di-fluoro-phenyl)-methyl)-2-phenyl acetamide (K.1.30), N′-(4-(4-chloro-3-trifluoro¬methyl-phen¬oxy)-2,5-dimethyl-phenyl)-N-ethyl-N methyl formamidine (K.1.31), N′ (4-(4-fluoro-3-trifluoro¬methyl-phenoxy)-2,5-dimethyl-phenyl)-N-ethyl-N-methyl formamidine (K.1.32), N′-(2-methyl-5-trifluoromethyl-4-(3-trimethyl¬silanyl-prop-oxy)-phenyl)-N-ethyl-N-methyl forma¬midine (K.1.33), N′-(5-difluoromethyl-2 methyl-4-(3-tri-methylsilanyl-propoxy)-phenyl)-N-ethyl-N-methyl formamidine (K.1.34), methoxy-acetic acid 6-tert-butyl-8-fluoro-2,3-dimethyl-quinolin-4-yl ester (K.1.35), 3-[5-(4-methylphenyl)-2,3-dimethyl-isoxazolidin-3 yl]-pyridine (K.1.36), 3 [5-(4-chloro-phenyl)-2,3-dimethyl-isoxazolidin-3-yl]-pyridine (pyrisoxazole) (K.1.37), N-(6-meth-oxy-pyridin-3-yl) cyclopropane¬carboxylic acid amide (K.1.38), 5-chloro-1 (4,6-di¬methoxy-pyrimidin-2-yl)-2-methyl-1H-ben¬zoimidazole (K.1.39), 2-(4-chloro-phenyl)-N-[4-(3,4-dimeth¬oxy-phenyl)-isoxazol-5-yl]-2-prop-2-ynyloxy-acetamide, ethyl (Z) 3 amino-2-cyano-3-phenyl-prop-2-enoate (K.1.40), picarbutrazox (K.1.41), pentyl N-[6-[[(Z)-[(1-methyltetrazol-5-yl)-phenyl-methylene]amino]oxy¬methyl]-2-pyridyl]carbamate (K.1.42), 2-[2-[(7,8-difluoro-2-methyl-3-quinolyl)oxy]-6-fluoro-phenyl]propan-2-ol (K. 1.43), 2-[2-fluoro-6-[(8-fluoro-2-methyl-3-quinolyl)oxy]-phen-yl]propan-2-oI (K.1.44), 3-(5-fluoro-3,3,4,4-tetramethyl-3,4-dihydroiso¬quinolin-1-yl)¬quinoline (K.1.45), 3-(4,4-difluoro-3,3-dimethyl-3,4-dihydroisoquinolin-1-yl)¬quin¬oline (K.1.46), 3-(4,4,5-trifluoro-3,3-dimethyl-3,4-dihydroisoquinolin-1-yl)quinoline (K.1.47), 9-fluoro-2,2-dimethyl-5-(3-quinolyl)-3H 1,4-benzoxazepine (K.1.48);

L)

M) Insecticides

M.1) Acetylcholine esterase (AChE) inhibitors from the class of: M.1A carbamates, for example aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; or from the class of M.1B or-ganophosphates, for example acephate, azamethiphos, azinphos-ethyl, azinphosme-thyl, cadusafos, chlorethoxyfos, chlorfenvinphos, chlormephos, chlorpyrifos, chlorpyri-fos-methyl, coumaphos, cyanophos, demeton-S-methyl, diazinon, dichlorvos/DDVP, dicrotophos, dimethoate, dimethylvinphos, disulfoton, EPN, ethion, ethoprophos, fam-phur, fenamiphos, fenitrothion, fenthion, fosthiazate, heptenophos, imicyafos, isofenphos, isopropyl O-(methoxyaminothio-phosphoryl) salicylate, isoxathion, mala-thion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, prope-tamphos, prothiofos, pyraclofos, pyridaphenthion, quinalphos, sulfotep, tebupirimfos, temephos, terbufos, tetrachlorvinphos, thiometon, triazophos, trichlorfon and vami-dothion;

M.2) GABA-gated chloride channel antagonists such as: M.2A cyclodiene organochlorine compounds, as for example endosulfan or chlordane; or M.2B fiproles (phenylpyra-zoles), as for example ethiprole, fipronil, flufiprole, pyrafluprole and pyriprole;

M.3) Sodium channel modulators from the class of M.3A pyrethroids, for example acrinathrin, allethrin, d-cis-trans allethrin, d-trans allethrin, bifenthrin, bioallethrin, bioal-lethrin S-cylclopentenyl, bioresmethrin, cycloprothrin, cyfluthrin, beta-cyfluthrin, cyhalo-thrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, em-penthrin, esfenvalerate, etofenprox, fenpropathrin, fenvalerate, flucythrinate, flumethrin, tau-fluvalinate, halfenprox, heptafluthrin, imiprothrin, meperfluthrin, metofluthrin, mom-fluorothrin, permethrin, phenothrin, prallethrin, profluthrin, pyrethrin (pyrethrum), resmethrin, silafluofen, tefluthrin, tetramethylfluthrin, tetramethrin, tralomethrin and transfluthrin; or M.3B sodium channel modulators such as DDT or methoxychlor;

M.4) Nicotinic acetylcholine receptor agonists (nAChR) from the class of M.4A neonicotinoids, for example acetamiprid, clothianidin, cycloxaprid, dinotefuran, imidacloprid, nitenpyram, thiacloprid and thiamethoxam; or the compounds M.4A.2: (2E-)-1-[(6-Chloropyridin-3-yl)methyl]-N′-nitro-2-pentylidenehydrazinecarboximidamide; or M4.A.3: 1-[(6-Chloropyridin-3-yl)methyl]-7-methyl-8-nitro-5-propoxy-1,2,3,5,6,7-hexahydroimidazo[1,2-a]pyridine; or from the class M.4B nicotine;

M.5) Nicotinic acetylcholine receptor allosteric activators from the class of spinosyns, for ex-ample spinosad or spinetoram;

M.6) Chloride channel activators from the class of avermectins and milbemycins, for exam-pie abamectin, emamectin benzoate, ivermectin, lepimectin or milbemectin;

M.7) Juvenile hormone mimics, such as M.7A juvenile hormone analogues as hydroprene, kinoprene and methoprene; or others as M.7B fenoxycarb or M.7C pyriproxyfen;

M.8) miscellaneous non-specific (multi-site) inhibitors, for example M.8A alkyl halides as me-thyl bromide and other alkyl halides, or M.8B chloropicrin, or M.8C sulfuryl fluoride, or M.8D borax, or M.8E tartar emetic;

M.9) Selective homopteran feeding blockers, for example M.9B pymetrozine, or M.9C floni-camid;

M.10) Mite growth inhibitors, for example M.10A clofentezine, hexythiazox and diflovidazin, or M.10B etoxazole;

M.11) Microbial disruptors of insect midgut membranes, for example Bacillus thuringiensis or Bacillus sphaericus and the insecticdal proteins they produce such as Bacillus thurin-giensis subsp. israelensis, Bacillus sphaericus, Bacillus thuringiensis subsp. aizawai, Bacillus thuringiensis subsp. kurstaki and Bacillus thuringiensis subsp. tenebrionis, or the Bt crop proteins: Cry1Ab, Cry1Ac, Cry1Fa, Cry2Ab, mCry3A, Cry3Ab, Cry3Bb and Cry34/35Ab1;

M.12) Inhibitors of mitochondrial ATP synthase, for example M.12A diafenthiuron, or M.12B organotin miticides such as azocyclotin, cyhexatin or fenbutatin oxide, or M.12C pro-pargite, or M.12D tetradifon;

M.13) Uncouplers of oxidative phosphorylation via disruption of the proton gradient, for example chlorfenapyr, DNOC or sulfluramid;

M.14) Nicotinic acetylcholine receptor (nAChR) channel blockers, for example nereistoxin analogues as bensultap, cartap hydrochloride, thiocyclam or thiosultap sodium;

M.15) Inhibitors of the chitin biosynthesis type 0, such as benzoylureas as for example bistrifluron, chlorfluazuron, diflubenzuron, flucycloxuron, flufenoxuron, hexaflumuron, lufenu-ron, novaluron, noviflumuron, teflubenzuron or triflumuron;

M.16) Inhibitors of the chitin biosynthesis type 1, as for example buprofezin;

M.17) Moulting disruptors, Dipteran, as for example cyromazine;

M.18) Ecdyson receptor agonists such as diacylhydrazines, for example methoxyfenozide, tebufenozide, halofenozide, fufenozide or chromafenozide;

M.19) Octopamin receptor agonists, as for example amitraz;

M.20) Mitochondrial complex III electron transport inhibitors, for example M.20A hydramethylnon, or M.20B acequinocyl, or M.20C fluacrypyrim;

M.21) Mitochondrial complex I electron transport inhibitors, for example M.21A METI acaricides and insecticides such as fenazaquin, fenpyroximate, pyrimidifen, pyridaben, tebufenpyrad or tolfenpyrad, or M.21 B rotenone;

M.22) Voltage-dependent sodium channel blockers, for example M.22A indoxacarb, or M.22B metaflumizone, or M.22B.1: 2-[2-(4-Cyanophenyl)-1-[3-(trifluoromethyl)phenyl]-ethylidene]-N-[4-(difluoromethoxy)phenyl]-hydrazinecarboxamide or M.22B.2: N-(3-Chloro-2-methylphenyl)-2-[(4-chlorophenyl)[4-[methyl(methylsulfonyl)amino]phenyl]-methylene]-hydrazinecarboxamide;

M.23) Inhibitors of the of acetyl CoA carboxylase, such as Tetronic and Tetramic acid derivatives, for example spirodiclofen, spiromesifen or spirotetramat;

M.24) Mitochondrial complex IV electron transport inhibitors, for example M.24A phosphine such as aluminium phosphide, calcium phosphide, phosphine or zinc phosphide, or M.24B cyanide;

M.25) Mitochondrial complex II electron transport inhibitors, such as beta-ketonitrile derivatives, for example cyenopyrafen or cyflumetofen;

M.28) Ryanodine receptor-modulators from the class of diamides, as for example flubendiamide, chlorantraniliprole (Rynaxypyr®), cyantraniliprole (Cyazypyr®), tetraniliprole, or the phthalamide compounds M.28.1: (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and M.28.2: (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, or the compound M.28.3: 3-bromo-N-{2-bromo-4-chloro-6-[(1-cyclopropylethyl)carbamoyl]phenyl}-1-(3-chlorpyridin-2-yl)-1H-pyrazole-5-carboxamide (proposed ISO name: cyclaniliprole), or the compound M.28.4: methyl-2-[3,5-dibromo-2-({[3-bromo-1-(3-chlorpyridin-2-yl)-1H-pyrazol-5-yl]carbonyl}-amino)benzoyl]-1,2-dimethylhydrazinecarboxylate; or a compound selected from M.28.5a) to M.28.5d) and M.28.5h) to M.28.5l): M.28.5a)N-[4,6-dichloro-2-[(diethyl-lambda-4-sulfanylidene)-carbamoyl]-phenyl]-2-(3-chloro-2-pyridyl)-5-(trifluoromethyl)pyrazole-3-carboxamide; M.28.5b) N-[4-chloro-2-[(diethyl-lambda-4-sulfanylidene)carbamoyl]-6-methyl-phenyl]-2-(3-chloro-2-pyridyl)-5-(trifluoromethyl)pyrazole-3-carboxamide; M.28.5c) N-[4-chloro-2-[(di-2-propyl-lambda-4-sulfanyl idene)carbamoyl]-6-methyl-phenyl]-2-(3-chloro-2-pyridyl)-5-(trifluoromethyl)pyrazole-3-carboxamide; M.28.5d) N-[4,6-dichloro-2-[(di-2-propyl-lambda-4-sulfanylidene)carbamoyl]-phenyl]-2-(3-chloro-2-pyridyl)-5-(trifluoro-methyl)pyrazole-3-carboxamide; M.28.5h) N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide; M.28.5i) N-[2-(5-Amino-1,3,4-thiadiazol-2-yl)-4-chloro-6-methylphenyl]-3-bromo-1-(3-chloro-2-pyridinyl)-1H-pyrazole-5-carboxamide; M.28.5j) 3-Chloro-1-(3-chloro-2-pyridinyl)-N-[2,4-dichloro-6-[[(1-cyano-1-methylethyl)amino]carbonyl]phenyl]-1H-pyrazole-5-carboxamide; M.28.5k) 3-Bromo-N-[2,4-dichloro-6-(methylcarbamoyl)phenyl]-1-(3,5-dichloro-2-pyridyl)-1H-pyrazole-5-carboxamide; M.28.5l) N-[4-Chloro-2-[[(1,1-dimethylethyl)amino]carbonyl]-6-methylphenyl]-1-(3-chloro-2-pyridinyl)-3-(fluoromethoxy)-1H-pyrazole-5-carboxamide; or a compound se-lected from M.28.6: N-(2-cyanopropan-2-yl)-N-(2,4-dimethylphenyl)-3-iodobenzene-1,2-dicarboxamide; or M.28.7: 3-Chloro-N-(2-cyanopropan-2-yl)-N-(2,4-dimethylphenyl)-benzene-1,2-dicarboxamide;

M.29) insecticidal active compounds of unknown or uncertain mode of action, as for example afidopyropen, afoxolaner, azadirachtin, amidoflumet, benzoximate, bifenazate, broflani-lide, bromopropylate, chinomethionat, cryolite, dicloromezotiaz, dicofol, flufenerim, flometoquin, fluensulfone, fluhexafon, fluopyram, flupyradifurone, fluralaner, metoxadi-azone, piperonyl butoxide, pyflubumide, pyridalyl, pyrifluquinazon, sulfoxaflor, tioxazaf-en, triflumezopyrim, or the compounds;

M.29.3: 11-(4-chloro-2,6-dimethylphenyl)-12-hydroxy-1,4-dioxa-9-azadispiro[4.2.4.2]-tetradec-11-en-10-one, or the compound M.29.4: 3-(4′-fluoro-2,4-dimethylbiphenyl-3-yl)-4-hydroxy-8-oxa-1-azaspiro[4.5]dec-3-en-2-one, or the compound M.29.5: 1-[2-fluoro-4-methyl-5-[(2,2,2-trifluoroethyl)sulfinyl]phenyl]-3-(trifluoromethyl)-1H-1,2,4-triazole-5-amine, or actives on basis of Bacillus firmus (Votivo, 1-1582);

or a compound selected from the group of M.29.6, wherein the compound is selected from M.29.6a) to M.29.6k): M.29.6a) (E/Z)—N-[1-[(6-chloro-3-pyridyl)methyl]-2-pyridylidene]-2,2,2-trifluoro-acetamide; M.29.6b) (E/Z)—N-[1-[(6-chloro-5-fluoro-3-pyridyl)methyl]-2-pyridylidene]-2,2,2-trifluoro-acetamide; M.29.6c) (E/Z)-2,2,2-trifluoro-N-[1-[(6-fluoro-3-pyridyl)methyl]-2-pyridylidene]acetamide; M.29.6d) (E/Z)—N-[1-[(6-bromo-3-pyridyl)methyl]-2-pyridylidene]-2,2,2-trifluoro-acetamide; M.29.6e) (E/Z)—N-[1-[1-(6-chloro-3-pyridyl)ethyl]-2-pyridylidene]-2,2,2-trifluoro-acetamide; M.29.6f) (E/Z)—N-[1-[(6-chloro-3-pyridyl)methyl]-2-pyridylidene]-2,2-difluoroacetamide; M.29.6g) (E/Z)-2-chloro-N-[1-[(6-chloro-3-pyridyl)methyl]-2-pyridylidene]-2,2-difluoroacetamide; M.29.6h) (E/Z)—N-[1-[(2-chloropyrimidin-5-yl)methyl]-2-pyridylidene]-2,2,2-trifluoroacetamide; M.29.6i) (E/Z)—N-[1-[(6-chloro-3-pyridyl)methyl]-2-pyridylidene]-2,2,3,3,3-pentafluoropropanamide.); M.29.6j) N-[1-[(6-chloro-3-pyridyl)methyl]-2-pyridylidene]-2,2,2-trifluorothioacetamide; or M.29.6k) N-[1-[(6-chloro-3-pyridyl)methyl]-2-pyridylidene]-2,2,2-trifluoro-N′-isopropyl-acetamidine; or the compounds M.29.8: 8-chloro-N-[2-chloro-5-methoxyphenyl)sulfonyl]-6-trifluoromethyl)-imidazo[1,2-a]pyridine-2-carboxamide;

or the compounds M.29.9.a): 4-[5-(3,5-dichlorophenyl)-5-(trifluoromethyl)-4H-isoxazol-3-yl]-2-methyl-N-(1-oxothietan-3-yl)benzamide; or M.29.9.b): 4-[5-(3,5-Dichlorophenyl)-5-trifluoromethyl-4,5-dihydroisoxazol-3-yl]-N-[(methoxyimino)methyl]-2-methylbenzamide;

or M.29.10: 5-[3-[2,6-dichloro-4-(3,3-dichloroallyloxy)phenoxy]propoxy]-1H-pyrazole;

or a compound selected from the group of M.29.11, wherein the compound is selected from M.29.11 b) to M.29.11 p): M.29.11.b) 3-(benzoylmethylamino)-N-[2-bromo-4-[1,2,2,3,3,3-hexafluoro-1-(trifluoromethyl)propyl]-6-(trifluoromethyl)phenyl]-2-fluoro-benzamide; M.29.11.c) 3-(benzoylmethylamino)-2-fluoro-N-[2-iodo-4-[1,2,2,2-tetrafluoro-1-(trifluoromethyl)ethyl]-6-(trifluoromethyl)phenyl]-benzamide; M.29.11.d) N-[3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide; M.29.11.e) N-[3-[[[2-bromo-4-[1,2,2,2-tetrafluoro-1-(trifluoromethyl)ethyl]-6-(trifluoromethyl)phenyl]amino]carbonyl]-2-fluorophenyl]-4-fluoro-N-methyl-benzamide; M.29.11.f) 4-fluoro-N-[2-fluoro-3-[[[2-iodo-4-[1,2,2,2-tetrafluoro-1-(trifluoromethyl)-ethyl]-6-(trifluoromethyl)phenyl]amino]carbonyl]phenyl]-N-methyl-benzamide; M.29.11.g) 3-fluoro-N-[2-fluoro-3-[[[2-iodo-4-[1,2,2,2-tetrafluoro-1-(trifluoromethyl)-ethyl]-6-(trifluoromethyl)phenyl]amino]carbonyl]phenyl]-N-methyl-benzamide; M.29.11.h) 2-chloro-N-[3-[[[2-iodo-4-[1,2,2,2-tetrafluoro-1-(trifluoromethyl)ethyl]-6-(trifluoromethyl)phenyl]amino]carbonyl]phenyl]-3-pyridinecarboxamide; M.29.11.i) 4-cyano-N-[2-cyano-5-[[2,6-dibromo-4-[1,2,2,3,3,3-hexafluoro-1-(trifluoromethyl)-propyl]phenyl]carbamoyl]phenyl]-2-methyl-benzamide; M.29.11.j) 4-cyano-3-[(4-cyano-2-methylbenzoyl)amino]-N-[2,6-dichloro-4-[1,2,2,3,3,3-hexafluoro-1-(trifluoromethyl)-propyl]phenyl]-2-fluoro-benzamide; M.29.11.k) N-[5-[[2-chloro-6-cyano-4-[1,2,2,3,3,3-hexafluoro-1-(trifluoromethyl)propyl]phenyl]carbamoyl]-2-cyano-phenyl]-4-cyano-2-methyl-benzamide; M.29.11.l) N-[5-[[2-bromo-6-chloro-4-[2,2,2-trifluoro-1-hydroxy-1-(trifluoromethyl)ethyl]phenyl]carbamoyl]-2-cyano-phenyl]-4-cyano-2-methyl-benzamide; M.29.11.m) N-[5-[[2-bromo-6-chloro-4-[1,2,2,3,3,3-hexafluoro-1-(trifluoromethyl)-propyl]phenyl]carbamoyl]-2-cyano-phenyl]-4-cyano-2-methyl-benzamide; M.29.11.n) 4-cyano-N-[2-cyano-5-[[2,6-dichloro-4-[1,2,2,3,3,3-hexafluoro-1-(trifluoromethyl)-propyl]phenyl]carbamoyl]phenyl]-2-methyl-benzamide; M.29.11.o) 4-cyano-N-[2-cyano-5-[[2,6-dichloro-4-[1,2,2,2-tetrafluoro-1-(trifluoromethyl)ethyl]phenyl]carbamoyl]-phenyl]-2-methylbenzamide; M.29.11.p) N-[5-[[2-bromo-6-chloro-4-[1,2,2,2-tetrafluoro-1-(trifluoromethyl)ethyl]phenyl]carbamoyl]-2-cyano-phenyl]-4-cyano-2-methyl-benzamide;

or a compound selected from the group of M.29.12, wherein the compound is selected from M.29.12a) to M.29.12m): M.29.12.a) 2-(1,3-Dioxan-2-yl)-6-[2-(3-pyridinyl)-5-thiazolyl]-pyridine; M.29.12.b) 2-[6-[2-(5-Fluoro-3-pyridinyl)-5-thiazolyl]-2-pyridinyl]-pyrimidine; M.29.12.c) 2-[6-[2-(3-Pyridinyl)-5-thiazolyl]-2-pyridinyl]-pyrimidine; M.29.12.d) N-Methylsulfonyl-6-[2-(3-pyridyl)thiazol-5-yl]pyridine-2-carboxamide; M.29.12.e) N-Methylsulfonyl-6-[2-(3-pyridyl)thiazol-5-yl]pyridine-2-carboxamide; M.29.12.f) N-Ethyl-N-[4-methyl-2-(3-pyridyl)thiazol-5-yl]-3-methylthio-propanamide; M.29.12.g) N-Methyl-N-[4-methyl-2-(3-pyridyl)thiazol-5-yl]-3-methylthio-propanamide; M.29.12.h) N,2-Dimethyl-N-[4-methyl-2-(3-pyridyl)thiazol-5-yl]-3-methylthio-propanamide; M.29.12.i) N-Ethyl-2-methyl-N-[4-methyl-2-(3-pyridyl)thiazol-5-yl]-3-methylthio-propanamide; M.29.12.j) N-[4-Chloro-2-(3-pyridyl)thiazol-5-yl]-N-ethyl-2-methyl-3-methylthio-propanamide; M.29.12.k) N-[4-Chloro-2-(3-pyridyl)thiazol-5-yl]-N,2-dimethyl-3-methylthio-propanamide; M.29.12.l) N-[4-Chloro-2-(3-pyridyl)thiazol-5-yl]-N-methyl-3-methylthio-propanamide; M.29.12.m) N-[4-Chloro-2-(3-pyridyl)thiazol-5-yl]-N-ethyl-3-methylthio-propanamide;

or the compounds M.29.14a) 1-[(6-Chloro-3-pyridinyl)methyl]-1,2,3,5,6,7-hexahydro-5-methoxy-7-methyl-8-nitro-imidazo[1,2-a]pyridine; or M.29.14b) 1-[(6-Chloropyridin-3-yl)methyl]-7-methyl-8-nitro-1,2,3,5,6,7-hexahydroimidazo[1,2-a]pyridin-5-ol;

or the compounds M.29.16a) 1-isopropyl-N,5-dimethyl-N-pyridazin-4-yl-pyrazole-4-carboxamide; or M.29.16b) 1-(1,2-dimethylpropyl)-N-ethyl-5-methyl-N-pyridazin-4-yl-pyrazole-4-carboxamide; M.29.16c) N,5-dimethyl-N-pyridazin-4-yl-1-(2,2,2-trifluoro-1-methyl-ethyl)pyrazole-4-carboxamide; M.29.16d) 1-[1-(1-cyanocyclopropyl)ethyl]-N-ethyl-5-methyl-N-pyridazin-4-yl-pyrazole-4-carboxamide; M.29.16e) N-ethyl-1-(2-fluoro-1-methyl-propyl)-5-methyl-N-pyridazin-4-yl-pyrazole-4-carboxamide; M.29.16f) 1-(1,2-dimethylpropyl)-N,5-dimethyl-N-pyridazin-4-yl-pyrazole-4-carboxamide; M.29.16g) 1-[1-(1-cyanocyclopropyl)ethyl]-N,5-dimethyl-N-pyridazin-4-yl-pyrazole-4-carboxamide; M.29.16h) N-methyl-1-(2-fluoro-1-methyl-propyl]-5-methyl-N-pyridazin-4-yl-pyrazole-4-carboxamide; M.29.16i) 1-(4,4-difluorocyclohexyl)-N-ethyl-5-methyl-N-pyridazin-4-yl-pyrazole-4-carboxamide; or M.29.16j) 1-(4,4-difluorocyclohexyl)-N,5-dimethyl-N-pyridazin-4-yl-pyrazole-4-carboxamide;

N) Herbicides
herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, or ureas.

By applying compounds of formula I together with at least one active substance from groups A) to N) a synergistic plant health effect can be obtained, i.e. more than simple addition of the individual effects is obtained (synergistic mixtures).

This can be obtained by applying the compounds I and at least one further active substance simultaneously, either jointly (e. g. as tank-mix) or separately, or in succession, wherein the time interval between the individual applications is selected to ensure that the active substance applied first still occurs at the site of action in a sufficient amount at the time of application of the further active substance(s). The order of application is not essential for working of the present invention.

When applying compounds of formula I and a pesticide I sequentially, the time between both applications may vary e. g. between 2 hours to 7 days. Also a broader range is possible ranging from 0.25 hour to 30 days, preferably from 0.5 hour to 14 days, particularly from 1 hour to 7 days or from 1.5 hours to 5 days, even more preferred from 2 hours to 1 day. In case of a mixture comprising a pesticide II selected from group L), it is preferred that the pesticide I is applied as last treatment.

According to the invention, the solid material (dry matter) of the biopesticides (with the exception of oils such as Neem oil, Tagetes oil, etc.) are considered as active components (e. g. to be obtained after drying or evaporation of the extraction medium or the suspension medium in case of liquid formulations of the microbial pesticides).

In accordance with the present invention, the weight ratios and percentages used herein for a biological extract such as Quillay extract are based on the total weight of the dry content (solid material) of the respective extract(s).

The total weight ratios of compositions comprising at least one microbial pesticide in the form of viable microbial cells including dormant forms, can be determined using the amount of CFU of the respective microorganism to calculate the total weight of the respective active component with the following equation that 1×1010 CFU equals one gram of total weight of the respective active component. Colony forming unit is measure of viable microbial cells, in particular fungal and bacterial cells.

The active substances referred to above, their preparation and their activity e. g. against harmful fungi is known (cf.: http://www.alanwood.net/pesticides/); these substances are commercially available. The compounds described by IUPAC nomenclature, their preparation and their pesticidal activity are also known (cf. Can. J. Plant Sci. 48(6), 587-94, 1968; EP A 141 317; EP-A 152 031; EP-A 226 917; EP A 243 970; EP A 256 503; EP-A 428 941; EP-A 532 022; EP-A 1 028 125; EP-A 1 035 122; EP A 1 201 648; EP A 1 122 244, JP 2002316902; DE 19650197; DE 10021412; DE 102005009458; U.S. Pat. Nos. 3,296,272; 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624, WO 11/028657, WO2012/168188, WO 2007/006670, WO 2011/77514; WO13/047749, WO 10/069882, WO 13/047441, WO 03/16303, WO 09/90181, WO 13/007767, WO 13/010862, WO 13/127704, WO 13/024009, WO 13/024010 and WO 13/047441, WO 13/162072, WO 13/092224, WO 11/135833).

The commercially available compounds of the group M listed above may be found in The Pesticide Manual, 16th Edition, C. MacBean, British Crop Protection Council (2013) among other publications. The online Pesticide Manual is updated regularly and is accessible through http://bcpcdata.com/pesticide-manual.html. Another online data base for pesticides providing the ISO common names is http://www.alanwood.net/pesticides. The M.4 neonicotinoid cycloxaprid is known from WO2010/069266 and WO2011/069456, the neonicotinoid M.4A.2, sometimes also to be named as guadipyr, is known from WO2013/003977, and the neonicotinoid M.4A.3 (approved as paichongding in China) is known from WO2007/101369. The metaflumizone analogue M.22B.1 is described in CN10171577 and the analogue M.22B.2 in CN102126994. The phthalamides M.28.1 and M.28.2 are both known from WO2007/101540. The anthranilamide M.28.3 is de-scribed in WO2005/077934. The hydrazide compound M.28.4 is described in WO2007/043677. The anthranilamides M.28.5a) to M.28.5d) and M.28.5h) are described in WO 2007/006670, WO2013/024009 and WO2013/024010, the anthranilamide M.28.5i) is described in WO2011/085575, M.28.5j) in WO2008/134969, M.28.5k) in US2011/046186 and M.28.5l) in WO2012/034403. The diamide compounds M.28.6 and M.28.7 can be found in CN102613183. The spiroketal-substituted cyclic ketoenol derivative M.29.3 is known from WO2006/089633 and the biphenyl-substituted spirocyclic ketoenol derivative M.29.4 from WO2008/067911. The tri-azoylphenylsulfide M.29.5 is described in WO2006/043635, and biological control agents on the basis of Bacillus firmus are described in WO2009/124707. The compounds M.29.6a) to M.29.6i) listed under M.29.6 are described in WO2012/029672, and M.29.6j) and M.29.6k) in WO2013/129688. The nematicide M.29.8 is known from WO2013/055584. The isoxazoline M.29.9.a) is described in WO2013/050317. The isoxazoline M.29.9.b) is described in WO2014/126208. The pyridalyl-type analogue M.29.10 is known from WO2010/060379. The car-boxamides broflanilide and M.29.11.b) to M.29.11.h) are described in WO2010/018714, and the carboxamides M.29.11i) to M.29.11.p) in WO2010/127926. The pyridylthiazoles M.29.12.a) to M.29.12.c) are known from WO2010/006713, M.29.12.d) and M.29.12.e) are known from WO2012/000896, and M.29.12.f) to M.29.12.m) from WO2010/129497. The compounds M.29.14a) and M.29.14b) are known from WO2007/101369. The pyrazoles M.29.16.a) to M.29.16h) are described in WO2010/034737, WO2012/084670, and WO2012/143317, respectively, and the pyrazoles M.29.16i) and M.29.16j) are described in U.S. 61/891,437.

According to one embodiment of the inventive mixtures, the at least one pesticide II is selected from the groups L1) to L6):

L1) Microbial pesticides with fungicidal, bactericidal, viricidal and/or plant defense activator activi-ty: Aureobasidium pullulans DSM 14940 and DSM 14941 (L1.1), Bacillus amylolique-faciens AP-188 (L.1.2), B. amyloliquefaciens ssp. plantarum D747 (L.1.3), B. amylo-lique-faciens ssp. plantarum FZB24 (L.1.4), B. amyloliquefaciens ssp. plantarum FZB42 (L.1.5), B. amylolique-faciens ssp. plantarum MBI600 (L.1.6), B. amyloliquefaciens ssp. plantarum QST-713 (L.1.7), B. amyloliquefaciens ssp. plantarum TJ1000 (L.1.8), B. pumilus GB34 (L.1.9), B. pumilus GHA 180 (L.1.10), B. pumilus INR-7 (L.1.11), B. pumilus QST 2808 (L.1.13), B. simplex ABU 288 (L.1.14), B. subtilis FB17 (L.1.15), Coniothyrium minitans CON/M/91-08 (L.1.16), Metschnikowia fructicola NRRL Y 30752 (L.1.17), Penicillium bilaiae ATCC 22348 (L.1.19), P. bilaiae ATCC 20851 (L.1.20), Penicillium bilaiae ATCC 18309 (L.1.21), Streptomyces mi-croflavus NRRL B-50550 (L.1.22), T. harzianum T-22 (L.1.24);

L2) Biochemical pesticides with fungicidal, bactericidal, viricidal and/or plant defense activator activity: harpin protein (L.2.1), Reynoutria sachalinensis extract (L.2.2);

L3) Microbial pesticides with insecticidal, acaricidal, molluscidal and/or nematicidal activity: Bacil-lus firmus I 1582 (L.3.1); B. thuringiensis ssp. aizawai ABTS-1857 (L.3.2), B. t. ssp. kurstaki ABTS-351 (L.3.3), B. t. ssp. tenebrionis NB-176-1 (L.3.5), Beauveria bassiana GHA

(L.3.6), B. bassiana JW-1 (L.3.7), Burkholderia sp. A396 (L.3.9), Helicoverpa armigera nucleopolyhe-drovirus (HearNPV) (L.3.10), Helicoverpa zea nucleopolyhedrovirus (HzNPV) ABA-NPV-U (L.3.11), Helicoverpa zea single capsid nucleopolyhedrovirus (HzSNPV) (L.3.12), Heterohab-ditis bacteriophora (L.3.13), Isaria fumosorosea Apopka-97 (L.3.14), Metarhizium anisopliae var. anisopliae F52 (L.3.15), Paecilomyces lilacinus 251 (L.3.16), Pasteuria nishizawae Pn1 (L.3.17), Steinernema carpocapsae (L.3.18), S. feltiae (L.3.19);

L4) Biochemical pesticides with insecticidal, acaricidal, molluscidal, pheromone and/or nematicidal activity: cis-jasmone (L.4.1), methyl jasmonate (L.4.2), Quillay extract (L.4.3);

L5) Microbial pesticides with plant stress reducing, plant growth regulator, plant growth promoting and/or yield enhancing activity.

As outlined above, the present invention in particular relates to a mixture comprising

(i) a fertilizer, a composition comprising a fertilizer, or a granule comprising a fertilizer; and
(ii) the capsules, or the capsule suspension according to the invention.

The mixture is preferably an agrochemical mixture, which is suitable for agrochemical applications.

The term “fertilizers” is to be understood as chemical compounds applied to promote plant and fruit growth. Fertilizers are typically applied either through the soil (for uptake by plant roots), through soil substituents (also for uptake by plant roots), or by foliar feeding (for uptake through leaves). The term also includes mixtures of one or more different types of fertilizers as mentioned below.

The term “fertilizers” can be subdivided into several categories including: a) organic fertilizers (composed of decayed plant/animal matter), b) inorganic fertilizers (composed of chemicals and minerals) and c) urea-containing fertilizers.

Organic fertilizers include manure, e.g. liquid manure, semi-liquid manure, biogas manure, stable manure or straw manure, slurry, worm castings, peat, seaweed, compost, sewage, and guano. Green manure crops are also regularly grown to add nutrients (especially nitrogen) to the soil. Manufactured organic fertilizers include compost, blood meal, bone meal and seaweed extracts. Further examples are enzyme digested proteins, fish meal, and feather meal. The decomposing crop residue from prior years is another source of fertility. In addition, naturally occurring minerals such as mine rock phosphate, sulfate of potash and limestone are also considered inorganic fertilizers.

Inorganic fertilizers are usually manufactured through chemical processes (such as the Haber process), also using naturally occurring deposits, while chemically altering them (e.g. concentrated triple superphosphate). Naturally occurring inorganic fertilizers include Chilean sodium nitrate, mine rock phosphate, limestone, and raw potash fertilizers.

The inorganic fertilizer may, in a specific embodiment, be a NPK fertilizer. “NPK fertilizers” are inorganic fertilizers formulated in appropriate concentrations and combinations comprising the three main nutrients nitrogen (N), phosphorus (P) and potassium (K) as well as typically S, Mg, Ca, and trace elements.

Urea-containing fertilizer may, in specific embodiments, be urea, formaldehyde urea, anhydrous ammonium, urea ammonium nitrate (UAN) solution, urea sulfur, urea based NPK-fertilizers, or urea ammonium sulfate. Also envisaged is the use of urea as fertilizer. In case urea-containing fertilizers or urea are used or provided, it is particularly preferred that urease inhibitors as defined herein above may be added or additionally be present, or be used at the same time or in connection with the urea-containing fertilizers.

Fertilizers may be provided in any suitable form, e.g. as solid coated or uncoated granules, in liquid or semi-liquid form, as sprayable fertilizer, or via fertigation etc.

Coated fertilizers may be provided with a wide range of materials. Coatings may, for example, be applied to granular or prilled nitrogen (N) fertilizer or to multi-nutrient fertilizers. Typically, urea is used as base material for most coated fertilizers. Alternatively, ammonium or NPK fertilizers are used as base material for coated fertilizers. The present invention, however, also envisages the use of other base materials for coated fertilizers, any one of the fertilizer materials defined herein. In certain embodiments, elemental sulfur may be used as fertilizer coating. The coating may be performed by spraying molten S over urea granules, followed by an application of sealant wax to close fissures in the coating. In a further embodiment, the S layer may be covered with a layer of organic polymers, preferably a thin layer of organic polymers.

Further envisaged coated fertilizers may be provided by reacting resin-based polymers on the surface of the fertilizer granule. A further example of providing coated fertilizers includes the use of low permeability polyethylene polymers in combination with high permeability coatings.

In specific embodiments the composition and/or thickness of the fertilizer coating may be adjusted to control, for example, the nutrient release rate for specific applications. The duration of nutrient release from specific fertilizers may vary, e.g. from several weeks to many months.

The presence of nitrification inhibitors in a mixture with coated fertilizers may accordingly be adapted. It is, in particular, envisaged that the nutrient release involves or is accompanied by the release of a nitrification inhibitor according to the present invention.

Coated fertilizers may be provided as controlled release fertilizers (CRFs). In specific embodiments these controlled release fertilizers are fully coated urea or N—P—K fertilizers, which are homogeneous and which typically show a pre-defined longevity of release. In further embodiments, the CRFs may be provided as blended controlled release fertilizer products which may contain coated, uncoated and/or slow release components. In certain embodiments, these coated fertilizers may additionally comprise micronutrients. In specific embodiments these fertilizers may show a pre-defined longevity, e.g. in case of N—P—K fertilizers.

Additionally, envisaged examples of CRFs include patterned release fertilizers. These fertilizers typically show a pre-defined release patterns (e.g. hi/standard/lo) and a pre-defined longevity. In exemplary embodiments fully coated N—P—K, Mg and micronutrients may be delivered in a patterned release manner.

Also envisaged are double coating approaches or coated fertilizers based on a programmed release.

In further embodiments the fertilizer mixture may be provided as, or may comprise or contain a slow release fertilizer. The fertilizer may, for example, be released over any suitable period of time, e.g. over a period of 1 to 5 months, preferably up to 3 months. Typical examples of ingredients of slow release fertilizers are IBDU (isobutylidenediurea), e.g. containing about 31-32% nitrogen, of which 90% is water insoluble; or UF, i.e. an urea-formaldehyde product which contains about 38% nitrogen of which about 70% may be provided as water insoluble nitrogen; or CDU (crotonylidene diurea) containing about 32% nitrogen; or MU (methylene urea) containing about 38 to 40% nitrogen, of which 25-60% is typically cold water insoluble nitrogen; or MDU (methylene diurea) containing about 40% nitrogen, of which less than 25% is cold water insoluble nitrogen; or MO (methylol urea) containing about 30% nitrogen, which may typically be used in solu-tions; or DMTU (diimethylene triurea) containing about 40% nitrogen, of which less than 25% is cold water insoluble nitrogen; or TMTU (tri methylene tetraurea), which may be provided as component of UF products; or TMPU (tri methylene pentaurea), which may also be provided as component of UF products; or UT (urea triazone solution) which typically contains about 28% nitro-gen. The fertilizer mixture may also be long-term nitrogen-bearing fertilizer containing a mixture of acetylene diurea and at least one other organic nitrogen-bearing fertilizer selected from methylene urea, isobutylidene diurea, crotonylidene diurea, substituted triazones, triuret or mixtures thereof.

Any of the above mentioned fertilizers or fertilizer forms may suitably be combined. For instance, slow release fertilizers may be provided as coated fertilizers. They may also be combined with other fertilizers or fertilizer types. The same applies to the presence of a nitrification inhibitor ac-cording to the present invention, which may be adapted to the form and chemical nature of the fertilizer and accordingly be provided such that its release accompanies the release of the fertilizer, e.g. is released at the same time or with the same frequency. The present invention further envisages fertilizer or fertilizer forms as defined herein above in combination with the capsules, or the capsule suspension, or the mixture according to the invention and optionally further in combination with urease inhibitors as defined herein above. Such combinations may be provided as coated or uncoated forms and/or as slow or fast release forms. Preferred are combinations with slow release fertilizers including a coating. In further embodiments, also different release schemes are envisaged, e.g. a slower or a faster release.

The term “fertigation” as used herein refers to the application of fertilizers, optionally soil amendments, and optionally other water-soluble products together with water through an irrigation system to a plant or to the locus where a plant is growing or is intended to grow, or to a soil substituent as defined herein below. For example, liquid fertilizers or dissolved fertilizers may be provided via fertigation directly to a plant or a locus where a plant is growing or is intended to grow. Likewise, the capsules, or the capsule suspension, or the mixture according to the invention may be provided via fertigation to plants or to a locus where a plant is growing or is intended to grow. Fertilizers and the capsules, or the capsule suspension, or the mixture according to the invention may be provided together, e.g. dissolved in the same charge or load of material (typically water) to be irrigated. In further embodiments, fertilizers and the capsules, or the capsule suspension, or the mixture according to the invention may be provided at different points in time. For example, the fertilizer may be fertigated first, followed by the nitrification inhibitor, or preferably, the nitrification inhibitor may be fertigated first, followed by the fertilizer. The time intervals for these activities follow the herein above outlined time intervals for the application of fertilizers and the capsules, or the capsule suspension, or the mixture according to the invention. Also envisaged is a repeated fertigation of fertilizers and the capsules, or the capsule suspension, or the mixture according to the invention, either together or intermittently, e.g. every 2 hours, 6 hours, 12 hours, 24 hours, 2 days, 3 days, 4 days, 5 days, 6 days or more.

In particularly preferred embodiments, the fertilizer is an ammonium-containing fertilizer.

The agrochemical mixture according to the present invention may comprise one fertilizer as defined herein above and the capsules or capsule suspensions as defined herein above. The term mixture is to be understood as also covering a fertilizer or a composition or granule comprising a fertilizer, which is treated or coated with the capsules or capsule suspension according to the invention.

In further embodiments, the agrochemical mixture according to the present invention may comprise at least one or more than one fertilizer as defined herein above, e.g. 2, 3, 4, 5, 6, 6, 7, 8, 9, 10 or more different fertilizers (including inorganic, organic and urea-containing fertilizers).

In addition to the fertilizer and the capsules or capsule suspensions as defined herein above, the agrochemical mixture may comprise further ingredients, compounds, active compounds or compositions or the like. For example, the agrochemical mixture may additionally comprise or composed with or on the basis of a carrier, e.g. an agrochemical carrier, preferably as defined herein. In further embodiments, the agrochemical mixture may further comprise at least one pesticidal compound. For example, the agrochemical mixture may additionally comprise at least one herbicidal compound and/or at least one fungicidal compound and/or at least one insecticidal compound.

The term “plant” as used herein further includes all parts of a plant such as germinating seeds, emerging seedlings, plant propagules, herbaceous vegetation as well as established woody plants including all belowground portions (such as the roots) and aboveground portions.

Within the context of the method for reducing nitrification it is assumed that the plant is growing on soil. In specific embodiments, the plant may also grow differently, e.g. in synthetic laboratory environments or on soil substituents, or be supplemented with nutrients, water etc. by artificial or technical means. In such scenarios, the invention envisages a treatment of the zone or area where the nutrients, water etc. are provided to the plant. Also envisaged is that the plant grows in green houses or similar indoor facilities.

The term “locus” is to be understood as any type of environment, soil, soil substituent, area or material where the plant is growing or intended to grow. Preferably, the term relates to soil or soil substituent on which a plant is growing.

The term “plant propagation material” is to be understood to denote all the generative parts of the plant such as seeds and vegetative plant material such as cuttings and tubers (e.g. potatoes), which can be used for the multiplication of the plant. This includes seeds, grains, roots, fruits, tubers, bulbs, rhizomes, cuttings, spores, offshoots, shoots, sprouts and other parts of plants, including seedlings and young plants, which are to be transplanted after germination or after emergence from soil, meristem tissues, single and multiple plant cells and any other plant tissue from which a complete plant can be obtained.

The term “soil substituent” as used herein refers to a substrate which is able to allow the growth of a plant and does not comprise usual soil ingredients. This substrate is typically an anorganic substrate which may have the function of an inert medium. It may, in certain embodiments, also comprise organic elements or portions. Soil substituents may, for example, be used in hydroculture or hydroponic approaches, i.e. wherein plants are grown in soilless medium and/or aquatic based environments. Examples of suitable soil substituents, which may be used in the context of the present invention, are perlite, gravel, biochar, mineral wool, coconut husk, phyllosilicates, i.e. sheet silicate minerals, typically formed by parallel sheets of silicate tetrahedra with Si₂O₅ or a 2:5 ratio, or clay aggregates, in particular expanded clay aggregates with a diameter of about 10 to 40 mm. Particularly preferred is the employment of vermiculite, i.e. a phyllosilicate with 2 tetrahedral sheets for every one octahedral sheet present.

The use of soil substituents may, in specific embodiments, be combined with fertigation or irrigation as defined herein.

In specific embodiments, the treatment may be carried out during all suitable growth stages of a plant as defined herein. For example, the treatment may be carried out during the BBCH principle growth stages.

The term “BBCH principal growth stage” refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases. The BBCH-scale uses a decimal code system, which is divided into principal and secondary growth stages. The abbreviation BBCH derives from the Federal Biological Research Centre for Agriculture and Forestry (Germany), the Bundessortenamt (Germany) and the chemical industry.

In one embodiment the invention relates to a method for reducing nitrification comprising treating a plant growing on soil or soil substituents and/or the locus where the plant is growing or is intended to grow with the capsules, the capsule suspension, or the mixture as defined herein above at a growth stage (GS) between GS 00 and GS >BBCH 99 of the pant (e.g. when fertilizing in fall after harvesting apples) and preferably between GS 00 and GS 65 BBCH of the plant.

In one embodiment the invention relates to a method for reducing nitrification comprising treating a plant growing on soil or soil substituents and/or the locus where the plant is growing or is intended to grow with the capsules, the capsule suspension, or the mixture as defined herein above at a growth stage (GS) between GS 00 to GS 45, preferably between GS 00 and GS 40 BBCH of the plant.

In a preferred embodiment the invention relates to a method for reducing nitrification comprising treating a plant growing on soil or soil substituents and/or the locus where the plant is growing or is intended to grow with the capsules, the capsule suspension, or the mixture as defined herein above at an early growth stage (GS), in particular a GS 00 to GS 05, or GS 00 to GS 10, or GS 00 to GS 15, or GS 00 to GS 20, or GS 00 to GS 25 or GS 00 to GS 33 BBCH of the plant. In particularly preferred embodiments, the method for reducing nitrification comprises treating a plant growing on soil or soil substituents and/or the locus where the plant is growing or is intended to grow with at least one nitrification inhibitor as defined herein above during growth stages including GS 00.

In a further, specific embodiment of the invention, the capsules, the capsule suspension, or the mixture as defined herein above are applied to a plant growing on soil or soil substituents and/or the locus where the plant is growing or is intended to grow at a growth stage between GS 00 and GS 55 BBCH, or of the plant.

In a further embodiment of the invention, the capsules, the capsule suspension, or the mixture as defined herein above are applied to a plant growing on soil or soil substituents and/or the locus where the plant is growing or is intended to grow at the growth stage between GS 00 and GS 47 BBCH of the plant.

In one embodiment of the invention, the capsules, the capsule suspension, or the mixture as defined herein above are applied to a plant growing on soil or soil substituents and/or the locus where the plant is growing or is intended to grow before and at sowing, before emergence, and until harvest (GS 00 to GS 89 BBCH), or at a growth stage (GS) between GS 00 and GS 65 BBCH of the plant.

In a preferred embodiment the invention relates to a method for reducing nitrification comprising treating a plant growing on soil or soil substituents and/or the locus where the plant is growing with the capsules, the capsule suspension, or the mixture, wherein the plant and/or the locus where plant is growing or is intended to grow is additionally provided with at least one fertilizer. The fertilizer may be any suitable fertilizer, preferably a fertilizer as defined herein above. Also envisaged is the application of more than one fertilizer, e.g. 2, 3, 4, 5, 6, 7, 8, 9, 10 fertilizers, or of different fertilizer classes or categories.

In specific embodiments of the invention, the capsules, the capsule suspension, or the mixture and at least one fertilizer is applied to a plant growing on soil or soil substituents and/or the locus where the plant is growing or is intended to grow at a growth stage between GS 00 and GS 33 BBCH of the plant.

In specific embodiments of the invention, the capsules, the capsule suspension, or the mixture and at least one fertilizer is applied to a plant growing on soil or soil substituents and/or the locus where the plant is growing or is intended to grow at a growth stage between GS 00 and GS 55 BBCH of the plant.

In further specific embodiments of the invention, the capsules, the capsule suspension, or the mixture and at least one fertilizer is applied to a plant growing on soil or soil substituents and/or the locus where the plant is growing or is intended to grow at sowing, before emergence, or at a growth stage (GS) between GS 00 and GS >BBCH 99 of the pant (e.g. when fertilizing in fall after harvesting apples) and preferably between GS 00 and 65 BBCH of the plant.

According to a preferred embodiment of the present invention, the application of the capsules, the capsule suspension, or the mixture and of the fertilizer as defined herein above is carried out simultaneously or with a time lag.

The term “time lag” as used herein means that either the capsules, the capsule suspension, or the mixture are applied before the fertilizer to the plant growing on soil or soil substituents and/or the locus where the plant is growing or is intended to grow; or the fertilizer is applied before the capsules, the capsule suspension, or the mixture to the plant growing on soil or soil substituents and/or the locus where the plant is growing or is intended to grow. Such time lag may be any suitable period of time which still allows to provide a nitrification inhibiting effect in the context of fertilizer usage. For example, the time lag may be a time period of 1 day, 2 days, 3 days, 4 days, 5 days, 6 days, 7 days, 8 days, 9 days, 10 days, 11 days, 12 days, 13 days, 14 days, 3 weeks 4 weeks, 5 weeks, 6 weeks, 7 weeks, 8 weeks, 9 weeks, 10 weeks, 11 weeks, 12 weeks, 4 months, 5 months, 6 months, 7 months, 8 months, 9 months, 10 months or more or any time period in between the mentioned time periods. Preferably, the time lag is an interval of 1 day, 2 days, 3 days, 1 week, 2 weeks or 3 weeks. The time lag preferably refers to situations in which the nitrification inhibitor as defined above is provided 1 day, 2 days, 3 days, 4 days, 5 days, 6 days, 7 days, 8 days, 9 days, 10 days, 11 days, 12 days, 13 days, 14 days, 3 weeks 4 weeks, 5 weeks, 6 weeks, 7 weeks, 8 weeks, 9 weeks, 10 weeks, 11 weeks, 12 weeks, 4 months, 5 months, 6 months, 7 months, 8 months, 9 months, 10 months or more or any time period in between the mentioned time periods before the application of a fertilizer as defined herein above.

In another specific embodiment of the invention the capsules, the capsule suspension, or the mixture are applied between GS 00 to GS 33 BBCH of the plant, or between GS 00 and GS 65 BBCH of the plant, provided that the application of at least one fertilizer as defined herein above is carried out with a time lag of at least 1 day, e.g. a time lag of 1 day, 2 days, 3 days, 4 days, 5 days, 6 days, 7 days, 8 days, 9 days, 10 days, 11 days, 12 days, 13 days, 14 days, 3 weeks 4 weeks, 5 weeks, 6 weeks, 7 weeks, 8 weeks, 9 weeks, 10 weeks, or more or any time period in between the mentioned time periods. It is preferred that the capsules, the capsule suspension, or the mixture, which are applied between GS 00 to GS 33 BBCH of the plant, are provided 1 day, 2 days, 3 days, 4 days, 5 days, 6 days, 7 days, 8 days, 9 days, 10 days, 11 days, 12 days, 13 days, 14 days, 3 weeks 4 weeks, 5 weeks, 6 weeks, 7 weeks, 8 weeks, 9 weeks, 10 weeks, 11 weeks, or 12 weeks before the application of a fertilizer as defined herein above.

In another specific embodiment of the invention, at least one fertilizer as defined herein above is applied between GS 00 to GS 33 BBCH of the plant or between GS 00 and GS 65 BBCH of the plant, provided that the application of the capsules, the capsule suspension, or the mixture, is carried out with a time lag of at least 1 day, e.g. a time lag of 1 day, 2 days, 3 days, 4 days, 5 days, 6 days, 7 days, 8 days, 9 days, 10 days, 11 days, 12 days, 13 days, 14 days, 3 weeks 4 weeks, 5 weeks, 6 weeks, 7 weeks, 8 weeks, 9 weeks, 10 weeks or more or any time period in between the mentioned time periods.

According to a specific embodiment of the present invention a plant growing on soil or soil substituents and/or the locus where the plant is growing or is intended to grow is treated at least once with the capsules, the capsule suspension, or the mixture of the invention. In a further specific embodiment of the present invention a plant growing on soil or soil substituents and/or the locus where the plant is growing or is intended to grow is treated at least once with the capsules, the capsule suspension, or the mixture of the invention, and at least once with a fertilizer as defined herein above.

The term “at least once” means that the application may be performed one time, or several times, i.e. that a repetition of the treatment with a nitrification inhibitor and/or a fertilizer may be envisaged. Such a repetition may be a 2 times, 3 times, 4 times, 5 times, 6 times, 7 times, 8 times, 9 times, 10 times or more frequent repetition of the treatment with a nitrification inhibitor and/or a fertilizer. The repetition of treatment with the capsules, the capsule suspension, or the mixture of the invention and a fertilizer may further be different. For example, while the fertilizer may be applied only once, the capsules, the capsule suspension, or the mixture of the invention may be applied 2 times, 3 times, 4 times etc. Alternatively, while the capsules, the capsule suspension, or the mixture of the invention may be applied only once, the fertilizer may be applied 2 times, 3 times, 4 times etc. Further envisaged are all combination of numerical different numbers of repetitions for the application of the capsules, the capsule suspension, or the mixture of the invention and a fertilizer as defined herein above.

Such a repeated treatment may further be combined with a time lag between the treatment with the capsules, the capsule suspension, or the mixture of the invention and the fertilizer as described above.

The time interval between a first application and second or subsequent application of the capsules, the capsule suspension, or the mixture of the invention and/or a fertilizer may be any suitable interval. This interval may range from a few seconds up to 3 months, e.g. from a few seconds up to 1 month, or from a few seconds up to 2 weeks. In further embodiments, the time interval may range from a few seconds up to 3 days or from 1 second up to 24 hours.

In further specific embodiments, a method for reducing nitrification as described above is carried out by treating a plant growing on soil or soil substituents and/or the locus where the plant is growing or is intended to grow with at least one agrochemical mixture as defined herein above.

In another embodiment of the invention, an agrochemical mixture comprising an ammonium- or urea-containing fertilizer and the capsules or the capsule suspension as defined herein above is applied before and at sowing, before emergence, and until GS >BBCH 99 of the pant (e.g. when fertilizing in fall after harvesting apples In case the agrochemical mixture is provided as kit of parts or as non-physical mixture, it may be applied with a time lag between the application of the capsules or the capsule suspension and the fertilizer or between the application of the capsules or the capsule suspension and a secondary or further ingredient, e.g. a pesticidal compound as mentioned herein above.

In a further embodiment plant propagules are preferably treated simultaneously (together or separately) or subsequently.

The term “propagules” or “plant propagules” is to be understood to denote any structure with the capacity to give rise to a new plant, e.g. a seed, a spore, or a part of the vegetative body capable of independent growth if detached from the parent. In a preferred embodiment, the term “propagules” or “plant propagules” denotes for seed.

For a method as described above, or for a use according to the invention, in particular for seed treatment and in furrow application, the application rates of the capsules, the capsule suspension, or the mixture of the invention are between 0,01 g and 5 kg of active ingredient per hectare, preferably between 1 g and 1 kg of active ingredient per hectare, especially preferred between 50 g and 300 g of active ingredient per hectare depending on different parameters such as the specific active ingredient applied and the plant species treated. In the treatment of seed, amounts of from 0.001 g to 20 g per kg of seed, preferably from 0.01 g to 10 g per kg of seed, more preferably from 0.05 to 2 g per kg of seed of nitrification inhibitors may be generally required.

As a matter of course, if the capsules, the capsule suspension, or the mixture of the invention are employed, the active ingredient may be used in an effective and non-phytotoxic amount. This means that the compounds of formula I are provided in a quantity which allows to obtain the desired effect but which does not give rise to any phytotoxic symptoms on the treated plant or on the plant raised from the treated propagule or treated soil or soil substituents. For the use according to the invention, the application rates of fertilizers may be selected such that the amount of applied N is between 10 kg and 1000 kg per hectare, preferably between 50 kg and 700 kg per hectare.

Methods for applying the capsules, the capsule suspension, or the mixture of the invention on to plant propagation material, especially seeds, the plant and/or the locus where the plant is growing or intended to grow are known in the art, and include dressing, coating, pelleting, dusting, soaking and in-furrow application methods of the propagation material. In a preferred embodiment, the capsules, the capsule suspension, or the mixture of the invention are applied on to the plant propagation material by a method such that germination is not induced, e.g. by seed dressing, pelleting, coating and dusting.

In a further aspect the invention relates to a method for treating a fertilizer or a composition or granule comprising a fertilizer in order to obtain the mixture of the invention. This treatment includes the application of the capsules or the capsule suspension according to the invention to a fertilizer or a composition or granule comprising a fertilizer. The treatment may accordingly result in the presence of the capsules or the capsule suspension in a preparation of fertilizers or other compositions. Such treatment may, for example, result in a homogenous distribution of the capsules or the capsule suspension on or in fertilizer preparations. Treatment processes are known to the skilled person and may include, for instance, dressing, coating, pelleting, dusting or soaking. In a specific embodiment, the treatment may be a coating of the capsules or the capsule suspension with fertilizer preparations, or a coating of fertilizers with the capsules or the capsule suspension. The treatment may be based on the use of granulation methods as known to the skilled person, e.g. fluidized bed granulation.

In a further specific embodiment, the present invention relates to a method for treating seed or plant propagation material. The term “seed treatment” as used herein refers to or involves steps towards the control of biotic stresses on or in seed and the improvement of shooting and development of plants from seeds. For seed treatment it is evident that a plant suffering from biotic stresses such as fungal or insecticidal attack or which has difficulties obtaining sufficient suitable nitrogen-sources shows reduced germination and emergence leading to poorer plant or crop establishment and vigor, and consequently, to a reduced yield as compared to a plant propagation material which has been subjected to curative or preventive treatment against the relevant pest and which can grow without the damage caused by the biotic stress factor. Methods for treating seed or plant propagation material according to the invention thus lead, among other advantages, to an enhanced plant health, a better protection against biotic stresses and an increased plant yield.

Seed treatment methods for applying the capsules or the capsule suspension or the mixture of the invention and secondary effectors such as pesticides, in particular fungicides, insecticides, and/or nematicides and/or biostimulants, to plant propagation material, especially seeds, are known in the art, and include dressing, coating, filmcoating, pelleting and soaking application methods of the propagation material. Such methods are also applicable to the combinations or compositions according to the invention.

In further embodiments, the treatment of seeds is performed with the capsules or the capsule suspension or the mixture according to the present invention, and a fungicide or insecticide, or a fungicide and an insecticide, or a fungicide and a nematicide, or a fungicide and a biopesticide and/or biostimulant, or an insecticide and a nematicide, or an insecticide and a biopesticide and/or biostimulant, or a nematicide and a biopesticide and/or biostimulant, or a combination of a fungicide, insecticide and nematicide, or a combination of a fungicide, insecticide and biopesticide and/or biostimulant, or a combination of an insecticide, nematicide, and biopesticide etc.

In a preferred embodiment, the capsules or the capsule suspension or the mixture according to the present invention are applied on to the plant propagation material by a method such that the germination is not negatively impacted. Accordingly, examples of suitable methods for applying (or treating) a plant propagation material, such as a seed, include seed dressing, seed coating or seed pelleting and alike. It is preferred that the plant propagation material is a seed, seed piece (i.e. stalk) or seed bulb.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications). The seed may also be primed either before or after the treatment.

Even distribution of the capsules or the capsule suspension or the mixture according to the present invention and adherence thereof to the seeds is desired during propagation material treatment. Treatment could vary from a thin film (dressing) of the formulation containing the combination, for example, a mixture of active ingredient(s), on a plant propagation material, such as a seed, where the original size and/or shape are recognizable to an intermediary state (such as a coating) and then to a thicker film (such as pelleting with many layers of different materials (such as carriers, for example, clays; different formulations, such as of other active ingredients; polymers; and colorants) where the original shape and/or size of the seed is no longer recognizable.

An aspect of the present invention includes application of the capsules or the capsule suspension or the mixture according to the present invention onto the plant propagation material in a targeted fashion, including positioning the ingredients in the combination onto the entire plant propagation material or on only parts thereof, including on only a single side or a portion of a single side. One of ordinary skill in the art would understand these application methods from the description provided in EP954213B1 and WO06/112700.

Application of the capsules or the capsule suspension or the mixture according to the present invention onto plant propagation material also includes protecting the plant propagation material treated with the combination of the present invention by placing one or more pesticide- and nitrification inhibitor (NI)-containing particles next to a pesticide- and NI-treated seed, wherein the amount of pesticide is such that the pesticide-treated seed and the pesticide-containing particles together contain an effective dose of the pesticide and the pesticide dose contained in the pesticide-treated seed is less than or equal to the maximal non-phytotoxic dose of the pesticide. Such techniques are known in the art, particularly in WO2005/120226.

Application of the combinations onto the seed also includes controlled release coatings on the seeds, wherein the ingredients of the combinations are incorporated into materials that release the ingredients over time. Examples of controlled release seed treatment technologies are generally known in the art and include polymer films, waxes, or other seed coatings, wherein the ingredients may be incorporated into the controlled release material or applied between layers of materials, or both.

The seed treatment occurs to an unsown seed, and the term “unsown seed” is meant to include seed at any period between the harvest of the seed and the sowing of the seed in the ground for the purpose of germination and growth of the plant.

Treatment to an unsown seed is not meant to include those practices in which the active ingredient is applied to the soil or soil substituents but would include any application practice that would target the seed during the planting process.

Preferably, the treatment occurs before sowing of the seed so that the sown seed has been pre-treated with the capsules or the capsule suspension or the mixture according to the present invention. In particular, seed coating or seed pelleting are preferred in the treatment of the combinations according to the invention. As a result of the treatment, the ingredients in each combination are adhered on to the seed and therefore available for pest control.

The treated seeds can be stored, handled, sowed and tilled in the same manner as any other active ingredient treated seed.

Application can be carried out before or during sowing. Methods for applying or treating the capsules or the capsule suspension or the mixture according to the present invention on to plant propagation material, especially seeds include dressing, coating, pelleting, dusting, soaking and in-furrow application methods of the propagation material. Preferably, the capsules or the capsule suspension or the mixture according to the present invention are applied on to the plant propagation material by a method such that germination is not induced, e.g. by seed dressing, pelleting, coating and dusting.

Typically, a pre-mix formulation for seed treatment application comprises 0.5 to 99.9 percent, especially 1 to 95 percent, of the desired ingredients, and 99.5 to 0.1 percent, especially 99 to 5 percent, of a solid or liquid adjuvant (including, for example, a solvent such as water), where the auxiliaries can be a surfactant in an amount of 0 to 50 percent, especially 0.5 to 40 percent, based on the pre-mix formulation. Whereas commercial products will preferably be formulated as concentrates (e.g., pre-mix composition (formulation), the end user will normally employ dilute formulations (e.g. tank mix composition).

When employed in plant protection, the total amounts of active components applied are, depending on the kind of effect desired, from 0.001 to 10 kg per ha, preferably from 0.005 to 2 kg per ha, more preferably from 0.05 to 0.9 kg per ha, in particular from 0.1 to 0.75 kg per ha. The application rates may range from about 1×106 to 5×1015 (or more) CFU/ha. Preferably, the spore concentration is about 1×107 to about 1×1011 CFU/ha. In the case of (entomopathogenic) nematodes as microbial pesticides (e.g. Steinernema feltiae), the application rates preferably range inform about 1×105 to 1×1012 (or more), more preferably from 1×108 to 1×1011, even more preferably from 5×108 to 1×1010 individuals (e.g. in the form of eggs, juvenile or any other live stages, preferably in an infetive juvenile stage) per ha.

When employed in plant protection by seed treatment, the amount of the capsules or the capsule suspension or the mixture according to the present invention (based on total weight of active components) is in the range from 0.01-10 kg, preferably from 0.1-1000 g, more preferably from 1-100 g per 100 kilogram of plant propagation material (preferably seeds). The application rates with respect to plant propagation material preferably may range from about 1×106 to 1×1012 (or more) CFU/seed. Preferably, the concentration is about 1×106 to about 1×1011 CFU/seed. Alternatively, the application rates with respect to plant propagation material may range from about 1×107 to 1×1014 (or more) CFU per 100 kg of seed, preferably from 1×109 to about 1×1011 CFU per 100 kg of seed.

### EXAMPLES

The following abbreviations and terms that are used herein:

LIST OF ABBREVIATIONS AND TERMS

| | |
|---|---|
| PVA | polyvinyl alcohol - |
| | 4 wt % solution of Polyvinyl alcohol having a |
| | viscosity of 18 mPas according to DIN 53015 |
| | and a degree of hydrolysis of 88% |
| MDI | 4,4′-diphenylmethane diisocyanate |
| MDI-based | solvent free polyisocyanate based on 4,4′- |
| Polyisocyanate | diphenylmethane diisocyanate (MDI) with an |
| | average functionality of 2,7, NCO content 32 g/ |
| | 100 g) |
| MHPC | methylhydroxypropyl cellulose |
| Soprophor 4D384 | polyarylphenyl ether sulfate |
| EO | ethylene oxide |
| PO | propylene oxide |
| DETA | diethylene triamine |
| TEPA | triethylene pentaamine |
| HNO₃ | nitric acid |
| K₂SO₄ | potassium sulfate |
| GC | gas Chromatograph |
| ECD | electron Capture Detector |
| μm | Micrometer |
| g | Gram |
| wt % | weight % |
| min | Minute |
| h | Hour |
| RT | room temperature (20 to 25° C.) |

### Example 1

Polyurea capsule suspension 1 stabilized by polyvinyl alcohol as a protective colloid was prepared according to the procedure described hereinbelow:

| | Ingredient | Amount (in g) |
|---|---|---|
| Initial charge | Deionised water | 187.50 |
| | PVA | 45.00 |
| Feed 1 | Compound-10 | 142.5 |
| | MDI-based Polyisocyanate | 72.5 |
| Feed 2 | TEPA (25 wt %) | 17.16 |

A water phase comprising water and the protective colloid PVA (10 wt %) was introduced as the initial charge at RT. Under stirring conditions, Feed 1 comprising the polyisocyanate and the compound A-10 of Table 1 were added and the mixture dispersed in the aqueous phase for 3 min at 15,000 rpm. Tetraethyl pentaamine solution (25 wt %) was added under stirring for 15 min. The mixture was further heated to 80° C. for 1 h, and maintained at the same temperature for 1 h and further cooled to RT. The dispersion obtained had a solid content of 28.5 wt % and average particle size (D0.5) of 6.66 μm.

### Example 2

Polyurea capsule suspension 2 stabilized by polyvinyl alcohol as a protective colloid was prepared in an analogous manner according to the procedure described in Example 1 and by involving the ingredients provided hereinbelow, excepting that the water phase was introduced at 20° C. or less.

| | Ingredient | Amount (in g) |
|---|---|---|
| Initial charge | Deionised water | 208 |
| | PVA | 30 |
| Feed 1 | Compound A-10 | 85 |
| | MDI-based Polyisocyanate | 15 |
| Feed 2 | TEPA (25 wt %) | 34.32 |

The dispersion obtained had a solid content of 23.1 wt % and average particle size (D0.5) of 8.66 μm.

### Example 3

Polyurea capsule suspension 3 stabilized by polyvinyl alcohol as a protective colloid was prepared in an analogous manner according to the procedure described in Example 1 and by involving the ingredients provided hereinbelow, excepting that the water phase was introduced at 20° C.

| | Ingredient | Amount (in g) |
|---|---|---|
| Initial charge | Deionised water | 211 |
| | PVA | 30 |
| Feed 1 | Compound A-10 | 95 |
| | MDI-based Polyisocyanate | 5 |
| Feed 2 | TEPA (25 wt %) | 11.46 |

The dispersion obtained had a solid content of 29.6 wt % and average particle size (D0.5) of 8.47 μm.

### Example 4

Polyurea capsule suspension 4 stabilized by polyvinyl alcohol as a protective colloid was prepared in an analogous manner to the procedure described in Example 1 and by involving the ingredients provided hereinbelow, excepting that the water phase was introduced at 20° C.

| | Ingredient | Amount (in g) |
|---|---|---|
| Initial charge | Deionised water | 196.05 |
| | PVA | 30.00 |
| Feed 1 | Compound A-10 | 142.50 |
| | MDI-based Polyisocyanate | 7.50 |
| Feed 2 | TEPA (25 wt %) | 17.16 |

The dispersion obtained had a solid content of 33.7 wt % and average particle size (D0.5) of 7.56 μm.

### Example 5

Polyurea capsule suspension 5 stabilized with pickering particles was prepared according to the procedure described hereinbelow:

| | Ingredient | Amount (in g) |
|---|---|---|
| Initial charge | Deionised water | 200 |
| | Silica sol (50 wt %) having | 24 |
| | specific surface area of 80 m²/g | |
| | MHPC solution (5 wt %) | 1.12 |
| | having an average molecular | |
| | weight of 26,000 g/mol | |
| | Nitric acid solution (20 wt %) | 1.20 |
| Feed 1 | Compound A-10 | 76 |
| | MDI-based Polyisocyanate | 4 |
| Feed 2 | TEPA (25 wt %) | 9.15 |

A water phase comprising water and the pickering system comprising silica sol, MHPC and HNO₃ was introduced as the initial charge below 20° C. Under stirring, the compound A-10 of Table 1 were added and the mixture dispersed in the aqueous phase at 21,000 rpm for 3 min. TEPA solution was added under stirring for 15 min. The mixture was further heated to 80° C. for 1 h, and maintained at the same temperature for 1 h and further cooled to RT. The dispersion obtained had a solid content of 20.3 wt % and average particle size (D0.5) of 4.78 μm.

### Example 6

Polyurea capsule suspension 6 stabilized with pickering particles was prepared in an analogous manner to the procedure described in Example 5 and by using the ingredients provided hereinbelow:

| | Ingredient | Amount (in g) |
|---|---|---|
| Initial charge | Deionised water | 200 |
| | Silica sol (50 wt %) | 24 |
| | MHPC solution (5 wt %) | 1.12 |
| | HNO₃ solution (20 wt %) | 1.20 |
| Feed 1 | Compound A-10 | 68.00 |
| | MDI-based Polyisocyanate | 12.00 |
| Feed 2 | TEPA (25 wt %) | 27.46 |

The dispersion obtained had a solid content of 30.7 wt % and average particle size (D0.5) of 4.97 μm.

### Example 7

Acrylate capsule suspension 7 stabilized with pickering particles was prepared in an analogous manner to the procedure described in Example 5 and by using the ingredients provided herein below:

| | Ingredient | Amount (in g) |
|---|---|---|
| Initial charge | Deionised water | 175 |
| | Silica sol (50 wt %) | 36 |
| | MHPC solution (5 wt %) | 1.68 |
| | Sodium nitrite solution in | 0.48 |
| | water (2.5 wt %) | |
| | Nitric acid solution (20 wt % | 1.80 |
| | in water) | |
| Feed 1 | Compound A-10 | 96.00 |
| | methyl methacrylate | 14.40 |
| | Pentaerythritol triacrylate | 9.60 |
| Feed 2 | Tert-butyl perpivalate (as a | 0.32 |
| | 75% solution in aliphatic | |
| | hydrocarbons) | |
| Feed 3 | TEPA (25 wt %) | 27.46 |

The water phase was added at 20° C. When Feed 2 was introduced, the heating program employed was: heating the reaction mixture to 65° C. in 60 min; heating to 90° C. in 60 min and maintaining the reaction mixture at 90° C. for 90 min at 90° C. TEPA was added to the reaction mixture when the reaction mixture was maintained at 90° C.

The dispersion obtained had a solid content of 22.5 wt % and average particle size (D0.5) of 2.67 μm.

### Example 8

Acrylate capsule suspension 8 stabilized with the protective colloid
PVA was prepared in an analogous manner to the procedure described
in Example 1 and by using the ingredients provided herein below:

| | Ingredient | Amount (in g) |
|---|---|---|
| Initial charge | Deionised water | 204 |
| | PVA | 36 |
| Feed 1 | Compound A-10 | 80 |
| | methyl methacrylate | 12 |
| | Pentaerythritol triacrylate | 8 |
| Feed 2 | Tert-butyl perpivalate (75% | 0.27 |
| | solution in aliphatic | |
| | hydrocarbons) | |
| Feed 3 | TEPA (25 wt %) | 27.46 |

The dispersion obtained had a solid content of 11.5 wt % and average particle size (D0.5) of 25.4 μm.

### Example 9

Melamine formaldehyde capsule suspension 9 was prepared in accordance with the procedure described hereinbelow:

| | Ingredient | Amount (in g) |
|---|---|---|
| Initial charge | Deionised water | 222 |
| | Poly(2-acrylamido-2- | 17.6 |
| | methylpropane sulfonic acid) | |
| | sodium salt having pH 2.5 to 4 | |
| | Aqueous polymeric solution | 19.7 |
| | comprising 1,3,5-triazin-2,4,6- | |
| | triamine (70% strength by | |
| | weight) reacted with | |
| | formaldehye having viscosity | |
| | of 200 to 350 mPa according | |
| | to DIN EN ISO 3219 at 20° C.) | |
| Feed 1 | Compound A-10 | 68 |
| Feed 2 | Aqueous solution of formic | 2 |
| | acid (25% strength by weight) | |

A water phase comprising water, sodium salt of Poly(2-acrylamido-2-methylpropane sulfonic acid and aqueous polymeric solution comprising 1,3,5-triazin-2,4,6-triamine (70% strength by weight) reacted with formaldehye was introduced below 20° C. Compound A-10 of Table 1 was added and the mixture dispersed in the aqueous phase for 3 min at 21,000 rpm. Feed 2 comprising aqueous solution of formic acid was added to stabilize the pH value to 4. Stirring was continued for 2 min. The mixture was further heated to 80° C. for 1 h, and maintained at the same temperature for 1 h and further cooled to RT. The dispersion obtained had a solid content of 21.8 wt % and average particle size (D0.5) of 77.98 μm.

### Example 10

Melamine formaldehyde capsule suspension 9 was prepared in an analogous manner accordance with the procedure described in Example 9 and by employing the ingredients as herein below:

| | Ingredient | Amount (in g) |
|---|---|---|
| Initial charge | Deionised water | 222 |
| | Poly(2-acrylamido-2- | 17.6 |
| | methylpropane sulfonic acid) | |
| | sodium salt having pH 2.5 to 4 | |
| | Aqueous polymeric solution | 19.7 |
| | comprising 1,3,5-triazin- | |
| | 2,4,6-triamine (70% strength | |
| | by weight) reacted with | |
| | formaldehye having viscosity | |
| | of 200 to 350 mPa according | |
| | to DIN EN ISO 3219 at | |
| | 20° C.) | |
| Feed 1 | Compound A-10 | 86.65 |
| Feed 2 | Aqueous solution of formic | 2 |
| | acid (25% strength by | |
| | weight) | |

The dispersion obtained had a solid content of 27.2 wt % and average particle size (D0.5) of 29.82 μm.

### Example 11

Polyurea capsule suspension stabilized with lignosulfate was prepared in accordance with the procedure described hereinbelow:

| | Ingredient | Amount (in g) |
|---|---|---|
| Initial charge | Deionised water | 339.69 |
| | Sodium lignosulfonate | 6 |
| Feed 1 | Compound A-10 | 189.99 |
| | MDI-based Polyisocyanate | 24 |
| | Butanol derived EO/PO | 7.2 |
| | block copolymer | |
| Feed 2 | DETA | 9.12 |
| Feed 3 | Glycerine | 30 |
| Feed 4 | Xanthan gum | 30 |

A water phase comprising water and sodium lignosulfate was introduced. Under stirring, the mixture comprising compound A-10 of Table 1, MDI based polyisocyanate and butanol derived EO/PO block copolymer was added and the mixture dispersed at 5000 rpm for 3 min. DETA was further added and mixture stirred for 25 min. The mixture was further stirred for 1h at 25° C., cooled to RT further to which glycerine and the thickener xanthan gum were added.

The dispersion contained an active ingredient of 305 g/l and an average particle size (D0.5) of 3.3 μm.

### Example 12

Polyurea capsule suspension stabilized with sodium lignosulfate was prepared in an analogous manner according to the procedure described in Example 11 and by employing the ingredients as provided hereinbelow:

| | Ingredient | Amount (in g) |
|---|---|---|
| Initial charge | Deionised water | 105.75 |
| | Sodium lignosulfonate | 2.17 |
| Feed 1 | Compound A-10 | 60 |
| | MDI-based Polyisocyanate | 16 |
| | Butanol derived EO/PO | 2.4 |
| | block copolymer | |
| Feed 2 | DETA | 6.08 |
| Feed 3 | Glycerine | 20 |

The suspension contained an active ingredient of 305 g/l and an average particle size (D0.5) of 2.5 μm.

### Example 13

Non-encapsulated emulsion containing the active compound A-10 (of Table 1) was prepared in accordance with the procedure as described hereinbelow:

| | Ingredient | Amount (in g) |
|---|---|---|
| Initial charge | Deionised water | 497 |
| | Soprophor 4D384 | 75 |
| | Glycerine | 100 |
| Feed 1 | Xanthan gum | 2 |
| Feed 2 | Compound A-10 | 300 |

A water phase comprising water and Soprophor 4D384 was introduced at 20° C. Under stirring, thickener Xanthan gum and the compound A-10 were added and the mixture was dispersed at 5000 rpm for 3 min. The emulsion obtained had an active ingredient content of 300 g/I by weight and an average particle size (D0.5) of 1.2 μm.

### Example 14

Soil (100 g) was filled into plastic bottles (500 ml) (e.g. soil sampled from the field) and moistened to 50% water holding capacity. The soil was incubated at 20° C. for one week to activate the microbial biomass. The test solution (1 ml) containing the capsule suspensions 1 to 12 containing the active test compound A-10 in the appropriate concentration (usually 0,3 or 1% of nitrogen N), or DMSO and nitrogen (10 mg) in the form of ammoniumsulfate-N were added to the soil and mixed well. Bottles were capped but loosely to allow air exchange. The bottles were then incubated at 20° C. for 0,14 or 28 days. The same procedure was carried out with the non-encapsulated emulsion comprising the test compound A-10.

K₂SO₄ solution (1%) (300 ml) was added to the bottle containing the soil and shaken for 2 h in a horizontal shaker at 150 rpm. The whole solution was filtered (Macherey-Nagel Filter MN 807%) and the ammonium and nitrate content were analyzed in the filtrate in an autoanalyzer at 550 nm (Merck, AA11).

The inhibition (in %) is calculated by the equation [(a−b)/(a−c)]×100; wherein a is the amount of Nitrate-Nitrogen without the test capsule suspensions without the active test compound A-10 at the end of incubation; b is the amount of Nitrate-Nitrogen with the test capsule suspensions containing the active test compound A-10 at the end of incubation; c is the amount of Nitrate-Nitrogen at the beginning. The best inhibition values obtained for the test compounds are provided herein below in Table 2:

| Capsule suspensions | | |
|---|---|---|
| prepared according to | Inhibition | Inhibition (%) |
| Examples 1 to 12 | (%) (14 days) | (28 days) |
| 1 | 44 | 6 |
| 2 | 32 | 15 |
| 3 | 42 | 20 |
| 4 | 39 | ND |
| 5 | 47 | 11 |
| 6 | 44 | ND |
| 7 | 45 | 11 |
| 8 | 32 | 0 |
| 9 | 28 | 16 |
| 10 | 35 | 21 |
| 11 | 30 | 11 |
| 12 | 29 | 19 |
| Non-encapsulated | Inhibition (%) | Inhibition (%) |
| emulsion | (14 days) | (28 days) |
| 13 | 22 | 9 |

ND—Not determined

The encapsulated capsule suspensions exhibited improved nitrification inhibiting activity as compared to the non-encapsulated emulsion comprising the test compound. The nitrification inhibiting activity was further sustained for an extended period of time.

### Example 15

Green head lettuce was seeded in seedling boxes. Once the 4 leaf stage was reached one plant was potted into a 8 cm pot in standard greenhouse soil (mixture of peat, loam and sand) and grown in the greenhouse at 20° C. and 60% humidity. One week after planting the plants, the pots were separated out and each pot set onto a plant saucer designed with an inner compartment for the pot and an outer ring that is filled with water. At time 0, water with or without various concentrations of fertilizer and with either empty formulation or formulated capsule suspensions was applied to the plant such that the water holding capacity of the soil was around 50%. Then a gas sampling chamber was placed over the plant saucer such that the rim fit into the ring filled with water to create a gas-tight chamber and 20 cc air from the chamber were drawn into a syringe and immediately emptied in to a Vacutainer (Labco, 12 ml volume). This equals the Time Zero measurement for each pot. The same procedure was performed with all pots in the experiment. After incubation time of 1 h, again 20 cc air samples were taken from the gas chambers and emptied into Vacutainers as described above. Plants were then returned to their positions in the greenhouse. The procedure was repeated at precisely the same time of day for the following days until the N₂O emissions were back to background level.

Samples were analyzed in a Shimadzu 2014 GC equipped with an ECD system. Total cumulated N₂O emissions were calculated and related by calculating the % inhibition compared to control.

| | Inhibition (%) N₂O |
|---|---|
| | emissions |
| Capsule suspension prepared | |
| according to Examples 4 or 6 | |
| 4 | 31.44 |
| 6 | 56.93 |
| active test compound A-10 | |
| (unformulated) | |
| A-10 | 25 |

The encapsulated capsule suspensions are more efficacious than the active test compound (unformulated) in reducing N₂O emissions and have enhanced potency as a nitrification inhibitor.

1. Capsules comprising:
(1) a core (a) and a shell (b), wherein the core (a) is encapsulated by the shell (b); or
(2) a matrix (c);
wherein, if the capsules comprise a core (a) and a shell (b) according to option (1),
the core (a) comprises compounds of formula I 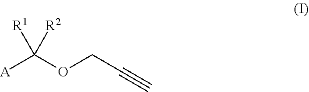
or a stereoisomer, salt, tautomer, or N-oxide thereof
wherein
R¹ and R² are independently of each other selected from the group consisting of H, C₁-C₆-alkyl, C₂-C₆-alkenyl, C₂-C₆-alkynyl, C₁-C₆-haloalkyl, C₁-C₄-alkoxy-C₁-C₄-alkyl C₁-C₆-alkoxy, C₂-C₆-alkenyloxy, C₂-C₆-alkynyloxy, wherein the C-atoms may in each case be unsubstituted or may carry 1, 2 or 3 identical or different substituents R^{e};
C₃-C₈-cycloalkyl, C₃-C₈-cycloalkenyl, heterocyclyl, aryl, hetaryl, C₃-C₈-cycloalkyl-C₁-C₆-alkyl, C₃-C₈-cycloalkenyl-C₁-C₆-alkyl, heterocyclyl-C₁-C₆-alkyl, aryl-C₁-C₆-alkyl, and hetaryl-C₁-C₆-alkyl, phenoxy and benzyloxy, wherein the cyclic moieties may in each case be unsubstituted or may carry 1, 2, 3, 4, or 5 identical or different substituents R^{a};
A is phenyl, wherein said phenyl ring may be unsubstituted or may carry 1, 2, 3, 4, or 5 identical or different substituents R^{A};
wherein
R^{A} is selected from the group consisting of CN, halogen, NO₂, OR^{b}, NR^{c}R^{d}, C(Y)R^{b}, C(Y)OR^{b}, C(Y)NR^{c}R^{d}, S(Y)ₘR^{b}, S(Y)ₘOR^{b},
C₁-C₆-alkyl, C₂-C₆-alkenyl, C₂-C₆-alkynyl, C₁-C₆-haloalkyl, C₁-C₆-alkoxy, C₁-C₆-alkylthio, wherein the C-atoms may in each case be unsubstituted or may carry 1, 2 or 3 identical or different substituents R^{e};
C₃-C₈-cycloalkyl, C₃-C₈-cycloalkenyl, heterocyclyl, aryl, hetaryl, C₃-C₈-cycloalkyl-C₁-C₆-alkyl, C₃-C₈-cycloalkenyl-C₁-C₆-alkyl, heterocyclyl-C₁-C₆-alkyl, aryl-C₁-C₆-alkyl, and hetaryl-C₁-C₆-alkyl, phenoxy and benzyloxy, wherein the cyclic moieties may be unsubstituted or may carry 1, 2, 3, 4, or 5 identical or different substituents R^{a};
and wherein
R^{a} is selected from CN, halogen, NO₂, C₁-C₄-alkyl, C₁-C₄-haloalkyl and C₁-C₄-alkoxy;
or two substituents R^{a} on adjacent C-atoms may be a bridge selected from CH₂CH₂CH₂CH₂, OCH₂CH₂CH₂, CH₂OCH₂CH₂, OCH₂CH₂O, OCH₂OCH₂, CH₂CH₂CH₂, CH₂CH₂O, CH₂OCH₂, O(CH₂)O, SCH₂CH₂CH₂, CH₂SCH₂CH₂, SCH₂CH₂S, SCH₂SCH₂, CH₂CH₂S, CH₂SCH₂, S(CH₂)S, and form together with the C atoms, to which the two R^{a} are bonded to, a 5-membered or 6-membered saturated carbocyclic or heterocyclic ring;
R^{b} is selected from H, C1-C6-alkyl, C2-C₄-alkenyl, C2-C₄-alkynyl, C1-C₄-haloalkyl, phenyl and benzyl;
R^{c} and R^{d} are independently of each other selected from the group consisting of H, C₁-C₄-alkyl, and C₁-C₄-haloalkyl; or
R^{c} and R^{d} together with the N atom to which they are bonded form a 5- or 6-membered, saturated or unsaturated heterocycle, which may carry a further heteroatom being selected from O, S and N as a ring member atom and wherein the heterocycle may be unsubstituted or may carry 1, 2, 3, 4, or 5 substituents which are independently of each other selected from halogen;
R^{e} is selected from CN, halogen, C₁-C₄-alkyl, C₁-C₄-haloalkyl, C₁-C₄-alkoxy, and C₁-C₄-haloalkoxy;
Y is O or S; and
m is 0, 1 or 2;
and
the shell (b) comprises a shell material, which is selected from the group consisting of
(b1) polyaddition products of isocyanates;
(b2) poly(meth)acrylates; and
(b3) aminoplasts;
and wherein, if the capsules comprise a matrix (c) according to option (2),
the matrix (c) comprises compounds of formula I 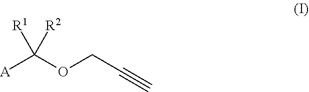
or a stereoisomer, salt, tautomer, or N-oxide thereof
wherein
R¹ and R² are independently of each other selected from the group consisting of H, C₁-C₆-alkyl, C₂-C₆-alkenyl, C₂-C₆-alkynyl, C₁-C₆-haloalkyl, C₁-C₄-alkoxy-C₁-C₄-alkyl C₁-C₆-alkoxy, C₂-C₆-alkenyloxy, C₂-C₆-alkynyloxy, wherein the C-atoms may in each case be unsubstituted or may carry 1, 2 or 3 identical or different substituents R^{e};
C₃-C₈-cycloalkyl, C₃-C₈-cycloalkenyl, heterocyclyl, aryl, hetaryl, C₃-C₈-cycloalkyl-C₁-C₆-alkyl, C₃-C₈-cycloalkenyl-C₁-C₆-alkyl, heterocyclyl-C₁-C₆-alkyl, aryl-C₁-C₆-alkyl, and hetaryl-C₁-C₆-alkyl, phenoxy and benzyloxy, wherein the cyclic moieties may in each case be unsubstituted or may carry 1, 2, 3, 4, or 5 identical or different substituents R^{a};
A is phenyl, wherein said phenyl ring may be unsubstituted or may carry 1, 2, 3, 4, or 5 identical or different substituents R^{A};
wherein
R^{A} is selected from the group consisting of CN, halogen, NO₂, OR^{b}, NR^{c}R^{d}, C(Y)R^{b}, C(Y)OR^{b}, C(Y)NR^{c}R^{d}, S(Y)ₘR^{b}, S(Y)ₘOR^{b},
C₁-C₆-alkyl, C₂-C₆-alkenyl, C₂-C₆-alkynyl, C₁-C₆-haloalkyl, C₁-C₆-alkoxy, C₁-C₆-alkylthio, wherein the C-atoms may in each case be unsubstituted or may carry 1, 2 or 3 identical or different substituents R^{e};
C₃-C₈-cycloalkyl, C₃-C₈-cycloalkenyl, heterocyclyl, aryl, hetaryl, C₃-C₈-cycloalkyl-C₁-C₆-alkyl, C₃-C₈-cycloalkenyl-C₁-C₆-alkyl, heterocyclyl-C₁-C₆-alkyl, aryl-C₁-C₆-alkyl, and hetaryl-C₁-C₆-alkyl, phenoxy and benzyloxy, wherein the cyclic moieties may be unsubstituted or may carry 1, 2, 3, 4, or 5 identical or different substituents R^{a};
and wherein
R^{a} is selected from CN, halogen, NO₂, C₁-C₄-alkyl, C1-C₄-haloalkyl and C₁-C₄-alkoxy;
or two substituents R^{a} on adjacent C-atoms may be a bridge selected from CH₂CH₂CH₂CH₂, OCH₂CH₂CH₂, CH₂OCH₂CH₂, OCH₂CH₂O, OCH₂OCH₂, CH₂CH₂CH₂, CH₂CH₂O, CH₂OCH₂, O(CH₂)O, SCH₂CH₂CH₂, CH₂SCH₂CH₂, SCH₂CH₂S, SCH₂SCH₂, CH₂CH₂S, CH₂SCH₂, S(CH₂)S, and form together with the C atoms, to which the two R^{a} are bonded to, a 5-membered or 6-membered saturated carbocyclic or heterocyclic ring;
R^{b} is selected from H, C₁-C₆-alkyl, C₂-C₄-alkenyl, C₂-C₄-alkynyl, C₁-C₄-haloalkyl, phenyl and benzyl;
R^{c} and R^{d} are independently of each other selected from the group consisting of H, C₁-C₄-alkyl, and C₁-C₄-haloalkyl; or
R^{c} and R^{d} together with the N atom to which they are bonded form a 5- or 6-membered, saturated or unsaturated heterocycle, which may carry a further heteroatom being selected from O, S and N as a ring member atom and wherein the heterocycle may be unsubstituted or may carry 1, 2, 3, 4, or 5 substituents which are independently of each other selected from halogen;
R^{e} is selected from CN, halogen, C₁-C₄-alkyl, C₁-C₄-haloalkyl, C₁-C₄-alkoxy, and C₁-C₄-haloalkoxy;
Y is O or S; and
m is 0, 1 or 2;
and
a matrix material, which is selected from the group consisting of
(c1) a poly(meth)acrylates; and
(c2) calcium alginate.

2. The capsules according to claim 1, wherein, in the compounds of formula I,
R¹ and R² are each H;
A is phenyl, wherein said phenyl ring is unsubstituted or carries 1, 2, or 3 identical or different substituents R^{A}, wherein
R^{A}, if present, is selected from the group consisting of halogen, C₁-C₄-alkyl, and C1-C₄-alkoxy.

3. The capsules according to claim 1, wherein the vapor pressure of the compounds of formula I is more than 0.2 Pa at 20° C.

4. The capsules according to claim 1, wherein the capsules comprise a core (a) and a shell (b), wherein the core (a) is encapsulated by the shell (b),
and wherein the weight ratio of the core (a) to the shell (b) is from 70:30 to 98:2.

5. The capsules according to claim 1, wherein the shell material is selected from (b1) polyaddition products of isocyanate, which comprise
(b1a) at least one polyfunctional isocyanate and at least one polyfunctional amine in polymerized form; or
(b1b) at least one polyfunctional isocyanate and at least one polyfunctional alcohol in polymerized form; or
(b1c) at least one polyfunctional isocyanate and at least one polyfunctional amine and at least one polyfunctional alcohol in polymerized form.

6. The capsules according to claim 1, wherein the shell material is
(b2a) a poly(meth)acrylate comprising methyl methacrylate and/or methacrylic acid in polymerized form; or
(b3a) an aminoplast comprising melamine and formaldehyde in polymerized form.

7. The capsules according to claim 1, wherein the shell (b) of the capsules comprises organic or inorganic protective colloids.

8. The capsules according to claim 1, having a volume median particle size of more than 300 μm.

9. A capsule suspension comprising: a suspended phase comprising the capsules according to claim 1, wherein the capsules have a volume median particle size of 300 μm or less; and a liquid phase
wherein the weight ratio of the suspended phase to the liquid phase is from 1:0.5 to 1:100.

10. A mixture comprising:
(i) an inorganic carrier granule, an organic carrier granule, a fertilizer, a composition comprising a fertilizer, or a granule comprising a fertilizer; and
(ii) capsules according to claim 1.

11. A method of using the capsules according to claim 1, the method comprising applying the capsules to the root zone of a plant, the soil, soil substituents and/or the locus where a plant is growing or is intended to grow.

12. The method according to claim 11 further comprising using the capsules for reducing nitrification.

13. A method for reducing nitrification comprising applying the capsules according to claim 1 to the root zone of a plant, the soil, soil substituents and/or the locus where a plant is growing or is intended to grow.

14. The method according to claim 13, wherein the root zone of a plant, the soil, soil substituents and/or the locus where a plant is growing or is intended to grow is additionally provided with a fertilizer, wherein the application of the capsules according to claim 1, and the fertilizer may be carried out simultaneously or with a time lag.

15. The mixture according to claim 10, wherein the fertilizer comprises a solid or liquid ammonium-containing inorganic fertilizer, preferably a NPK fertilizer, ammonium nitrate, calcium ammonium nitrate, ammonium sulfate nitrate, ammonium sulfate, or ammonium phosphate; a solid or liquid organic fertilizer, preferably liquid manure, semi-liquid manure, biogas manure, stable manure and straw manure, worm castings, compost, seaweed or guano; or an urea-containing fertilizer such as urea, formaldehyde urea, urea ammonium nitrate (UAN) solution, urea sulphur, stabilized urea, urea based NPK-fertilizers, or urea ammonium sulfate.

16. The capsules according to claim 4 wherein the weight ratio of the core (a) to the shell (b) is from 80:20 to 95:5.

17. The capsules according to claim 8 having a volume median particle size of 1 mm or more.

18. The capsules according to claim 9 wherein the weight ratio of the suspended phase to the liquid phase is from 1:1 to 1:10.
